(19) United States
(12) Patent Application Publication
(10) Pub. No.: US 2022/0043731 A1
(43) Pub. Date: Feb. 10, 2022

(54) PERFORMANCE ANALYSIS

(71) Applicant: NVIDIA Corporation, Santa Clara, CA (US)

(72) Inventors: Alan Daniel Larson, Milpitas, CA (US); Bipin Prabhakar Todur, Santa Clara, CA (US); Marko Milovanovic, Milpitas, CA (US); Alexander Gordon McAuley, Cupertino, CA (US); Kevin Michael Thayer, Santa Clara, CA (US)

(21) Appl. No.: 16/987,252

(22) Filed: Aug. 6, 2020

(51) Int. Cl. G06F 11/34; H04L 29/08; G06F 17/18

(52) U.S. Cl. CPC G06F 11/3409; G06F 17/18; H04L 67/02; H04L 67/22

(57) ABSTRACT

Apparatuses, systems, and techniques to identify a cause of a performance regression in a web-based service. In at least one embodiment, a cause of a performance regression is identified by comparing performance metrics associated with a first group of user interactions with a web-based service to performance metrics associated with a second group of user interactions with the web-based service.

### TECHNICAL FIELD

At least one embodiment pertains to processors or computer systems used to detect and diagnose one or more causes of a performance regression in a web-based service, according to various novel techniques described herein.

### BACKGROUND

Techniques for automatically detecting and diagnosing performance regressions in a web-based service can use significant amounts of computing resources, and can be inaccurate. The accuracy of detecting and diagnosing performance regressions, and amount of computing resource used, can be improved.

### BRIEF DESCRIPTION OF DRAWINGS

FIG. 1 illustrates time series analysis of a web-based service, in accordance with at least one embodiment;

FIG. 2 illustrates metric resampling, in accordance with at least one embodiment;

FIG. 3 illustrates transition detection, in accordance with at least one embodiment;

FIG. 4 illustrates an example process of time series analysis of a web-based service, in accordance with at least one embodiment;

FIG. 5 illustrates an example process of subcontext isolation, in accordance with at least one embodiment;

FIG. 6 illustrates an example process of subenvironment isolation, in accordance with at least one embodiment;

FIG. 7 illustrates an example visualization of subenvironment and subcontext isolation, in accordance with at least one embodiment;

FIG. 8 illustrates a further example visualization of subenvironment and subcontext isolation, in accordance with at least one embodiment;

FIG. 9 illustrates a further example visualization of subenvironment and subcontext isolation, in accordance with at least one embodiment;

FIG. 10 illustrates an example directed graph visualization of subenvironment and subcontext isolation, in accordance with at least one embodiment;

FIG. 11 illustrates a distributed system, in accordance with at least one embodiment;

FIG. 12 illustrates an exemplary data center, in accordance with at least one embodiment;

FIG. 13 illustrates a client-server network, in accordance with at least one embodiment;

FIG. 14 illustrates a computer network, in accordance with at least one embodiment;

FIG. 15A illustrates a networked computer system, in accordance with at least one embodiment;

FIG. 15B illustrates a networked computer system, in accordance with at least one embodiment;

FIG. 15C illustrates a networked computer system, in accordance with at least one embodiment;

FIG. 16 illustrates one or more components of a system environment in which services may be offered as third party network services, in accordance with at least one embodiment;

FIG. 17 illustrates a cloud computing environment, in accordance with at least one embodiment;

FIG. 18 illustrates a set of functional abstraction layers provided by a cloud computing environment, in accordance with at least one embodiment;

FIG. 19 illustrates a supercomputer at a chip level, in accordance with at least one embodiment;

FIG. 20 illustrates a supercomputer at a rack module level, in accordance with at least one embodiment;

FIG. 21 illustrates a supercomputer at a rack level, in accordance with at least one embodiment;

FIG. 22 illustrates a supercomputer at a whole system level, in accordance with at least one embodiment;

FIG. 23A illustrates inference and/or training logic, in accordance with at least one embodiment;

FIG. 23B illustrates inference and/or training logic, in accordance with at least one embodiment;

FIG. 24 illustrates training and deployment of a neural network, in accordance with at least one embodiment;

FIG. 25 illustrates an architecture of a system of a network, in accordance with at least one embodiment;

FIG. 26 illustrates an architecture of a system of a network, in accordance with at least one embodiment;

FIG. 27 illustrates a control plane protocol stack, in accordance with at least one embodiment;

FIG. 28 illustrates a user plane protocol stack, in accordance with at least one embodiment;

FIG. 29 illustrates components of a core network, in accordance with at least one embodiment;

FIG. 30 illustrates components of a system to support network function virtualization (NFV), in accordance with at least one embodiment;

FIG. 31 illustrates a processing system, in accordance with at least one embodiment;

FIG. 32 illustrates a computer system, in accordance with at least one embodiment;

FIG. 33 illustrates a system, in accordance with at least one embodiment;

FIG. 34 illustrates an exemplary integrated circuit, in accordance with at least one embodiment;

FIG. 35 illustrates a computing system, according to at least one embodiment;

FIG. 36 illustrates an APU, in accordance with at least one embodiment;

FIG. 37 illustrates a CPU, in accordance with at least one embodiment;

FIG. 38 illustrates an exemplary accelerator integration slice, in accordance with at least one embodiment;

FIGS. 39A and 39B illustrate exemplary graphics processors, in accordance with at least one embodiment;

FIG. 40A illustrates a graphics core, in accordance with at least one embodiment;

FIG. 40B illustrates a GPGPU, in accordance with at least one embodiment;

FIG. 41A illustrates a parallel processor, in accordance with at least one embodiment;

FIG. 41B illustrates a processing cluster, in accordance with at least one embodiment;

FIG. 41C illustrates a graphics multiprocessor, in accordance with at least one embodiment;

FIG. 42 illustrates a software stack of a programming platform, in accordance with at least one embodiment;

FIG. 43 illustrates a CUDA implementation of a software stack of FIG. 42, in accordance with at least one embodiment;

FIG. 44 illustrates a ROCm implementation of a software stack of FIG. 42, in accordance with at least one embodiment;

FIG. 45 illustrates an OpenCL implementation of a software stack of FIG. 42, in accordance with at least one embodiment;

FIG. 46 illustrates software that is supported by a programming platform, in accordance with at least one embodiment; and

FIG. 47 illustrates compiling code to execute on programming platforms of FIGS. 42-45, in accordance with at least one embodiment.

### DETAILED DESCRIPTION

In the following description, numerous specific details are set forth to provide a more thorough understanding of at least one embodiment. However, it will be apparent to one skilled in the art that the inventive concepts may be practiced without one or more of these specific details.

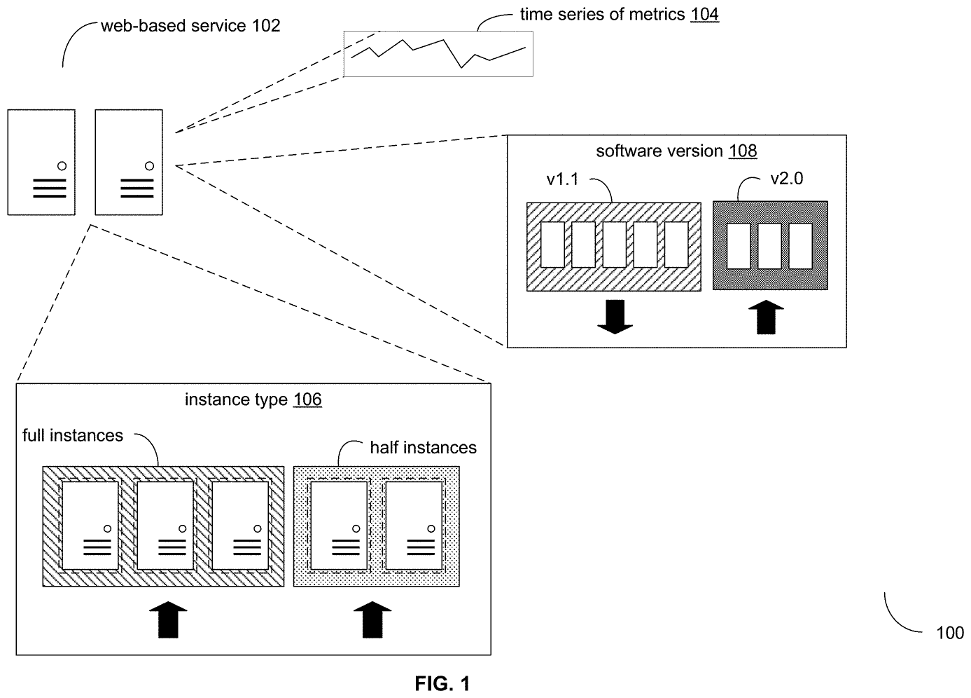

FIG. 1 illustrates time series analysis of a web-based service, in accordance with at least one embodiment. In at least one embodiment, in a depicted example 100 of a web-based service 102 comprises a plurality of servers. In at least one embodiment, a server hosts one or more virtual machines. In at least one embodiment, a virtual machine executes one or more applications that provide web-based services to one or more user devices.

In at least one embodiment, a user session corresponds to one or more interactions between a user's device and web-based service 102. In at least one embodiment, an interaction can include, but is not limited to, requests for data, provision of data, performance of a requested operation, performance of a scheduled or unrequested operation, connection, or disconnection. For example, in at least one embodiment, an interaction comprises rendering a frame of video in relation to a videogame hosted by web-based service 102 and streamed to a user device. In at least one embodiment, an interaction comprises requesting or performing operations or performing operations related to computerized gameplay. In at least one embodiment, a user interaction comprises a user session of gameplay, or a user session of some other web-based service.

In at least one embodiment, a performance regression of a web-based service 102 is automatically detected a cause of said regression is identified by automated analysis. In at least one embodiment, a regression comprises a change to a performance characteristic. In at least one embodiment, a regression comprises an unexpected negative change to a performance characteristic for which a cause is unknown.

In at least one embodiment, automated analysis of a regression is based on comparative analysis of groups of interactions with web-based service 102. In at least one embodiment, said comparative analysis comprises comparing, with respect to two or more groups of user interactions, changes to a regressed performance metric. In at least one embodiment, said comparative analysis further comprises comparing changes to a proportion of user interactions in a respective group, compared to user interactions in other groups or to a total number of user interactions. In at least one embodiment, said groups of user interactions are based on properties associated with a group. For example, in at least one embodiment, groups are based on a version number category of property, such that user interactions associated with “v1.0” of an application are placed in one group, and user interactions associated with “v2.0” of said application are placed in another. In at least one embodiment, said comparative analysis is based on comparing these respective groups. In at least one embodiment, a category of property, such as version number, is referred to as a subenvironment, and a value of a property in that category is referred to as a subcontext, or a subcontext of a subenvironment. For example, in at least one embodiment, user interactions, such as user sessions, are grouped according to a version number subenvironment, such as user interactions associated with a “v1.0” subcontext are placed in one group, and user interactions associated with a “v2.0” subcontext are placed in another group.

In at least one embodiment, time series of metrics are collected to monitor performance of said web-based service 102. For example, in at least one embodiment, a metric comprises a value indicative of system performance, which may include but is not limited to measurements such as requests processed per second, number of active sessions, number of inactive sessions, central processing unit (“CPU”) utilization, memory utilization, bandwidth utilization, and so on. In at least one embodiment, a time series of metrics comprises a sequence of such values collected over time, and thus represents a corresponding metric's value over time.

In at least one embodiment, a web-based service 102 collects a time series of metrics 104. For example, in at least one embodiment, web-based service 102 periodically counts inactive user sessions and records a corresponding value in an array or other storage structure suitable for maintaining time series data.

In at least one embodiment, changes to operating characteristics of web-based service 102 are identified, via techniques described herein, by analysis of time series of metrics and other data. In at least one embodiment, said operating characteristic is a performance characteristic, or a characteristic indicative of an application function. In at least one embodiment, a change to an operating characteristic of web-based service 102 is reflected as a transition in a time series of a metric. In at least one embodiment, a transition comprises a statistically significant change to values in the time series. In at least one embodiment, such changes are indicative of a malfunction or regression in performance.

In at least one embodiment, a transition in a time series is identified, from among a plurality of time series, using analysis techniques described herein. For example, in at least one embodiment, web-based service 102 collects a large number of different time series, pertaining to a variety different performance characteristics. In at least one embodiment, web-based service 102 analyzes these time series to detect a transition in one of these time series. In at least one embodiment, web-based service 102 identifies a transition that could be difficult, impossible, or impractical to detect by other means.

In at least one embodiment, web-based service 102 has a variety of properties, such as characteristics, attributes, traits, or qualities. In at least one embodiment, properties are single dimensional or multidimensional, and may be represented as scalars, vectors, or arrays of numeric or textual values. In at least one embodiment, examples of properties associated with web-based service 102 are instance type 106 and software version 108 properties. In at least one embodiment, instance type 106 refers to classifications of virtual machine instances, and may represented as vector that describes how many of each classification is operative at a given time. In at least one embodiment, software version 108 refers to a revision number of an application program operative on web-based service 102, and is similarly represented as a vector that describes how many instances of each revision or operative at a given time. Properties of web-based service 102 change over time, e.g., in response to a new application being installed or some other configuration change being made to web-based service 102, which may in turn lead to a transition in a time series of metrics 104. In at least one embodiment, a property whose change caused said transition is identified using an isolation and drilldown process, embodiments of which are described herein. In at least one embodiment, web-based service 102 has a large number of properties, many of which may vary independently over time, such that identification of a property associated with a metric transition would otherwise be difficult, impossible, or impractical. For example, in at least one embodiment, a number of “full instances” and “half instances” of virtual machines both increase during a time period associated with a transition of a time series of metrics 104, while applications having software version 108 decrease for version “v1.1,” but increase for version “v2.0.” In at least one embodiment, there are many such properties in addition to those depicted, each of which may change independently of other properties. In at least one embodiment, an isolation and drilldown process, as described herein, is used to identify, from among a large number of properties, those properties which may be associated with a root cause of a metric transition.

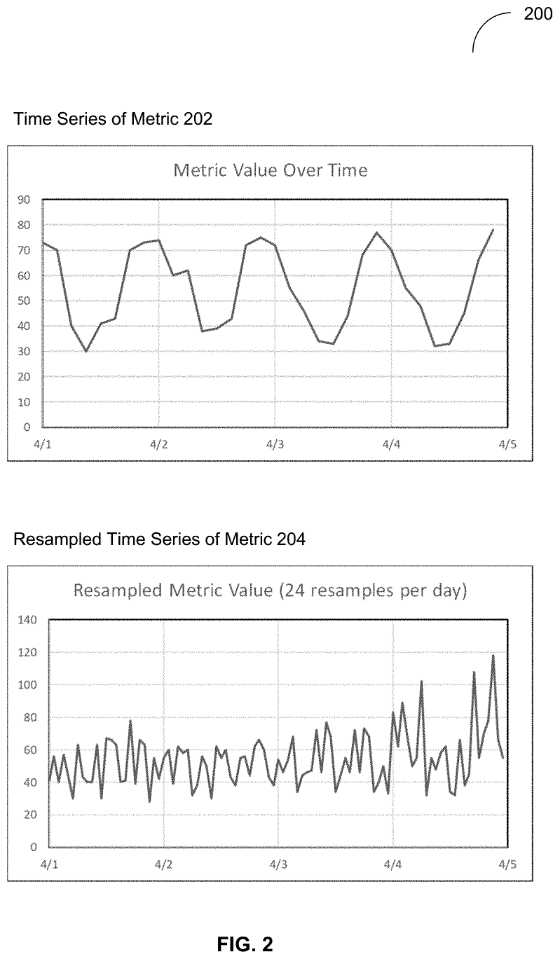

FIG. 2 illustrates metric resampling, in accordance with at least one embodiment. In at least one embodiment, an example 200 of a time series of a metric 202 comprises a metric value sampled periodically over a period of time, such as once every hour for a period of several days. In at least one embodiment, time series 202 exhibits periodicity or a cyclical tendency, which may result from demand on the system fluctuating naturally over time. For example, in at least one embodiment, peak usage times of a web-based service 102 are in early evening hours. In at least one embodiment, a resampling technique is used to facilitate identification of a transition point, even in view of cyclical patterns such as what is depicted in FIG. 2.

In at least one embodiment, resampling is performed by extracting values from a portion of a time series and randomly assigning those values to some number of buckets. For example, in at least one embodiment, a time series comprises samples collected at a periodic interval over a day. Resampling, in at least one embodiment, comprises randomly reassigning those values to one of a number of buckets. In at least one embodiment, twenty-four buckets per day are used, but each bucket could contain samples collected at any point throughout the day, so that these buckets do not necessarily correspond to hours of the day. In at least one embodiment, a value from a time series of a metric 202 is assigned to one and only one bucket within a resampled time series. In at least one embodiment, each bucket, after resampling, comprises 1/N samples, where N indicates how many buckets are used per day. In at least one embodiment, N=24. In at least one embodiment, N is chosen so that normal periodic fluctuations in time series of a metric 202 are removed or reduced, balanced with increased processing times that may be associated with increased values of N. In at least one embodiment, larger values of N can improve ability to detect shift in a population mean of metric of a time series 202.

In at least one embodiment, a mean is calculated for values assigned to each bucket. In at least one embodiment, the mean values for each bucket collectively constitute a resampled time series of metrics 204. In at least one embodiment, this resampled time series 204 can be plotted as depicted in FIG. 2, where each intraday value corresponds to a mean of a corresponding bucket.

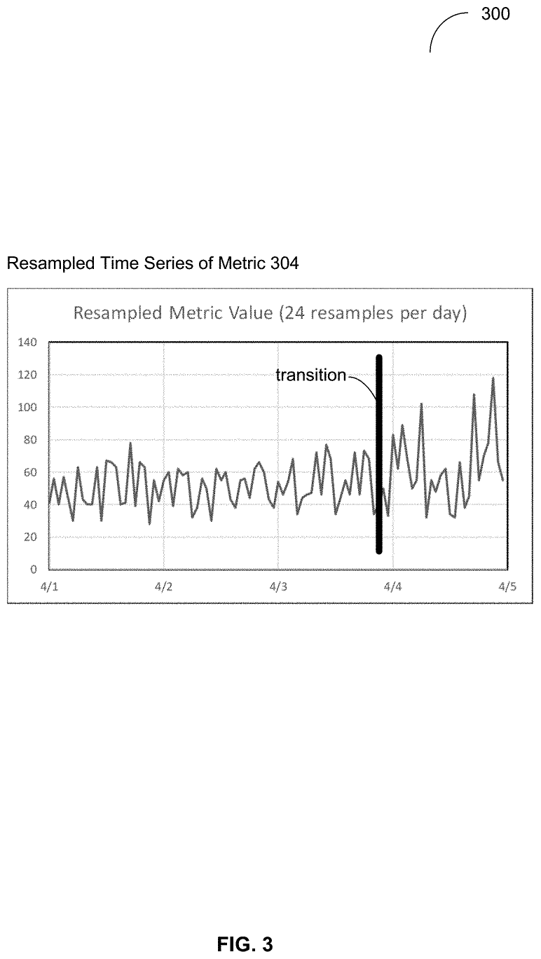

FIG. 3 illustrates transition detection, in accordance with at least one embodiment. In at least one embodiment, in an example 300, a resampled time series of a metric 304, such as the resampled time series 204 depicted in FIG. 2, is analyzed to identify one or more transition points.

In at least one embodiment, a t-test is used to identify a transition point. In at least one embodiment, Welch's t-test is used, according to an equation:

$$t = \frac{{\overline{X}}_{1} - {\overline{X}}_{2}}{\sqrt{\frac{{s}_{1}^{2}}{{N}_{1}} + \frac{{s}_{2}^{2}}{{N}_{2}}}}$$

In at least one embodiment, t is used in conjunction with degrees of freedom, as computed based off of a number of samples on each side, to produce a p-value that corresponds to an estimated probability that a null hypothesis is true. In at least one embodiment, said null hypothesis is that each section of said time series have equal population means, and an alternative hypothesis is that each section do not have equal population means.

In at least one embodiment, a resampled time series is taken and split into two portions at a given index position. For each such position, in at least one embodiment, a t-test is performed and t-statistics and p-values are recorded, and a transition point is identified by locating a position whose t-statistic has a greatest absolute value. In at least one embodiment, a position having a greatest absolute value and whose p-value indicates statistical significance is considered to be a transition point. In at least one embodiment, such positions are considered to be those whose p-values are below a threshold, e.g. below 0.001.

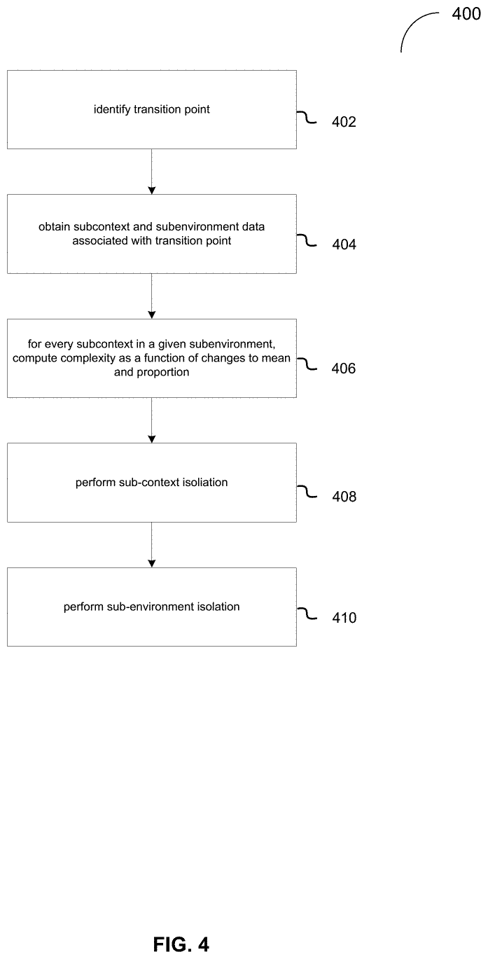

FIG. 4 illustrates an example process of time series analysis of a web-based service, in accordance with at least one embodiment. In at least one embodiment, one or more transition points in a time series of metrics are identified and a potential cause of each transition is identified using isolation analysis. In at least one embodiment, an objective of isolation analysis is to isolate a most probable cause of a transition. In at least one embodiment, isolation analysis is based on an assumption that a transition in a time series may be explained by a related change, in proportion, to a subcontext.

Although the example process 400 is depicted as a sequence of operations, it will be appreciated that, in embodiments, the depicted operations may be altered in various ways, and that some operations may be omitted, reordered, or performed in parallel with other operations, except where an order is explicitly stated or logically implied, such as when the input from one operation depends upon the output of another operation.

The operations depicted by FIG. 4 may be performed by a system, such as the web-based service 102 depicted in FIG. 1, comprising at least one processor and a memory comprising instructions that, in response to being executed by the at least one processor, cause the system to perform the depicted operations.

At 402, in at least one embodiment, a transition point in a time series is identified. In at least one embodiment, a system identifies said transition point using techniques described in relation to FIGS. 2-3. In at least one embodiment, said transition point is determined, based on statistical properties associated with the transition point, to be a target for isolation and drilldown analysis.

In at least one embodiment, for a given identified transition point, an isolation

At 404, in at least one embodiment, subcontext and subenvironment data associated with an identified transition point is obtained. In at least one embodiment, a subcontext corresponds to a value of a property or attribute, and a subenvironment corresponds to a classification or type of said properties or attributes. For example, in at least one embodiment, “instance type” corresponds to a subenvironment, and “full instance” or “half instance” corresponds to a subcontext.

In at least one embodiment, subcontext and subenvironment data is obtained for a time period associated with a transition. In at least one embodiment, this comprises data prior to a transition point being subjected to isolation and drilldown analysis, and data subsequent to said transition point.

At 406, in at least one embodiment, for every subcontext in a given subenvironment, a complexity value is computed as a function of changes to mean and proportion. In at least one embodiment, a given subenvironment (such as instance type) has a one-to-many relationship with subcontexts, such as “half instance” and “full instance.” In at least one embodiment, complexity is computed in accordance with the following:

$$s A = s [ after mean ] * s [ after proportion ]$$

$$sB = s [ before mean ] * s [ before proportion ]$$

$$sAB = ( \frac{s A - s B}{s B} )$$

$$s [ complexity ] = sA B * s [ after proportion ]$$

In at least one embodiment, sAB may be set to 1.0 if not a number, e.g. when sB is equal to zero. In at least one embodiment, an approximate scalar equivalent for before/after is computed by multiplying mean by proportion. In at least one embodiment, if the scalar is equal to zero, as in cases where a subcontext was introduced (e.g., a new software version), a scalar for before is set to not a number (“NaN”).

In at least one embodiment, a combined scalar, such as sAB shown above, is computed as a ratio of change between two scalars. In at least one embodiment, this ratio is multiplied by a proportion of an ‘after’ component to bias complexities to be higher for ‘newer’ subcontexts. This emphasizes contexts that increase in proportion, rather than subcontexts which decrease in proportion. For example, in at least one embodiment, a system generates a more intuitive result by flagging a new version v2.0 as being responsible for a transition, instead of flagging a “reduction in version to v1.0” as a cause of said transition.

In at least one embodiment, if said ratio becomes zero, as might occur when sB is zero due to a new context being introduced, said scalar can be set to 1.0 to enable new contexts (which have no prior proportion) to be flagged as a root cause of a transition.

At 408, in at least one embodiment, subcontext isolation is performed. In at least one embodiment, a system, through subcontext isolation, identifies properties or attributes whose change is estimated to be a cause of a transition.

In at least one embodiment, subcontext isolation comprises qualifying subcontexts as potential causes of a transition. In at least one embodiment, one or more filtering criteria are applied. In at least one embodiment, subcontexts are eliminated as potential causes when there proportion is below a threshold level. For example, in at least one embodiment, a subcontext associated with less than 5% of sessions during a relevant period might be filtered out of consideration. In at least one embodiment, subcontexts that do not have values on or around a transition date are excluded from consideration.

In at least one embodiment, subcontexts are included as potential causes when their proportion is above a threshold level and have data around a corresponding transition time.

In at least one embodiment, a complexity measure as described above is converted to an influence factor. In at least one embodiment, if a subcontext has not changed in mean or proportion, its influence is zero. Otherwise, in at least one embodiment, an influence factor of a subcontext is initialized to be an absolute value of said subcontexts complexity.

In at least one embodiment, logic is then performed to determine whether a subcontexts change is in agreement or disagreement with a transition. In at least one embodiment, when a transition is an increasing one, a subcontext whose value is decreasing may be disqualified. In at least one embodiment, a subcontext is marked as disqualified by setting is influence factor to zero.

In at least one embodiment, there may be a number of subcontexts in a given subenvironment, and each subcontext may have its own proportion vector and mean vector, where vector refers to a direction and amount of change in a respective subcontext. Each subcontext may be increasing or decreasing in mean, and this increase or decrease may be below a transition mean, above said transition mean, or across said transition mean. Each subcontext may also be increasing or decreasing in overall proportion. In at least one embodiment, a subcontext is identified as a potential cause of a transition based on its relative movement, in mean and proportion, to said transition. In at least one embodiment, an influence factor associated with a subcontext is set to zero, disqualifying that subcontext, if its vector is misaligned with that of a corresponding transition.

In at least one embodiment, an influence factor associated with each subcontext is used to identify potential root causes of a transition. In at least one embodiment, a subcontext is considered as a root cause if its influence factor percentage is greater than a threshold. For example, in at least one embodiment, a subcontext is considered as a root cause if its influence factor is more than 20% of influence factors attributable to that transition. In at least one embodiment, a subcontext may also be considered as a root cause if it is a new subcontext and its proportion is greater than a threshold amount.

At 410, in at least one embodiment, subenvironment isolation is performed. In at least one embodiment, a system is associated with many possible subenvironments, and the system performs subenvironment isolation to identify which subenvironment is most associated with a transition.

In at least one embodiment, subenvironment isolation comprises analysis of one or more of subenvironments associated with a system. In at least one embodiment, some subenvironments are excluded from analysis based on various criteria. In at least one embodiment, a subenvironment is excluded based on information gain associated with movement of associated subcontexts. For example, in at least one embodiment, a subenvironment is excluded if all of its subcontexts are either overwhelmingly increasing or overwhelmingly decreasing, because information gain associated with a subenvironment is low when respective movements of its associated subcontexts are aligned.

In at least one embodiment, mean absolute complexity is computed, across all subcontexts in an environment. In at least one embodiment, this includes subcontexts that were not identified as root causes. In at least one embodiment, mean absolute complexity indicates an amount of movement within a subenvironment. In at least one embodiment, a subenvironment with a highest mean absolute complexity is selected.

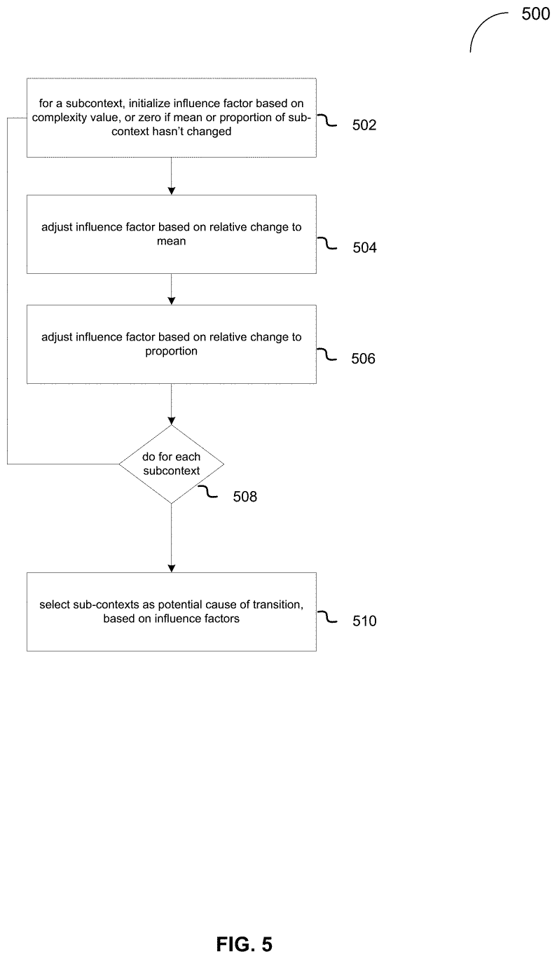

FIG. 5 illustrates an example process of subcontext isolation, in accordance with at least one embodiment.

Although the example process 500 is depicted as a sequence of operations, it will be appreciated that, in embodiments, the depicted operations may be altered in various ways, and that some operations may be omitted, reordered, or performed in parallel with other operations, except where an order is explicitly stated or logically implied, such as when the input from one operation depends upon the output of another operation.

The operations depicted by FIG. 5 may be performed by a system, such as the web-based service 102 depicted in FIG. 1, comprising at least one processor and a memory comprising instructions that, in response to being executed by the at least one processor, cause the system to perform the depicted operations.

At 502, in at least one embodiment, an influence factor of a subcontext is initialized, based either on a complexity value associated with said subcontext, or to zero if that subcontext's mean and proportion, relative to other subcontexts within a subenvironment, has not changed.

At 504, in at least one embodiment, said influence factor is adjusted based on relative changes to a mean of said subcontext. In at least one embodiment, a change vector of said subcontext is compared to other subcontexts within an associated subenvironment, where influence is adjusted upward when this vector is of a greater magnitude or in a different direction than change vectors of other subcontexts in that subenvironment. In at least one embodiment, influence is adjusted downwards when this vector is of similar magnitude or has similar direction that other change vectors.

At 506, in at least one embodiment, said influence factor is adjusted based on relative change to proportion of said subcontext. In at least one embodiment, influence is adjusted upwards when a subcontext's proportion increases relative to other subcontexts, and downward when proportion decreases.

In at least one embodiment, as illustrated by element 508, an influence factor is computed for each subcontext.

At 510, in at least one embodiment, one or more subcontexts are selected as potential causes of a transition, based on computed influence factors.

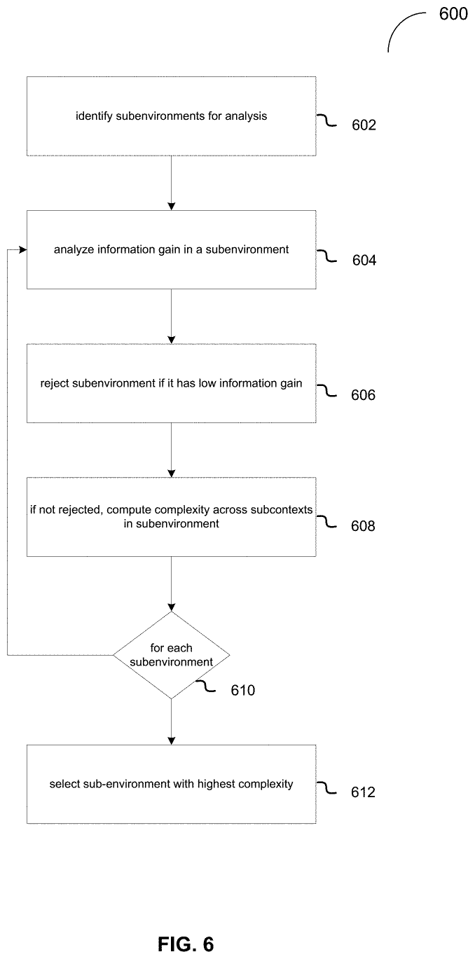

FIG. 6 illustrates an example process of subenvironment isolation, in accordance with at least one embodiment.

Although the example process 600 is depicted as a sequence of operations, it will be appreciated that, in embodiments, the depicted operations may be altered in various ways, and that some operations may be omitted, reordered, or performed in parallel with other operations, except where an order is explicitly stated or logically implied, such as when the input from one operation depends upon the output of another operation.

The operations depicted by FIG. 6 may be performed by a system, such as the web-based service 102 depicted in FIG. 1, comprising at least one processor and a memory comprising instructions that, in response to being executed by the at least one processor, cause the system to perform the depicted operations.

At 602, in at least one embodiment, subenvironments are identified for analysis. In at least one embodiment, said identification comprises filtering of subenvironmments based on one or more criteria. In at least one embodiment, said criteria includes availability of data relevant to a subenvironment around a transition.

At 604, in at least one embodiment, information gain in a subenvironment is analyzed. In at least one embodiment, a system analyzes information gain by comparing relative changes in its subenvironments. In at least one embodiment, a subenvironment is determined to have relatively high information gain when one or more of its subcontexts have change in a magnitude or direction significantly different than a majority of other subcontexts in said subenvironment. In at least one embodiment, a subenvironment is determined to have relatively low information gain when its subcontexts either have not significantly changed in magnitude or direction, or when a majority of its subcontexts have changed in similar magnitude and direction.

At 606, in at least one embodiment, a subenvironment is rejected as being potentially related to a transition if its information gain is low.

At 608, in at least one embodiment, for a subenvironment that has not been rejected, complexity values are computed across subcontexts in said subenvironment.

In at least one embodiment, at illustrated by operation 610, each identified subenvironment is analyzed based on information gain and, if information gain is suitably high, complexity measures are computed for its associated subcontexts.

At 612, in at least one embodiment, a subenvironment whose associated complexity is highest is selected as being a potential cause of a transition. In at least one embodiment, a subenvironment is selected based on its mean absolute complexity, calculated based on complexity values associated with each of its subcontexts. In at least one embodiment, a subenvironment whose mean absolute complexity is highest is selected.

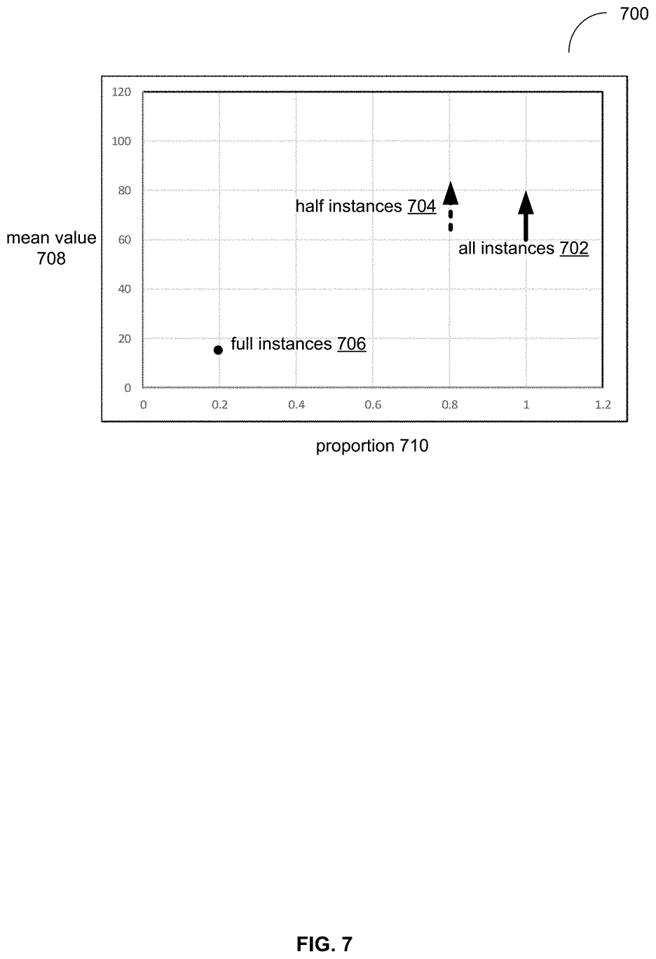

FIG. 7 illustrates an example visualization of subenvironment and subcontext isolation, in accordance with at least one embodiment. In at least one embodiment, a graph 700 is used to visualize subenvironment and subcontext isolation. In at least one embodiment, a graph 700 shows that half instances make up 80% of an instance type subenvironment, and that full instances make up 20%, and that for all instances 702 mean value 708 has increased. Further, a mean value associated with half instances 704 has increased, while a mean value associated with full instances 706 has not changed. Relative proportions 710 of said half instances and full instances is unchanged, at 20% and 30%, respectively. In at least one embodiment, this subenvironment is associated with high information gain, due to said change in mean associated with half instances, as indicated by arrow 704.

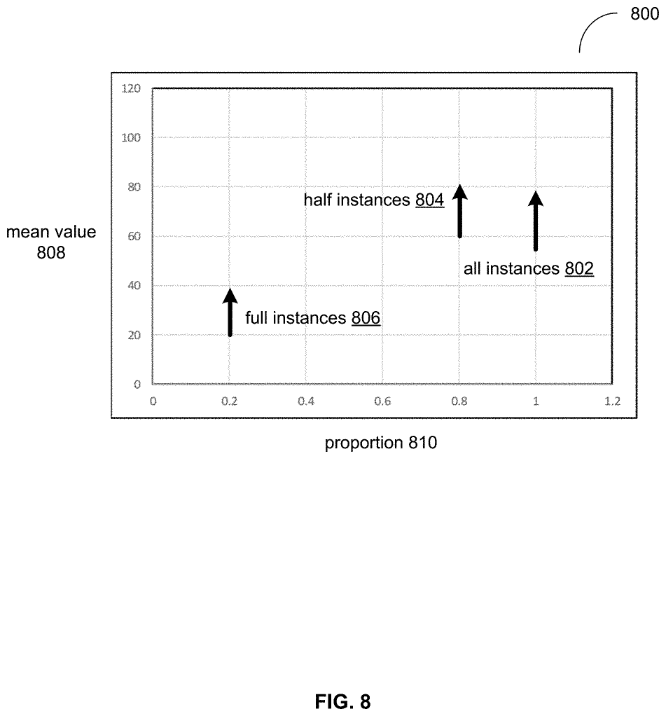

FIG. 8 illustrates a further example visualization of subenvironment and subcontext isolation, in accordance with at least one embodiment. In at least one embodiment, a graph 800 is used to visualize subenvironment and subcontext isolation. In at least one embodiment, a graph 800 shows that half instances 804 and full instances 806 make up 80% and 20% of an instance type subenvironment, compared to all instances 802, respectively. Further, graph 800 indicates that there has been no change to these respective proportions. Regarding mean values, graph 800 indicates that means of metric 808 have changed in similar magnitude and direction for both half and full instances. In at least one embodiment, this leads to determining that subenvironment has low information gain.

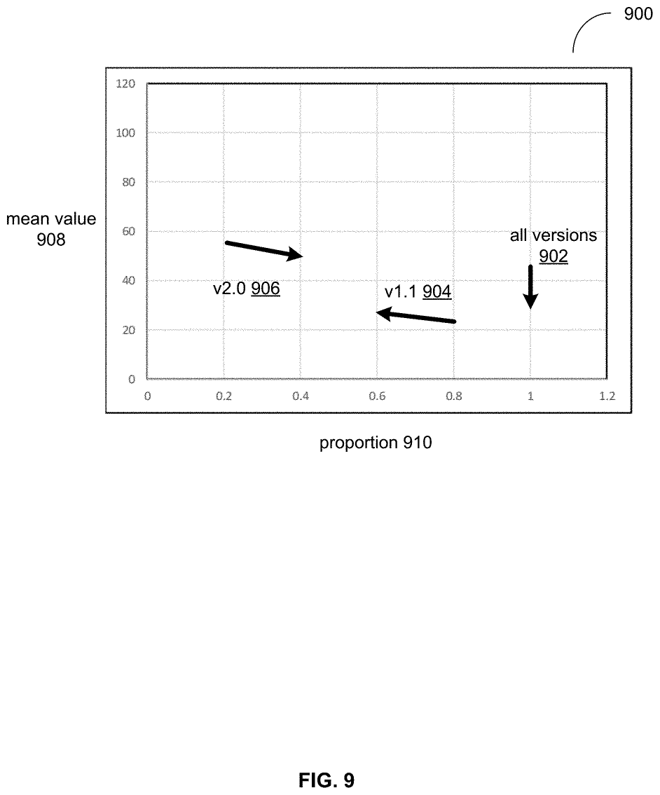

FIG. 9 illustrates a further example visualization of subenvironment and subcontext isolation, in accordance with at least one embodiment. In at least one embodiment, a graph 900 is used visualize subenvironment and subcontext isolation. In at least one embodiment, a graph 900 shows changes to mean and proportion of subcontexts within a subenvironment pertaining to version numbers. Further, graph 900 shows that a mean of metric 908 has decreased for all versions, as indicated by arrow 902, and that a proportion of version “v2.0” has increased from 20% to 40%. Although the changes to mean values 908 associated with versions 2.0 and v1.1 are indicated, in graph 900 by elements 904 and 906, as relatively slight, graph 900 may be considered to have relatively high information gain, due to versions v1.1 and v2.0 changing in opposite direction.

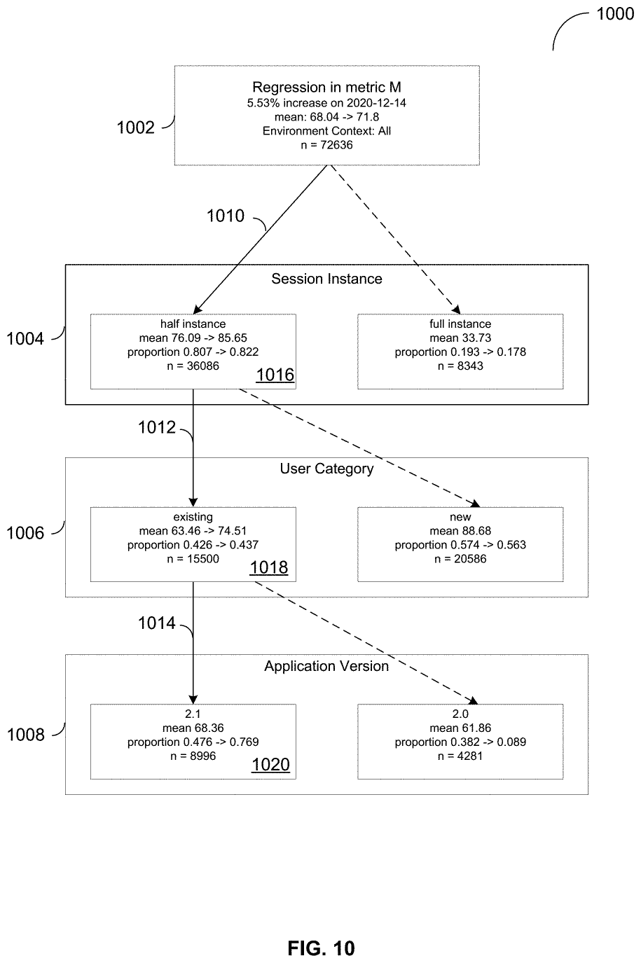

FIG. 10 illustrates an example directed graph visualization of subenvironment and subcontext isolation and drilldown, in accordance with at least one embodiment. In at least one embodiment, a visualization, such as one similar to what is depicted in FIG. 10, is generated by a system to facilitate identification and understanding of one or more causes of a transition in a metric.

In at least one embodiment, an element 1002 of visualization 1000 depicts a regression in a metric M. In at least one embodiment, element 1002 is linked to an element 1004 depicting a subenvironment which, based on isolation processes described herein, has been identified as a potential cause of said regression in metric M In at least one embodiment, as depicted by arrows 1010a,b leading to an element 1016, a change to a “half instance” subcontext, in an instance type subenvironment, has been identified as a potential cause of said regression.

In at least one embodiment, a drilldown process identifies a user category subenvironment, depicted as element 1006, that comprises an “existing” user category subcontext that has been identified, based on isolation processes described herein, as a potential cause of said regression. Similarly, an application version subenvironment, depicted as element 1008, comprises a subcontext of “v2.1” that has also been identified, based on isolation processes described herein, as a potential cause of said regression in metric M.

In at least one embodiment, visualization 1000 depicts correlations between flagged subenvironments and subcontexts. For example, in at least one embodiment, visualization 1000 depicts that a regression in metric M is likely associated with half instances running, on behalf of existing users, version 2.1 of an application. In at least one embodiment, relationships between subcontexts are depicted as arrows 1010, 1012, 1014. For example, arrow 1104 relates statistics pertaining to sessions running on half-instances with existing users, in element 1018, to statistics pertaining to sessions running on half-instances, for existing users, running version 2.1, in element 2020.

In at least one embodiment, a processor comprises one or more circuits are configured to compare performance metrics of a web-based service, in response to a first group of user interactions with the web-based service, to one or more performance metrics of the web-based service in response to a second group of user interactions.

In at least one embodiment, said one or more circuits are configured to determine that performance of the web-based service has regressed by at least generating a resampled time series, by at least randomly reassigning points of a time series of the one or more performance metrics of the web-based service to buckets of the resampled time series. In at least one embodiment, said one or more circuits are further configured to identify a transition point in the resampled time series based, at least in part, on statistical comparison of segments of the resampled time series.

In at least one embodiment, said one or more circuits are configured to compare a rate of change of the one or more performance metrics of the web-based service in response to the first group of user interactions, with a rate of change of the one or more performance metrics of the web-based service in response to the second group of user interactions.

In at least one embodiment, said one or more circuits are configured to compare a proportion of the first group of user interactions to a proportion of the second group of user interactions.

In at least one embodiment, the first group of user interactions is associated with a first property in a category of properties, and the second group of users interactions is associated with a second property in the category of properties.

In at least one embodiment, said one or more circuits are configured to determine that a property associated with the first group of user interactions is a likely cause of a regression in performance of the web-based service, based, at least in part, on a measure of information gained by comparing the one or more performance metrics of the first group of user interactions with the one or more performance metrics of the second group of user interactions.

In at least one embodiment, said one or more circuits are configured to recursively compare groups of user interactions based, at least in part, wherein each level of recursion is based, at least in part, on a category of property different than those in early levels of recursion.

In at least one embodiment, a user interaction comprises utilization of the web-based service by a client device associated with a user.

### Servers and Data Centers

The following FIGS. set forth, without limitation, exemplary network server and data center based systems that can be used to implement at least one embodiment.

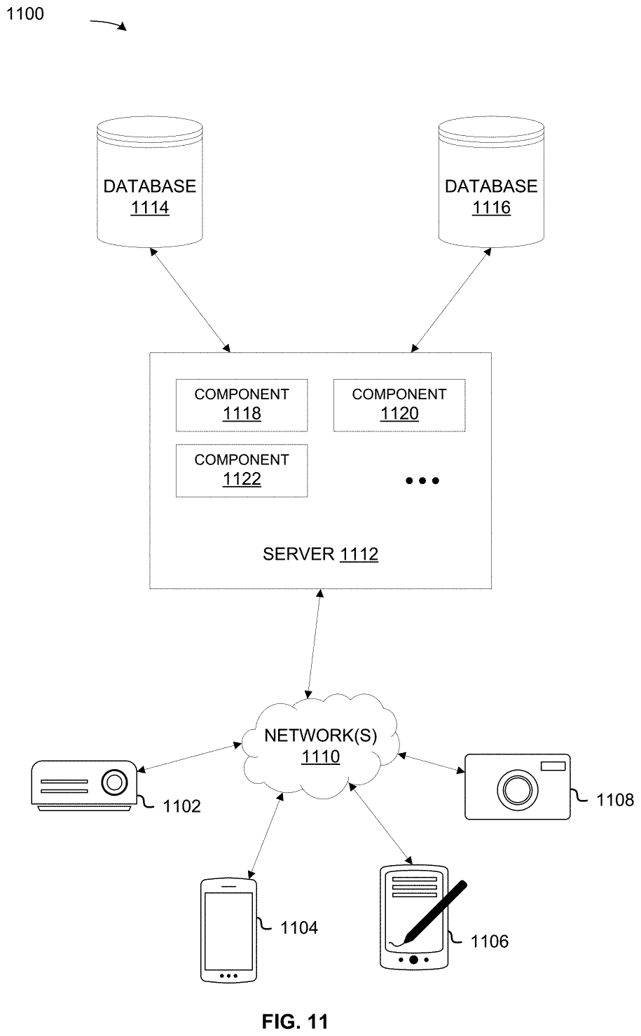

FIG. 11 illustrates a distributed system 1100, in accordance with at least one embodiment. In at least one embodiment, distributed system 1100 includes one or more client computing devices 1102, 1104, 1106, and 1108, which are configured to execute and operate a client application such as a web browser, proprietary client, and/or variations thereof over one or more network(s) 1110. In at least one embodiment, server 1112 may be communicatively coupled with remote client computing devices 1102, 1104, 1106, and 1108 via network 1110.

In at least one embodiment, server 1112 may be adapted to run one or more services or software applications such as services and applications that may manage session activity of single sign-on (SSO) access across multiple data centers. In at least one embodiment, server 1112 may also provide other services or software applications can include non-virtual and virtual environments. In at least one embodiment, these services may be offered as web-based or cloud services or under a Software as a Service (SaaS) model to users of client computing devices 1102, 1104, 1106, and/or 1108. In at least one embodiment, users operating client computing devices 1102, 1104, 1106, and/or 1108 may in turn utilize one or more client applications to interact with server 1112 to utilize services provided by these components.

In at least one embodiment, software components 1118, 1120 and 1122 of system 1100 are implemented on server 1112. In at least one embodiment, one or more components of system 1100 and/or services provided by these components may also be implemented by one or more of client computing devices 1102, 1104, 1106, and/or 1108. In at least one embodiment, users operating client computing devices may then utilize one or more client applications to use services provided by these components. In at least one embodiment, these components may be implemented in hardware, firmware, software, or combinations thereof. It should be appreciated that various different system configurations are possible, which may be different from distributed system 1100. The embodiment shown in FIG. 11 is thus one example of a distributed system for implementing an embodiment system and is not intended to be limiting.

In at least one embodiment, client computing devices 1102, 1104, 1106, and/or 1108 may include various types of computing systems. In at least one embodiment, a client computing device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and/or variations thereof. In at least one embodiment, devices may support various applications such as various Internet-related apps, e-mail, short message service (SMS) applications, and may use various other communication protocols. In at least one embodiment, client computing devices may also include general purpose personal computers including, by way of example, personal computers and/or laptop computers running various versions of Microsoft Windows®, Apple Macintosh®, and/or Linux operating systems. In at least one embodiment, client computing devices can be workstation computers running any of a variety of commercially-available UNIX® or UNIX-like operating systems, including without limitation a variety of GNU/Linux operating systems, such as Google Chrome OS. In at least one embodiment, client computing devices may also include electronic devices such as a thin-client computer, an Internet-enabled gaming system (e.g., a Microsoft Xbox gaming console with or without a Kinect® gesture input device), and/or a personal messaging device, capable of communicating over network(s) 1110. Although distributed system 1100 in FIG. 11 is shown with four client computing devices, any number of client computing devices may be supported. Other devices, such as devices with sensors, etc., may interact with server 1112.

In at least one embodiment, network(s) 1110 in distributed system 1100 may be any type of network that can support data communications using any of a variety of available protocols, including without limitation TCP/IP (transmission control protocol/Internet protocol), SNA (systems network architecture), IPX (Internet packet exchange), AppleTalk, and/or variations thereof. In at least one embodiment, network(s) 1110 can be a local area network (LAN), networks based on Ethernet, Token-Ring, a wide-area network, Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol), and/or any combination of these and/or other networks.

In at least one embodiment, server 1112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In at least one embodiment, server 1112 can include one or more virtual machines running virtual operating systems, or other computing architectures involving virtualization. In at least one embodiment, one or more flexible pools of logical storage devices can be virtualized to maintain virtual storage devices for a server. In at least one embodiment, virtual networks can be controlled by server 1112 using software defined networking. In at least one embodiment, server 1112 may be adapted to run one or more services or software applications.

In at least one embodiment, server 1112 may run any operating system, as well as any commercially available server operating system. In at least one embodiment, server 1112 may also run any of a variety of additional server applications and/or mid-tier applications, including HTTP (hypertext transport protocol) servers, FTP (file transfer protocol) servers, CGI (common gateway interface) servers, JAVA® servers, database servers, and/or variations thereof. In at least one embodiment, exemplary database servers include without limitation those commercially available from Oracle, Microsoft, Sybase, IBM (International Business Machines), and/or variations thereof.

In at least one embodiment, server 1112 may include one or more applications to analyze and consolidate data feeds and/or event updates received from users of client computing devices 1102, 1104, 1106, and 1108. In at least one embodiment, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and/or variations thereof. In at least one embodiment, server 1112 may also include one or more applications to display data feeds and/or real-time events via one or more display devices of client computing devices 1102, 1104, 1106, and 1108.

In at least one embodiment, distributed system 1100 may also include one or more databases 1114 and 1116. In at least one embodiment, databases may provide a mechanism for storing information such as user interactions information, usage patterns information, adaptation rules information, and other information. In at least one embodiment, databases 1114 and 1116 may reside in a variety of locations. In at least one embodiment, one or more of databases 1114 and 1116 may reside on a non-transitory storage medium local to (and/or resident in) server 1112. In at least one embodiment, databases 1114 and 1116 may be remote from server 1112 and in communication with server 1112 via a network-based or dedicated connection. In at least one embodiment, databases 1114 and 1116 may reside in a storage-area network (SAN). In at least one embodiment, any necessary files for performing functions attributed to server 1112 may be stored locally on server 1112 and/or remotely, as appropriate. In at least one embodiment, databases 1114 and 1116 may include relational databases, such as databases that are adapted to store, update, and retrieve data in response to SQL-formatted commands.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10. In at least one embodiment, a web-based service comprises distributed system 1100.

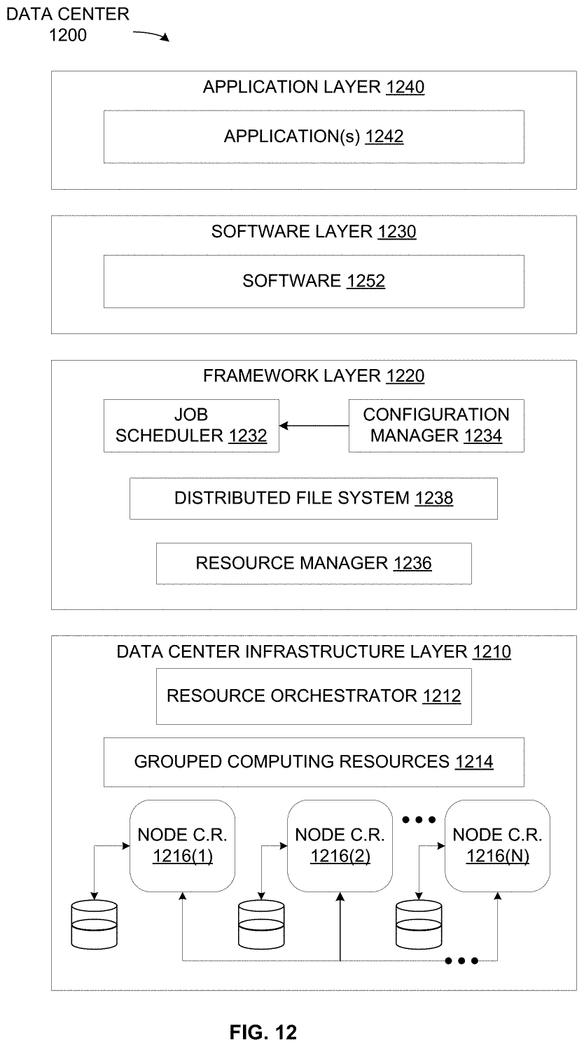

FIG. 12 illustrates an exemplary data center 1200, in accordance with at least one embodiment. In at least one embodiment, data center 1200 includes, without limitation, a data center infrastructure layer 1210, a framework layer 1220, a software layer 1230 and an application layer 1240.

In at least one embodiment, as shown in FIG. 12, data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1216(1)-1216(N) may be a server having one or more of above-mentioned computing resources.

In at least one embodiment, grouped computing resources 1214 may include separate groupings of node C.R.s housed within one or more racks (not shown), or many racks housed in data centers at various geographical locations (also not shown). Separate groupings of node C.R.s within grouped computing resources 1214 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1212 may configure or otherwise control one or more node C.R.s 1216(1)-1216(N) and/or grouped computing resources 1214. In at least one embodiment, resource orchestrator 1212 may include a software design infrastructure (“SDI”) management entity for data center 1200. In at least one embodiment, resource orchestrator 1212 may include hardware, software or some combination thereof.

In at least one embodiment, as shown in FIG. 12, framework layer 1220 includes, without limitation, a job scheduler 1232, a configuration manager 1234, a resource manager 1236 and a distributed file system 1238. In at least one embodiment, framework layer 1220 may include a framework to support software 1252 of software layer 1230 and/or one or more application(s) 1242 of application layer 1240. In at least one embodiment, software 1252 or application(s) 1242 may respectively include web-based service software or applications, such as those provided by Amazon Web Services, Google Cloud and Microsoft Azure. In at least one embodiment, framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1232 may include a Spark driver to facilitate scheduling of workloads supported by various layers of data center 1200. In at least one embodiment, configuration manager 1234 may be capable of configuring different layers such as software layer 1230 and framework layer 1220, including Spark and distributed file system 1238 for supporting large-scale data processing. In at least one embodiment, resource manager 1236 may be capable of managing clustered or grouped computing resources mapped to or allocated for support of distributed file system 1238 and job scheduler 1232. In at least one embodiment, clustered or grouped computing resources may include grouped computing resource 1214 at data center infrastructure layer 1210. In at least one embodiment, resource manager 1236 may coordinate with resource orchestrator 1212 to manage these mapped or allocated computing resources.

In at least one embodiment, software 1252 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. In at least one or more types of applications may include, without limitation, CUDA applications, 5G network applications, artificial intelligence application, data center applications, and/or variations thereof.

In at least one embodiment, any of configuration manager 1234, resource manager 1236, and resource orchestrator 1212 may implement any number and type of self-modifying actions based on any amount and type of data acquired in any technically feasible fashion. In at least one embodiment, self-modifying actions may relieve a data center operator of data center 1200 from making possibly bad configuration decisions and possibly avoiding underutilized and/or poor performing portions of a data center.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

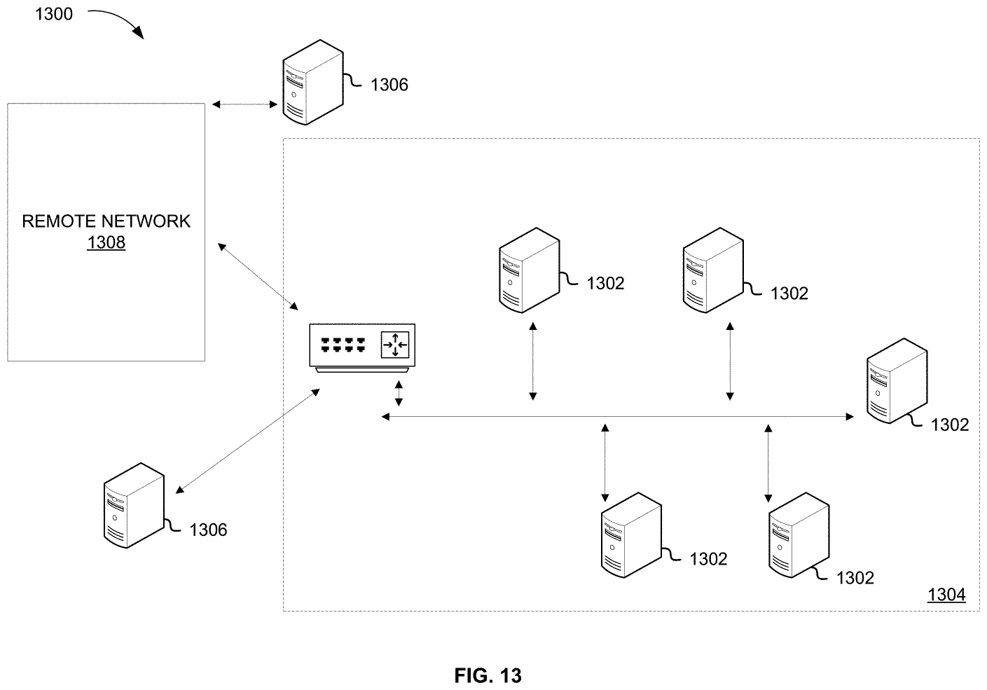

FIG. 13 illustrates a client-server network 1304 formed by a plurality of network server computers 1302 which are interlinked, in accordance with at least one embodiment. In at least one embodiment, each network server computer 1302 stores data accessible to other network server computers 1302 and to client computers 1306 and networks 1308 which link into a wide area network 1304. In at least one embodiment, configuration of a client-server network 1304 may change over time as client computers 1306 and one or more networks 1308 connect and disconnect from a network 1304, and as one or more trunk line server computers 1302 are added or removed from a network 1304. In at least one embodiment, when a client computer 1306 and a network 1308 are connected with network server computers 1302, client-server network includes such client computer 1306 and network 1308. In at least one embodiment, the term computer includes any device or machine capable of accepting data, applying prescribed processes to data, and supplying results of processes.

In at least one embodiment, client-server network 1304 stores information which is accessible to network server computers 1302, remote networks 1308 and client computers 1306. In at least one embodiment, network server computers 1302 are formed by main frame computers minicomputers, and/or microcomputers having one or more processors each. In at least one embodiment, server computers 1302 are linked together by wired and/or wireless transfer media, such as conductive wire, fiber optic cable, and/or microwave transmission media, satellite transmission media or other conductive, optic or electromagnetic wave transmission media. In at least one embodiment, client computers 1306 access a network server computer 1302 by a similar wired or a wireless transfer medium. In at least one embodiment, a client computer 1306 may link into a client-server network 1304 using a modem and a standard telephone communication network. In at least one embodiment, alternative carrier systems such as cable and satellite communication systems also may be used to link into client-server network 1304. In at least one embodiment, other private or time-shared carrier systems may be used. In at least one embodiment, network 1304 is a global information network, such as the Internet. In at least one embodiment, network is a private intranet using similar protocols as the Internet, but with added security measures and restricted access controls. In at least one embodiment, network 1304 is a private, or semi-private network using proprietary communication protocols.

In at least one embodiment, client computer 1306 is any end user computer, and may also be a mainframe computer, mini-computer or microcomputer having one or more microprocessors. In at least one embodiment, server computer 1302 may at times function as a client computer accessing another server computer 1302. In at least one embodiment, remote network 1308 may be a local area network, a network added into a wide area network through an independent service provider (ISP) for the Internet, or another group of computers interconnected by wired or wireless transfer media having a configuration which is either fixed or changing over time. In at least one embodiment, client computers 1306 may link into and access a network 1304 independently or through a remote network 1308.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

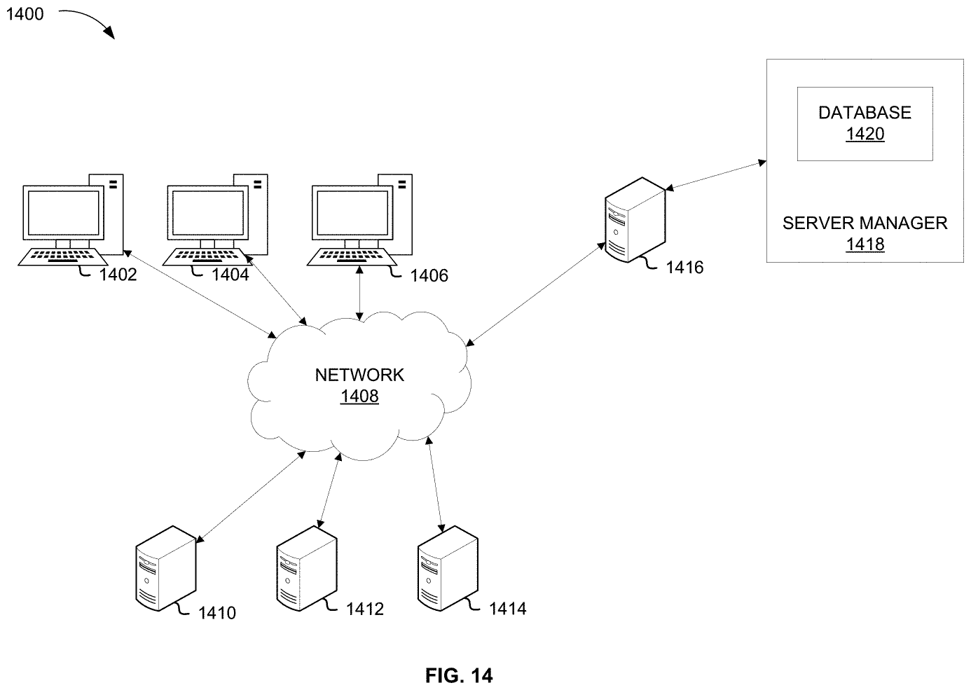

FIG. 14 illustrates a computer network 1408 connecting one or more computing machines, in accordance with at least one embodiment. In at least one embodiment, network 1408 may be any type of electronically connected group of computers including, for instance, the following networks: Internet, Intranet, Local Area Networks (LAN), Wide Area Networks (WAN) or an interconnected combination of these network types. In at least one embodiment, connectivity within a network 1408 may be a remote modem, Ethernet (IEEE 802.3), Token Ring (IEEE 802.5), Fiber Distributed Datalink Interface (FDDI), Asynchronous Transfer Mode (ATM), or any other communication protocol. In at least one embodiment, computing devices linked to a network may be desktop, server, portable, handheld, set-top box, personal digital assistant (PDA), a terminal, or any other desired type or configuration. In at least one embodiment, depending on their functionality, network connected devices may vary widely in processing power, internal memory, and other performance aspects. In at least one embodiment, communications within a network and to or from computing devices connected to a network may be either wired or wireless. In at least one embodiment, network 1408 may include, at least in part, the world-wide public Internet which generally connects a plurality of users in accordance with a client-server model in accordance with a transmission control protocol/internet protocol (TCP/IP) specification. In at least one embodiment, client-server network is a dominant model for communicating between two computers. In at least one embodiment, a client computer (“client”) issues one or more commands to a server computer (“server”). In at least one embodiment, server fulfills client commands by accessing available network resources and returning information to a client pursuant to client commands. In at least one embodiment, client computer systems and network resources resident on network servers are assigned a network address for identification during communications between elements of a network. In at least one embodiment, communications from other network connected systems to servers will include a network address of a relevant server/network resource as part of communication so that an appropriate destination of a data/request is identified as a recipient. In at least one embodiment, when a network 1408 comprises the global Internet, a network address is an IP address in a TCP/IP format which may, at least in part, route data to an e-mail account, a website, or other Internet tool resident on a server. In at least one embodiment, information and services which are resident on network servers may be available to a web browser of a client computer through a domain name (e.g. www.site.com) which maps to an IP address of a network server.

In at least one embodiment, a plurality of clients 1402, 1404, and 1406 are connected to a network 1408 via respective communication links. In at least one embodiment, each of these clients may access a network 1408 via any desired form of communication, such as via a dial-up modem connection, cable link, a digital subscriber line (DSL), wireless or satellite link, or any other form of communication. In at least one embodiment, each client may communicate using any machine that is compatible with a network 1408, such as a personal computer (PC), work station, dedicated terminal, personal data assistant (PDA), or other similar equipment. In at least one embodiment, clients 1402, 1404, and 1406 may or may not be located in a same geographical area.

In at least one embodiment, a plurality of servers 1410, 1412, and 1414 are connected to a network 1408 to serve clients that are in communication with a network 1408. In at least one embodiment, each server is typically a powerful computer or device that manages network resources and responds to client commands. In at least one embodiment, servers include computer readable data storage media such as hard disk drives and RAM memory that store program instructions and data. In at least one embodiment, servers 1410, 1412, 1414 run application programs that respond to client commands. In at least one embodiment, server 1410 may run a web server application for responding to client requests for HTML pages and may also run a mail server application for receiving and routing electronic mail. In at least one embodiment, other application programs, such as an FTP server or a media server for streaming audio/video data to clients may also be running on a server 1410. In at least one embodiment, different servers may be dedicated to performing different tasks. In at least one embodiment, server 1410 may be a dedicated web server that manages resources relating to web sites for various users, whereas a server 1412 may be dedicated to provide electronic mail (email) management. In at least one embodiment, other servers may be dedicated for media (audio, video, etc.), file transfer protocol (FTP), or a combination of any two or more services that are typically available or provided over a network. In at least one embodiment, each server may be in a location that is the same as or different from that of other servers. In at least one embodiment, there may be multiple servers that perform mirrored tasks for users, thereby relieving congestion or minimizing traffic directed to and from a single server. In at least one embodiment, servers 1410, 1412, 1414 are under control of a web hosting provider in a business of maintaining and delivering third party content over a network 1408.

In at least one embodiment, web hosting providers deliver services to two different types of clients. In at least one embodiment, one type, which may be referred to as a browser, requests content from servers 1410, 1412, 1414 such as web pages, email messages, video clips, etc. In at least one embodiment, a second type, which may be referred to as a user, hires a web hosting provider to maintain a network resource such as a web site, and to make it available to browsers. In at least one embodiment, users contract with a web hosting provider to make memory space, processor capacity, and communication bandwidth available for their desired network resource in accordance with an amount of server resources a user desires to utilize.

In at least one embodiment, in order for a web hosting provider to provide services for both of these clients, application programs which manage a network resources hosted by servers must be properly configured. In at least one embodiment, program configuration process involves defining a set of parameters which control, at least in part, an application program's response to browser requests and which also define, at least in part, a server resources available to a particular user.

In one embodiment, an intranet server 1416 is in communication with a network 1408 via a communication link. In at least one embodiment, intranet server 1416 is in communication with a server manager 1418. In at least one embodiment, server manager 1418 comprises a database of an application program configuration parameters which are being utilized in servers 1410, 1412, 1414. In at least one embodiment, users modify a database 1420 via an intranet 1416, and a server manager 1418 interacts with servers 1410, 1412, 1414 to modify application program parameters so that they match a content of a database. In at least one embodiment, a user logs onto an intranet server 1416 by connecting to an intranet 1416 via computer 1402 and entering authentication information, such as a username and password.

In at least one embodiment, when a user wishes to sign up for new service or modify an existing service, an intranet server 1416 authenticates a user and provides a user with an interactive screen display/control panel that allows a user to access configuration parameters for a particular application program. In at least one embodiment, a user is presented with a number of modifiable text boxes that describe aspects of a configuration of a user's web site or other network resource. In at least one embodiment, if a user desires to increase memory space reserved on a server for its web site, a user is provided with a field in which a user specifies a desired memory space. In at least one embodiment, in response to receiving this information, an intranet server 1416 updates a database 1420. In at least one embodiment, server manager 1418 forwards this information to an appropriate server, and a new parameter is used during application program operation. In at least one embodiment, an intranet server 1416 is configured to provide users with access to configuration parameters of hosted network resources (e.g., web pages, email, FTP sites, media sites, etc.), for which a user has contracted with a web hosting service provider.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

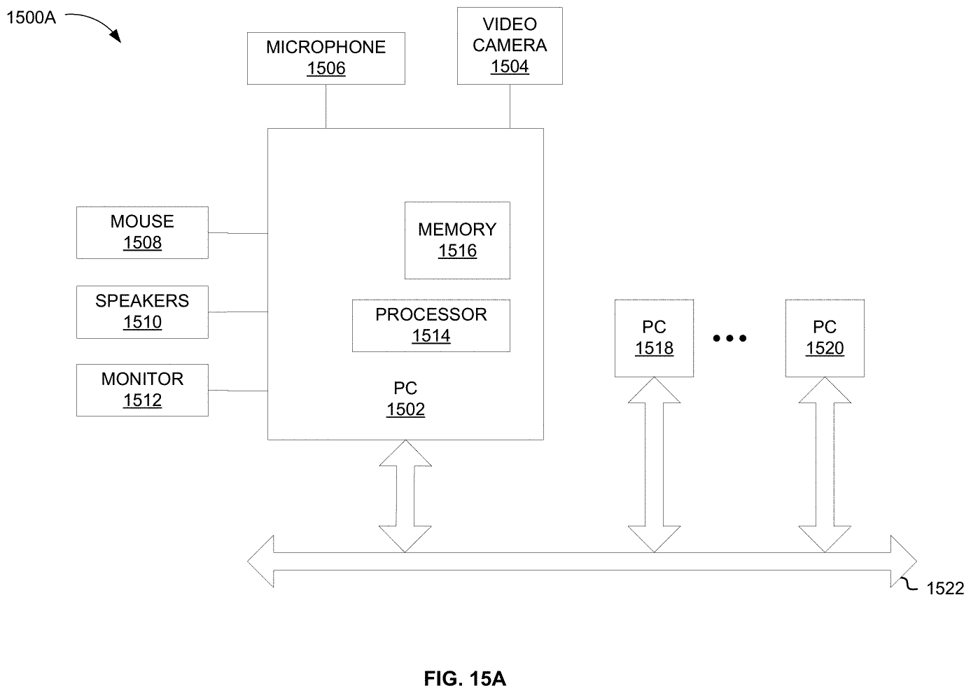

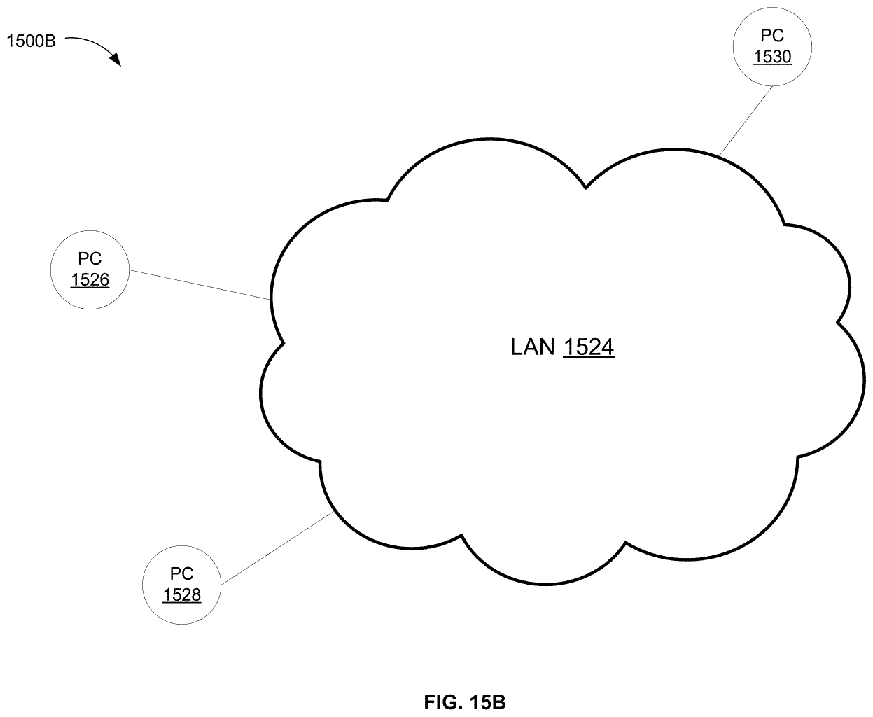

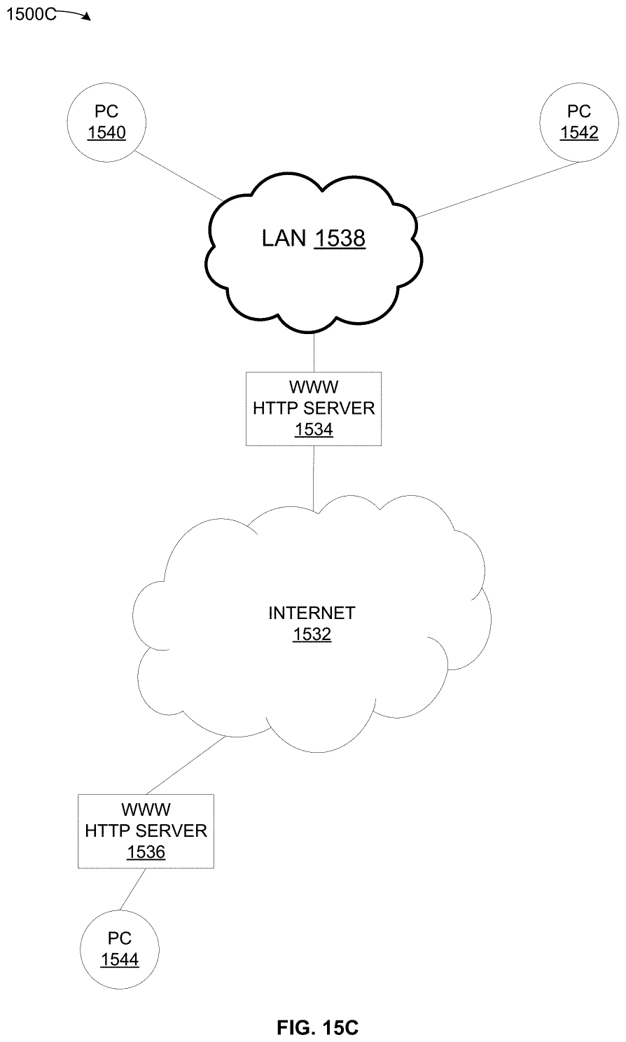

FIG. 15A illustrates a networked computer system 1500A, in accordance with at least one embodiment. In at least one embodiment, networked computer system 1500A comprises a plurality of nodes or personal computers (“PCs”) 1502, 1518, 1520. In at least one embodiment, personal computer or node 1502 comprises a processor 1514, memory 1516, video camera 1504, microphone 1506, mouse 1508, speakers 1510, and monitor 1512. In at least one embodiment, PCs 1502, 1518, 1520 may each run one or more desktop servers of an internal network within a given company, for instance, or may be servers of a general network not limited to a specific environment. In at least one embodiment, there is one server per PC node of a network, so that each PC node of a network represents a particular network server, having a particular network URL address. In at least one embodiment, each server defaults to a default web page for that server's user, which may itself contain embedded URLs pointing to further subpages of that user on that server, or to other servers or pages on other servers on a network.

In at least one embodiment, nodes 1502, 1518, 1520 and other nodes of a network are interconnected via medium 1522. In at least one embodiment, medium 1522 may be, a communication channel such as an Integrated Services Digital Network (“ISDN”). In at least one embodiment, various nodes of a networked computer system may be connected through a variety of communication media, including local area networks (“LANs”), plain-old telephone lines (“POTS”), sometimes referred to as public switched telephone networks (“PSTN”), and/or variations thereof. In at least one embodiment, various nodes of a network may also constitute computer system users inter-connected via a network such as the Internet. In at least one embodiment, each server on a network (running from a particular node of a network at a given instance) has a unique address or identification within a network, which may be specifiable in terms of an URL.

In at least one embodiment, a plurality of multi-point conferencing units (“MCUs”) may thus be utilized to transmit data to and from various nodes or “endpoints” of a conferencing system. In at least one embodiment, nodes and/or MCUs may be interconnected via an ISDN link or through a local area network (“LAN”), in addition to various other communications media such as nodes connected through the Internet. In at least one embodiment, nodes of a conferencing system may, in general, be connected directly to a communications medium such as a LAN or through an MCU, and that a conferencing system may comprise other nodes or elements such as routers, servers, and/or variations thereof.

In at least one embodiment, processor 1514 is a general-purpose programmable processor. In at least one embodiment, processors of nodes of networked computer system 1500A may also be special-purpose video processors. In at least one embodiment, various peripherals and components of a node such as those of node 1502 may vary from those of other nodes. In at least one embodiment, node 1518 and node 1520 may be configured identically to or differently than node 1502. In at least one embodiment, a node may be implemented on any suitable computer system in addition to PC systems.

FIG. 15B illustrates a networked computer system 1500B, in accordance with at least one embodiment. In at least one embodiment, system 1500B illustrates a network such as LAN 1524, which may be used to interconnect a variety of nodes that may communicate with each other. In at least one embodiment, attached to LAN 1524 are a plurality of nodes such as PC nodes 1526, 1528, 1530. In at least one embodiment, a node may also be connected to the LAN via a network server or other means. In at least one embodiment, system 1500B comprises other types of nodes or elements, for example including routers, servers, and nodes.

FIG. 15C illustrates a networked computer system 1500C, in accordance with at least one embodiment. In at least one embodiment, system 1500C illustrates a WWW system having communications across a backbone communications network such as Internet 1532, which may be used to interconnect a variety of nodes of a network. In at least one embodiment, WWW is a set of protocols operating on top of the Internet, and allows a graphical interface system to operate thereon for accessing information through the Internet. In at least one embodiment, attached to Internet 1532 in WWW are a plurality of nodes such as PCs 1540, 1542, 1544. In at least one embodiment, a node is interfaced to other nodes of WWW through a WWW HTTP server such as servers 1534, 1536. In at least one embodiment, PC 1544 may be a PC forming a node of network 1532 and itself running its server 1536, although PC 1544 and server 1536 are illustrated separately in FIG. 15C for illustrative purposes.

In at least one embodiment, WWW is a distributed type of application, characterized by WWW HTTP, WWW's protocol, which runs on top of the Internet's transmission control protocol/Internet protocol (“TCP/IP”). In at least one embodiment, WWW may thus be characterized by a set of protocols (i.e., HTTP) running on the Internet as its “backbone.”

In at least one embodiment, a web browser is an application running on a node of a network that, in WWW-compatible type network systems, allows users of a particular server or node to view such information and thus allows a user to search graphical and text-based files that are linked together using hypertext links that are embedded in documents or files available from servers on a network that understand HTTP. In at least one embodiment, when a given web page of a first server associated with a first node is retrieved by a user using another server on a network such as the Internet, a document retrieved may have various hypertext links embedded therein and a local copy of a page is created local to a retrieving user. In at least one embodiment, when a user clicks on a hypertext link, locally-stored information related to a selected hypertext link is typically sufficient to allow a user's machine to open a connection across the Internet to a server indicated by a hypertext link.

In at least one embodiment, more than one user may be coupled to each HTTP server, for example through a LAN such as LAN 1538 as illustrated with respect to WWW HTTP server 1534. In at least one embodiment, system 1500C may also comprise other types of nodes or elements. In at least one embodiment, a WWW HTTP server is an application running on a machine, such as a PC. In at least one embodiment, each user may be considered to have a unique “server,” as illustrated with respect to PC 1544. In at least one embodiment, a server may be considered to be a server such as WWW HTTP server 1534, which provides access to a network for a LAN or plurality of nodes or plurality of LANs. In at least one embodiment, there are a plurality of users, each having a desktop PC or node of a network, each desktop PC potentially establishing a server for a user thereof. In at least one embodiment, each server is associated with a particular network address or URL, which, when accessed, provides a default web page for that user. In at least one embodiment, a web page may contain further links (embedded URLs) pointing to further subpages of that user on that server, or to other servers on a network or to pages on other servers on a network.

In at least one embodiment, one or more circuits, processors, computing systems, or other devices or techniques are adapted, with reference to said FIGS., to identify a cause of a performance regression by comparing performance metrics associated with a first group of user interactions with a web-based service to performance metrics associated with a second group of user interactions with the web-based service. In at least one embodiment, this is performed by embodiments of said FIGS., according to embodiments described herein in relation to FIGS. 1-10.

### Cloud Computing and Services

The following FIGS. set forth, without limitation, exemplary cloud-based systems that can be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which can be referred to as “in the cloud,” that supports them. In at least one embodiment, cloud computing incorporates infrastructure as a service, platform as a service, software as a service, and other variations that have a common theme of reliance on the Internet for satisfying computing needs of users. In at least one embodiment, a typical cloud deployment, such as in a private cloud (e.g., enterprise network), or a data center (DC) in a public cloud (e.g., Internet) can consist of thousands of servers (or alternatively, VMs), hundreds of Ethernet, Fiber Channel or Fiber Channel over Ethernet (FCoE) ports, switching and storage infrastructure, etc. In at least one embodiment, cloud can also consist of network services infrastructure like IPsec VPN hubs, firewalls, load balancers, wide area network (WAN) optimizers etc. In at least one embodiment, remote subscribers can access cloud applications and services securely by connecting via a VPN tunnel, such as an IPsec VPN tunnel.

In at least one embodiment, cloud computing is a model for enabling convenient, on-demand network access to a shared pool of configurable computing resources (e.g., networks, servers, storage, applications, and services) that can be rapidly provisioned and released with minimal management effort or service provider interaction.

In at least one embodiment, cloud computing is characterized by on-demand self-service, in which a consumer can unilaterally provision computing capabilities, such as server time and network storage, as needed automatically without requiring human inter-action with each service's provider. In at least one embodiment, cloud computing is characterized by broad network access, in which capabilities are available over a network and accessed through standard mechanisms that promote use by heterogeneous thin or thick client platforms (e.g., mobile phones, laptops, and PDAs). In at least one embodiment, cloud computing is characterized by resource pooling, in which a provider's computing resources are pooled to serve multiple consumers using a multi-tenant model, with different physical and virtual resources dynamically as-signed and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). In at least one embodiment, examples of resources include storage, processing, memory, network bandwidth, and virtual machines. In at least one embodiment, cloud computing is characterized by rapid elasticity, in which capabilities can be rapidly and elastically provisioned, in some cases automatically, to quickly scale out and rapidly released to quickly scale in. In at least one embodiment, to a consumer, capabilities available for provisioning often appear to be unlimited and can be purchased in any quantity at any time. In at least one embodiment, cloud computing is characterized by measured service, in which cloud systems automatically control and optimize resource use by leveraging a metering capability at some level of abstraction appropriate to a type of service (e.g., storage, processing, bandwidth, and active user accounts). In at least one embodiment, resource usage can be monitored, controlled, and reported providing transparency for both a provider and consumer of a utilized service.

In at least one embodiment, cloud computing may be associated with various services. In at least one embodiment, cloud Software as a Service (SaaS) may refer to as service in which a capability provided to a consumer is to use a provider's applications running on a cloud infrastructure. In at least one embodiment, applications are accessible from various client devices through a thin client interface such as a web browser (e.g., web-based email). In at least one embodiment, consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which a capability provided to a consumer is to deploy onto cloud infrastructure consumer-created or acquired applications created using programming languages and tools supported by a provider. In at least one embodiment, consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which can include operating systems and applications. In at least one embodiment, consumer does not manage or control underlying cloud infrastructure, but has control over operating systems, storage, deployed applications, and possibly limited control of select networking components (e.g., host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a third party and may exist on-premises or off-premises. In at least one embodiment, a community cloud may refer to a cloud infrastructure that is shared by several organizations and supports a specific community that has shared concerns (e.g., mission, security requirements, policy, and compliance considerations). In at least one embodiment, a community cloud may be managed by organizations or a third party and may exist on-premises or off-premises. In at least one embodiment, a public cloud may refer to a cloud infrastructure that is made available to a general public or a large industry group and is owned by an organization providing cloud services. In at least one embodiment, a hybrid cloud may refer to a cloud infrastructure is a composition of two or more clouds (private, community, or public) that remain unique entities, but are bound together by standardized or proprietary technology that enables data and application portability (e.g., cloud bursting for load-balancing between clouds). In at least one embodiment, a cloud computing environment is service oriented with a focus on statelessness, low coupling, modularity, and semantic interoperability.

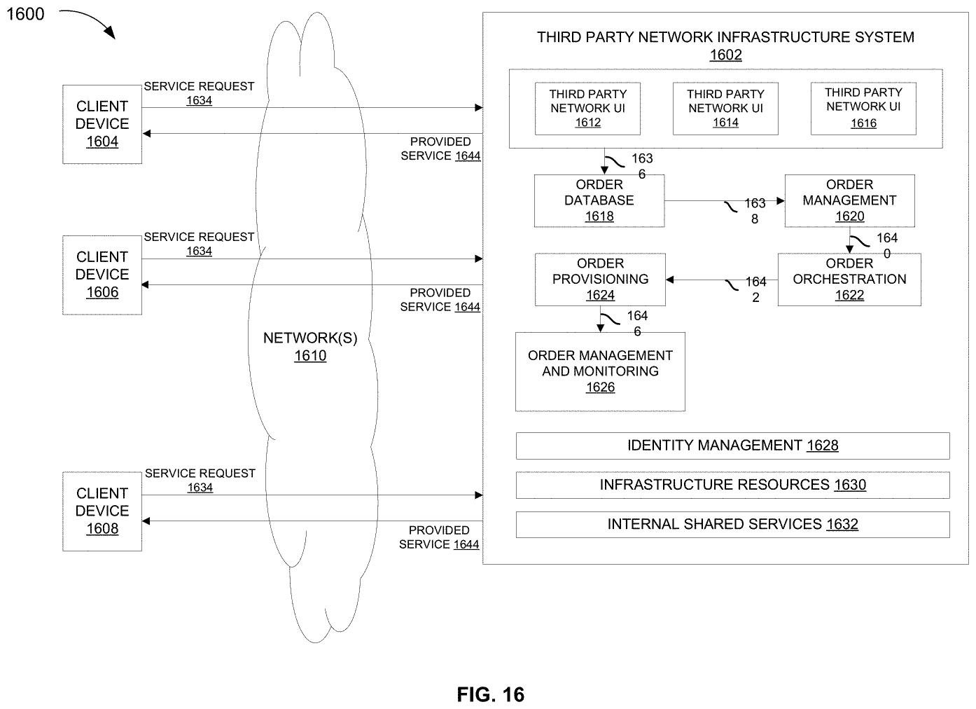

FIG. 16 illustrates one or more components of a system environment 1600 in which services may be offered as third party network services, in accordance with at least one embodiment. In at least one embodiment, a third party network may be referred to as a cloud, cloud network, cloud computing network, and/or variations thereof. In at least one embodiment, system environment 1600 includes one or more client computing devices 1604, 1606, and 1608 that may be used by users to interact with a third party network infrastructure system 1602 that provides third party network services, which may be referred to as cloud computing services. In at least one embodiment, third party network infrastructure system 1602 may comprise one or more computers and/or servers.

It should be appreciated that third party network infrastructure system 1602 depicted in FIG. 16 may have other components than those depicted. Further, FIG. 16 depicts an embodiment of a third party network infrastructure system. In at least one embodiment, third party network infrastructure system 1602 may have more or fewer components than depicted in FIG. 16, may combine two or more components, or may have a different configuration or arrangement of components.

In at least one embodiment, client computing devices 1604, 1606, and 1608 may be configured to operate a client application such as a web browser, a proprietary client application, or some other application, which may be used by a user of a client computing device to interact with third party network infrastructure system 1602 to use services provided by third party network infrastructure system 1602. Although exemplary system environment 1600 is shown with three client computing devices, any number of client computing devices may be supported. In at least one embodiment, other devices such as devices with sensors, etc. may interact with third party network infrastructure system 1602. In at least one embodiment, network(s) 1610 may facilitate communications and exchange of data between client computing devices 1604, 1606, and 1608 and third party network infrastructure system 1602.

In at least one embodiment, services provided by third party network infrastructure system 1602 may include a host of services that are made available to users of a third party network infrastructure system on demand. In at least one embodiment, various services may also be offered including without limitation online data storage and backup solutions, Web-based e-mail services, hosted office suites and document collaboration services, database management and processing, managed technical support services, and/or variations thereof. In at least one embodiment, services provided by a third party network infrastructure system can dynamically scale to meet needs of its users.

In at least one embodiment, a specific instantiation of a service provided by third party network infrastructure system 1602 may be referred to as a “service instance.” In at least one embodiment, in general, any service made available to a user via a communication network, such as the Internet, from a third party network service provider's system is referred to as a “third party network service.” In at least one embodiment, in a public third party network environment, servers and systems that make up a third party network service provider's system are different from a customer's own on-premises servers and systems. In at least one embodiment, a third party network service provider's system may host an application, and a user may, via a communication network such as the Internet, on demand, order and use an application.

In at least one embodiment, a service in a computer network third party network infrastructure may include protected computer network access to storage, a hosted database, a hosted web server, a software application, or other service provided by a third party network vendor to a user. In at least one embodiment, a service can include password-protected access to remote storage on a third party network through the Internet. In at least one embodiment, a service can include a web service-based hosted relational database and a script-language middleware engine for private use by a networked developer. In at least one embodiment, a service can include access to an email software application hosted on a third party network vendor's web site.

In at least one embodiment, third party network infrastructure system 1602 may include a suite of applications, middleware, and database service offerings that are delivered to a customer in a self-service, subscription-based, elastically scalable, reliable, highly available, and secure manner. In at least one embodiment, third party network infrastructure system 1602 may also provide “big data” related computation and analysis services. In at least one embodiment, term “big data” is generally used to refer to extremely large data sets that can be stored and manipulated by analysts and researchers to visualize large amounts of data, detect trends, and/or otherwise interact with data. In at least one embodiment, big data and related applications can be hosted and/or manipulated by an infrastructure system on many levels and at different scales. In at least one embodiment, tens, hundreds, or thousands of processors linked in parallel can act upon such data in order to present it or simulate external forces on data or what it represents. In at least one embodiment, these data sets can involve structured data, such as that organized in a database or otherwise according to a structured model, and/or unstructured data (e.g., emails, images, data blobs (binary large objects), web pages, complex event processing). In at least one embodiment, by leveraging an ability of an embodiment to relatively quickly focus more (or fewer) computing resources upon an objective, a third party network infrastructure system may be better available to carry out tasks on large data sets based on demand from a business, government agency, research organization, private individual, group of like-minded individuals or organizations, or other entity.

In at least one embodiment, third party network infrastructure system 1602 may be adapted to automatically provision, manage and track a customer's subscription to services offered by third party network infrastructure system 1602. In at least one embodiment, third party network infrastructure system 1602 may provide third party network services via different deployment models. In at least one embodiment, services may be provided under a public third party network model in which third party network infrastructure system 1602 is owned by an organization selling third party network services and services are made available to a general public or different industry enterprises. In at least one embodiment, services may be provided under a private third party network model in which third party network infrastructure system 1602 is operated solely for a single organization and may provide services for one or more entities within an organization. In at least one embodiment, third party network services may also be provided under a community third party network model in which third party network infrastructure system 1602 and services provided by third party network infrastructure system 1602 are shared by several organizations in a related community. In at least one embodiment, third party network services may also be provided under a hybrid third party network model, which is a combination of two or more different models.

In at least one embodiment, services provided by third party network infrastructure system 1602 may include one or more services provided under Software as a Service (SaaS) category, Platform as a Service (PaaS) category, Infrastructure as a Service (IaaS) category, or other categories of services including hybrid services. In at least one embodiment, a customer, via a subscription order, may order one or more services provided by third party network infrastructure system 1602. In at least one embodiment, third party network infrastructure system 1602 then performs processing to provide services in a customer's subscription order.

In at least one embodiment, services provided by third party network infrastructure system 1602 may include, without limitation, application services, platform services and infrastructure services. In at least one embodiment, application services may be provided by a third party network infrastructure system via a SaaS platform. In at least one embodiment, SaaS platform may be configured to provide third party network services that fall under a SaaS category. In at least one embodiment, SaaS platform may provide capabilities to build and deliver a suite of on-demand applications on an integrated development and deployment platform. In at least one embodiment, SaaS platform may manage and control underlying software and infrastructure for providing SaaS services. In at least one embodiment, by utilizing services provided by a SaaS platform, customers can utilize applications executing on a third party network infrastructure system. In at least one embodiment, customers can acquire an application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by third party network infrastructure system 1602 via a PaaS platform. In at least one embodiment, PaaS platform may be configured to provide third party network services that fall under a PaaS category. In at least one embodiment, examples of platform services may include without limitation services that enable organizations to consolidate existing applications on a shared, common architecture, as well as an ability to build new applications that leverage shared services provided by a platform. In at least one embodiment, PaaS platform may manage and control underlying software and infrastructure for providing PaaS services. In at least one embodiment, customers can acquire PaaS services provided by third party network infrastructure system 1602 without a need for customers to purchase separate licenses and support.

In at least one embodiment, by utilizing services provided by a PaaS platform, customers can employ programming languages and tools supported by a third party network infrastructure system and also control deployed services. In at least one embodiment, platform services provided by a third party network infrastructure system may include database third party network services, middleware third party network services and third party network services. In at least one embodiment, database third party network services may support shared service deployment models that enable organizations to pool database resources and offer customers a Database as a Service in a form of a database third party network. In at least one embodiment, middleware third party network services may provide a platform for customers to develop and deploy various business applications, and third party network services may provide a platform for customers to deploy applications, in a third party network infrastructure system.

In at least one embodiment, various different infrastructure services may be provided by an IaaS platform in a third party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, third party network infrastructure system 1602 may also include infrastructure resources 1630 for providing resources used to provide various services to customers of a third party network infrastructure system. In at least one embodiment, infrastructure resources 1630 may include pre-integrated and optimized combinations of hardware, such as servers, storage, and networking resources to execute services provided by a Paas platform and a Saas platform, and other resources.

In at least one embodiment, resources in third party network infrastructure system 1602 may be shared by multiple users and dynamically re-allocated per demand. In at least one embodiment, resources may be allocated to users in different time zones. In at least one embodiment, third party network infrastructure system 1602 may enable a first set of users in a first time zone to utilize resources of a third party network infrastructure system for a specified number of hours and then enable a re-allocation of same resources to another set of users located in a different time zone, thereby maximizing utilization of resources.

In at least one embodiment, a number of internal shared services 1632 may be provided that are shared by different components or modules of third party network infrastructure system 1602 to enable provision of services by third party network infrastructure system 1602. In at least one embodiment, these internal shared services may include, without limitation, a security and identity service, an integration service, an enterprise repository service, an enterprise manager service, a virus scanning and white list service, a high availability, backup and recovery service, service for enabling third party network support, an email service, a notification service, a file transfer service, and/or variations thereof.

In at least one embodiment, third party network infrastructure system 1602 may provide comprehensive management of third party network services (e.g., SaaS, PaaS, and IaaS services) in a third party network infrastructure system. In at least one embodiment, third party network management functionality may include capabilities for provisioning, managing and tracking a customer's subscription received by third party network infrastructure system 1602, and/or variations thereof.

In at least one embodiment, as depicted in FIG. 16, third party network management functionality may be provided by one or more modules, such as an order management module 1620, an order orchestration module 1622, an order provisioning module 1624, an order management and monitoring module 1626, and an identity management module 1628. In at least one embodiment, these modules may include or be provided using one or more computers and/or servers, which may be general purpose computers, specialized server computers, server farms, server clusters, or any other appropriate arrangement and/or combination.

In at least one embodiment, at step 1634, a customer using a client device, such as client computing devices 1604, 1606 or 1608, may interact with third party network infrastructure system 1602 by requesting one or more services provided by third party network infrastructure system 1602 and placing an order for a subscription for one or more services offered by third party network infrastructure system 1602. In at least one embodiment, a customer may access a third party network User Interface (UI) such as third party network UI 1612, third party network UI 1614 and/or third party network UI 1616 and place a subscription order via these UIs. In at least one embodiment, order information received by third party network infrastructure system 1602 in response to a customer placing an order may include information identifying a customer and one or more services offered by a third party network infrastructure system 1602 that a customer intends to subscribe to.

In at least one embodiment, at step 1636, an order information received from a customer may be stored in an order database 1618. In at least one embodiment, if this is a new order, a new record may be created for an order. In at least one embodiment, order database 1618 can be one of several databases operated by third party network infrastructure system 1618 and operated in conjunction with other system elements.

In at least one embodiment, at step 1638, an order information may be forwarded to an order management module 1620 that may be configured to perform billing and accounting functions related to an order, such as verifying an order, and upon verification, booking an order.

In at least one embodiment, at step 1640, information regarding an order may be communicated to an order orchestration module 1622 that is configured to orchestrate provisioning of services and resources for an order placed by a customer. In at least one embodiment, order orchestration module 1622 may use services of order provisioning module 1624 for provisioning. In at least one embodiment, order orchestration module 1622 enables management of business processes associated with each order and applies business logic to determine whether an order should proceed to provisioning.

In at least one embodiment, at step 1642, upon receiving an order for a new subscription, order orchestration module 1622 sends a request to order provisioning module 1624 to allocate resources and configure resources needed to fulfill a subscription order. In at least one embodiment, order provisioning module 1624 enables an allocation of resources for services ordered by a customer. In at least one embodiment, order provisioning module 1624 provides a level of abstraction between third party network services provided by third party network infrastructure system 1600 and a physical implementation layer that is used to provision resources for providing requested services. In at least one embodiment, this enables order orchestration module 1622 to be isolated from implementation details, such as whether or not services and resources are actually provisioned in real-time or pre-provisioned and only allocated/assigned upon request.

In at least one embodiment, at step 1644, once services and resources are provisioned, a notification may be sent to subscribing customers indicating that a requested service is now ready for use. In at least one embodiment, information (e.g. a link) may be sent to a customer that enables a customer to start using requested services.

In at least one embodiment, at step 1646, a customer's subscription order may be managed and tracked by an order management and monitoring module 1626. In at least one embodiment, order management and monitoring module 1626 may be configured to collect usage statistics regarding a customer use of subscribed services. In at least one embodiment, statistics may be collected for an amount of storage used, an amount data transferred, a number of users, and an amount of system up time and system down time, and/or variations thereof.

In at least one embodiment, third party network infrastructure system 1600 may include an identity management module 1628 that is configured to provide identity services, such as access management and authorization services in third party network infrastructure system 1600. In at least one embodiment, identity management module 1628 may control information about customers who wish to utilize services provided by third party network infrastructure system 1602. In at least one embodiment, such information can include information that authenticates identities of such customers and information that describes which actions those customers are authorized to perform relative to various system resources (e.g., files, directories, applications, communication ports, memory segments, etc.). In at least one embodiment, identity management module 1628 may also include management of descriptive information about each customer and about how and by whom that descriptive information can be accessed and modified.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

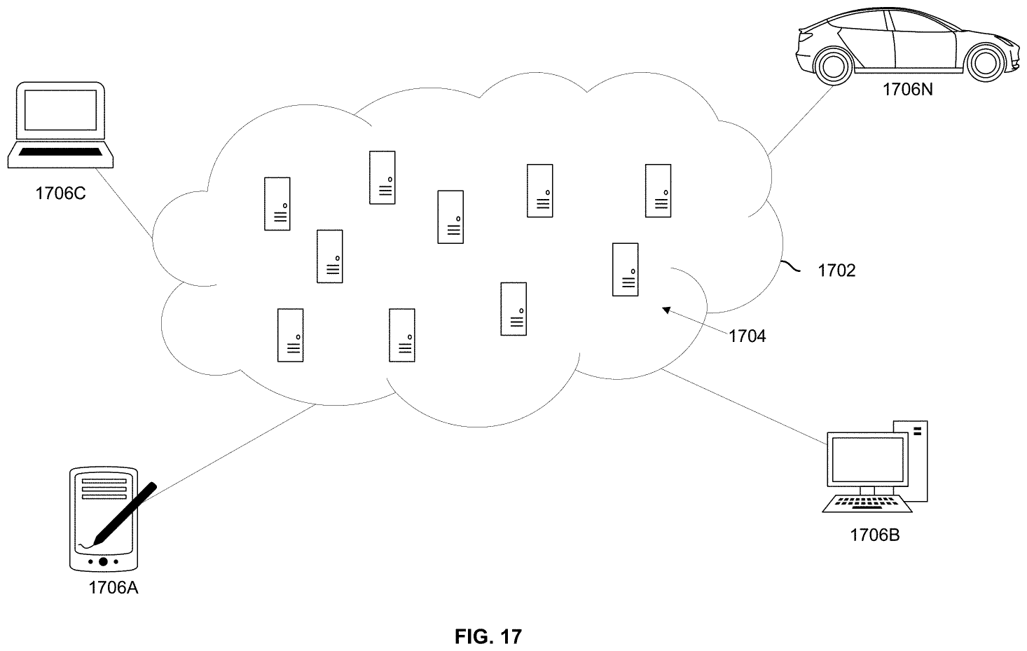

FIG. 17 illustrates a cloud computing environment 1702, in accordance with at least one embodiment. In at least one embodiment, cloud computing environment 1702 comprises one or more computer system/servers 1704 with which computing devices such as, personal digital assistant (PDA) or cellular telephone 1706A, desktop computer 1706B, laptop computer 1706C, and/or automobile computer system 1706N communicate. In at least one embodiment, this allows for infrastructure, platforms and/or software to be offered as services from cloud computing environment 1702, so as to not require each client to separately maintain such resources. It is understood that types of computing devices 1706A-N shown in FIG. 17 are intended to be illustrative only and that cloud computing environment 1702 can communicate with any type of computerized device over any type of network and/or network/addressable connection (e.g., using a web browser).

In at least one embodiment, a computer system/server 1704, which can be denoted as a cloud computing node, is operational with numerous other general purpose or special purpose computing system environments or configurations. In at least one embodiment, examples of computing systems, environments, and/or configurations that may be suitable for use with computer system/server 1704 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and/or variations thereof.

In at least one embodiment, computer system/server 1704 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, exemplary computer system/server 1704 may be practiced in distributed loud computing environments where tasks are performed by remote processing devices that are linked through a communications network. In at least one embodiment, in a distributed cloud computing environment, program modules may be located in both local and remote computer system storage media including memory storage devices.

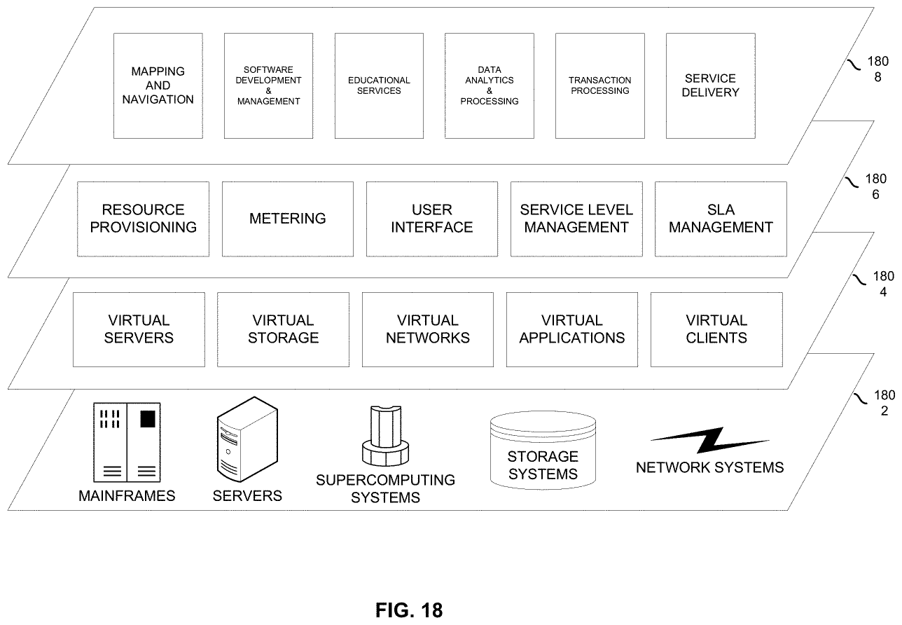

FIG. 18 illustrates a set of functional abstraction layers provided by cloud computing environment 1702 (FIG. 17), in accordance with at least one embodiment. It should be understood in advance that components, layers, and functions shown in FIG. 18 are intended to be illustrative only, and components, layers, and functions may vary.

In at least one embodiment, hardware and software layer 1802 includes hardware and software components. In at least one embodiment, examples of hardware components include mainframes, various RISC (Reduced Instruction Set Computer) architecture based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 1804 provides an abstraction layer from which following exemplary virtual entities may be provided: virtual servers, virtual storage, virtual networks, including virtual private networks, virtual applications, virtual clients, and/or variations thereof.

In at least one embodiment, management layer 1806 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, user interface provides access to a cloud computing environment for both users and system administrators. In at least one embodiment, service level management provides cloud computing resource allocation and management such that required service levels are met. In at least one embodiment, Service Level Agreement (SLA) management provides pre-arrangement for, and procurement of, cloud computing resources for which a future requirement is anticipated in accordance with an SLA.

In at least one embodiment, workloads layer 1808 provides functionality for which a cloud computing environment is utilized. In at least one embodiment, examples of workloads and functions which may be provided from this layer include: mapping and navigation, software development and management, educational services, data analytics and processing, transaction processing, and service delivery.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### Supercomputing

The following FIGS. set forth, without limitation, exemplary supercomputer-based systems that can be used to implement at least one embodiment.

In at least one embodiment, a supercomputer may refer to a hardware system exhibiting substantial parallelism and comprising at least one chip, where chips in a system are interconnected by a network and are placed in hierarchically organized enclosures. In at least one embodiment, a large hardware system filling a machine room, with several racks, each containing several boards/rack modules, each containing several chips, all interconnected by a scalable network, is one particular example of a supercomputer. In at least one embodiment, a single rack of such a large hardware system is another example of a supercomputer. In at least one embodiment, a single chip exhibiting substantial parallelism and containing several hardware components can equally be considered to be a supercomputer, since as feature sizes may decrease, an amount of hardware that can be incorporated in a single chip may also increase.

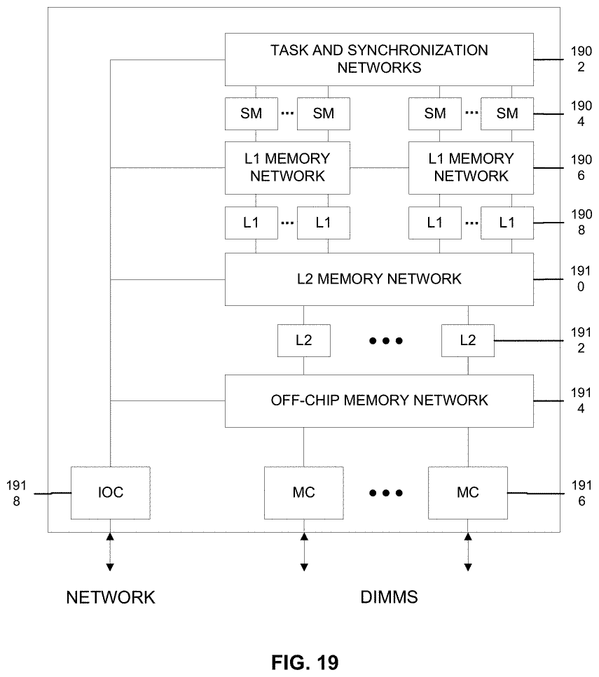

FIG. 19 illustrates a supercomputer at a chip level, in accordance with at least one embodiment. In at least one embodiment, inside an FPGA or ASIC chip, main computation is performed within finite state machines (1904) called thread units. In at least one embodiment, task and synchronization networks (1902) connect finite state machines and are used to dispatch threads and execute operations in correct order. In at least one embodiment, a multi-level partitioned on-chip cache hierarchy (1908, 1912) is accessed using memory networks (1906, 1910). In at least one embodiment, off-chip memory is accessed using memory controllers (1916) and an off-chip memory network (1914). In at least one embodiment, I/O controller (1918) is used for cross-chip communication when a design does not fit in a single logic chip.

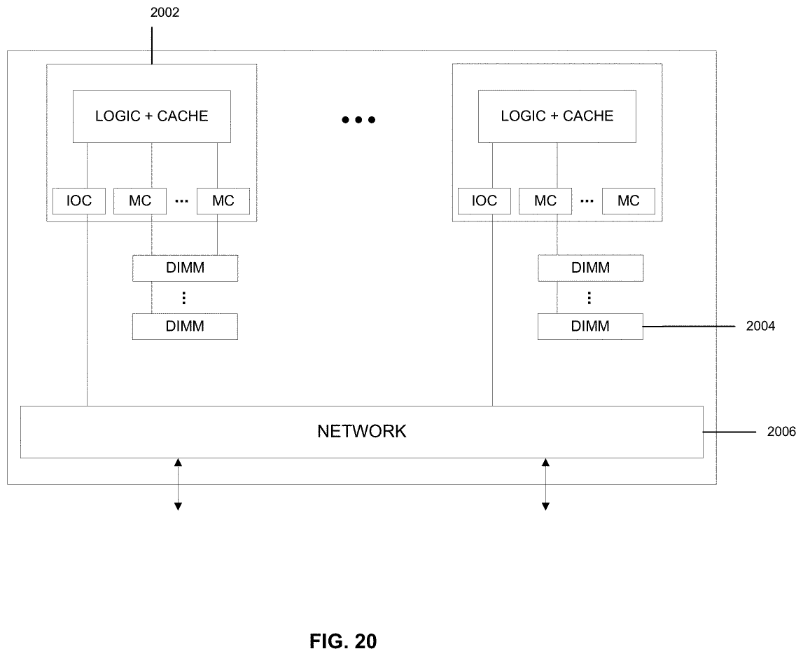

FIG. 20 illustrates a supercomputer at a rock module level, in accordance with at least one embodiment. In at least one embodiment, within a rack module, there are multiple FPGA or ASIC chips (2002) that are connected to one or more DRAM units (2004) which constitute main accelerator memory. In at least one embodiment, each FPGA/ASIC chip is connected to its neighbor FPGA/ASIC chip using wide busses on a board, with differential high speed signaling (2006). In at least one embodiment, each FPGA/ASIC chip is also connected to at least one high-speed serial communication cable.

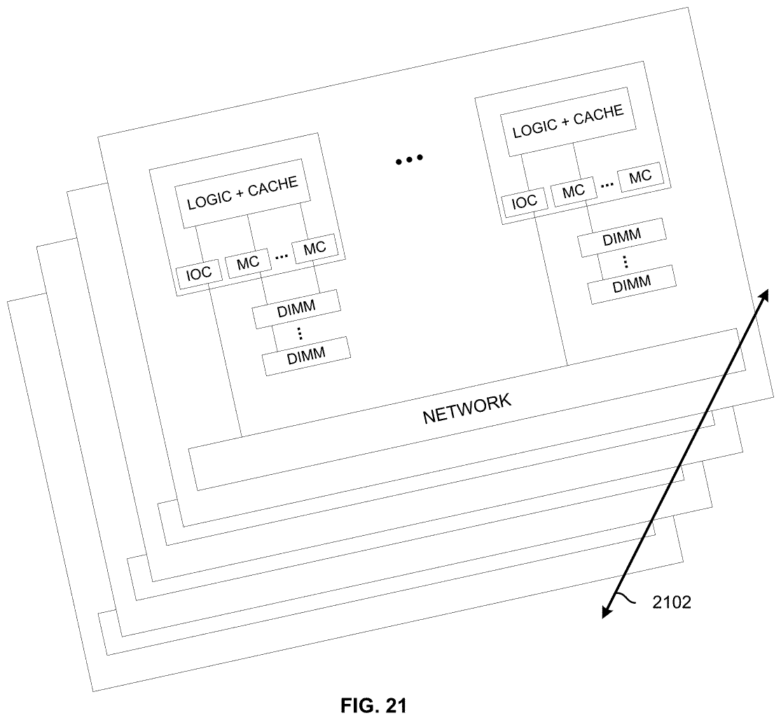

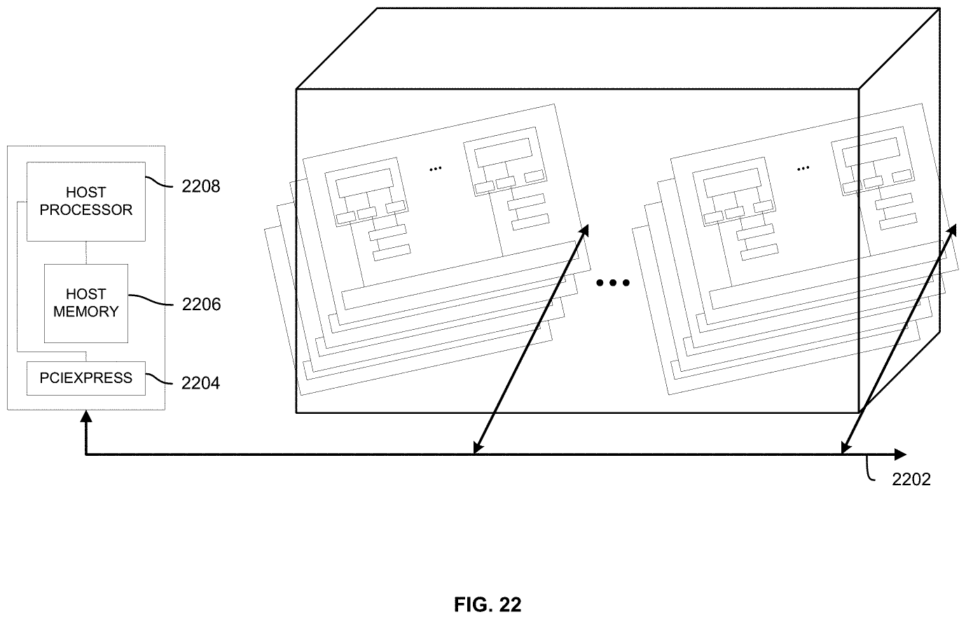

FIG. 21 illustrates a supercomputer at a rack level, in accordance with at least one embodiment. FIG. 22 illustrates a supercomputer at a whole system level, in accordance with at least one embodiment. In at least one embodiment, referring to FIG. 21 and FIG. 22, between rack modules in a rack and across racks throughout an entire system, high-speed serial optical or copper cables (2102, 2202) are used to realize a scalable, possibly incomplete hypercube network. In at least one embodiment, one of FPGA/ASIC chips of an accelerator is connected to a host system through a PCI-Express connection (2204). In at least one embodiment, host system comprises a host microprocessor (2208) that a software part of an application runs on and a memory consisting of one or more host memory DRAM units (2206) that is kept coherent with memory on an accelerator. In at least one embodiment, host system can be a separate module on one of racks, or can be integrated with one of a supercomputer's modules. In at least one embodiment, cube-connected cycles topology provide communication links to create a hypercube network for a large supercomputer. In at least one embodiment, a small group of FPGA/ASIC chips on a rack module can act as a single hypercube node, such that a total number of external links of each group is increased, compared to a single chip. In at least one embodiment, a group contains chips A, B, C and D on a rack module with internal wide differential busses connecting A, B, C and D in a torus organization. In at least one embodiment, there are 12 serial communication cables connecting a rack module to an outside world. In at least one embodiment, chip A on a rack module connects to serial communication cables 0, 1, 2. In at least one embodiment, chip B connects to cables 3, 4, 5. In at least one embodiment, chip C connects to 6, 7, 8. In at least one embodiment, chip D connects to 9, 10, 11. In at least one embodiment, an entire group {A, B, C, D} constituting a rack module can form a hypercube node within a supercomputer system, with up to 212=4096 rack modules (16384 FPGA/ASIC chips). In at least one embodiment, for chip A to send a message out on link 4 of group {A, B, C, D}, a message has to be routed first to chip B with an on-board differential wide bus connection. In at least one embodiment, a message arriving into a group {A, B, C, D} on link 4 (i.e., arriving at B) destined to chip A, also has to be routed first to a correct destination chip (A) internally within a group {A, B, C, D}. In at least one embodiment, parallel supercomputer systems of other sizes may also be implemented.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### Artificial Intelligence

The following FIGS. set forth, without limitation, exemplary artificial intelligence-based systems that can be used to implement at least one embodiment.

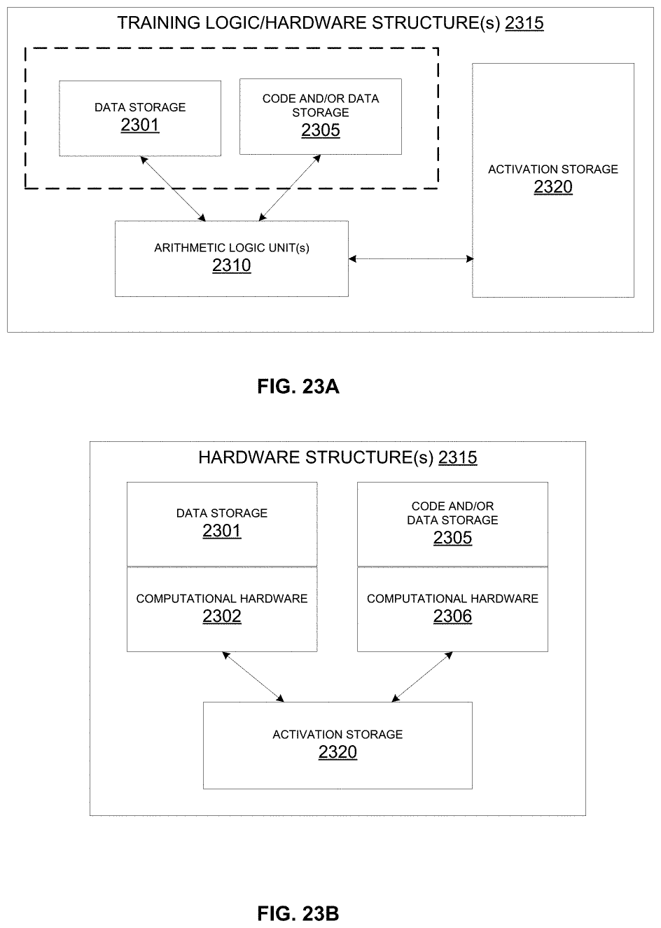

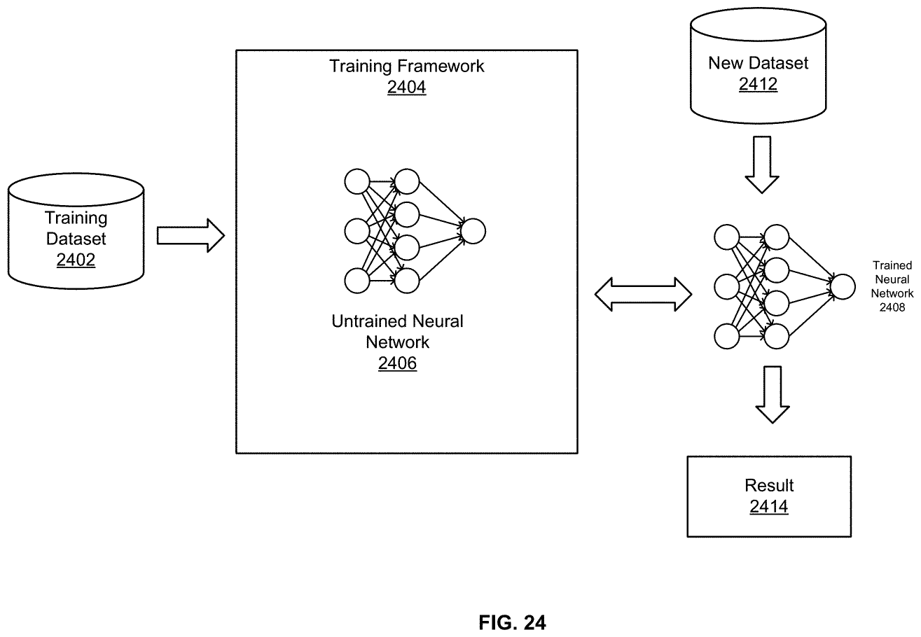

FIG. 23A illustrates inference and/or training logic 2315 used to perform inferencing and/or training operations associated with one or more embodiments. Details regarding inference and/or training logic 2315 are provided below in conjunction with FIGS. 23A and/or 23B.

In at least one embodiment, inference and/or training logic 2315 may include, without limitation, code and/or data storage 2301 to store forward and/or output weight and/or input/output data, and/or other parameters to configure neurons or layers of a neural network trained and/or used for inferencing in aspects of one or more embodiments. In at least one embodiment, training logic 2315 may include, or be coupled to code and/or data storage 2301 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which such code corresponds. In at least one embodiment code and/or data storage 2301 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 2301 may be included with other on-chip or off-chip data storage, including a processor's L1, L2, or L3 cache or system memory.

In at least one embodiment, any portion of code and/or data storage 2301 may be internal or external to one or more processors or other hardware logic devices or circuits. In at least one embodiment, code and/or code and/or data storage 2301 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 2301 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2315 may include, without limitation, a code and/or data storage 2305 to store backward and/or output weight and/or input/output data corresponding to neurons or layers of a neural network trained and/or used for inferencing in aspects of one or more embodiments. In at least one embodiment, code and/or data storage 2305 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 2315 may include, or be coupled to code and/or data storage 2305 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes loading of weight or other parameter information into processor ALUs based on an architecture of a neural network to which such code corresponds. In at least one embodiment, any portion of code and/or data storage 2305 may be included with other on-chip or off-chip data storage, including a processor's L1, L2, or L3 cache or system memory. In at least one embodiment, any portion of code and/or data storage 2305 may be internal or external to one or more processors or other hardware logic devices or circuits. In at least one embodiment, code and/or data storage 2305 may be cache memory, DRAM, SRAM, non-volatile memory (e.g., flash memory), or other storage. In at least one embodiment, a choice of whether code and/or data storage 2305 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 2301 and code and/or data storage 2305 may be separate storage structures. In at least one embodiment, code and/or data storage 2301 and code and/or data storage 2305 may be a combined storage structure. In at least one embodiment, code and/or data storage 2301 and code and/or data storage 2305 may be partially combined and partially separate. In at least one embodiment, any portion of code and/or data storage 2301 and code and/or data storage 2305 may be included with other on-chip or off-chip data storage, including a processor's L1, L2, or L3 cache or system memory.

In at least one embodiment, inference and/or training logic 2315 may include, without limitation, one or more arithmetic logic unit(s) (“ALU(s)”) 2310, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 2320 that are functions of input/output and/or weight parameter data stored in code and/or data storage 2301 and/or code and/or data storage 2305. In at least one embodiment, activations stored in activation storage 2320 are generated according to linear algebraic and or matrix-based mathematics performed by ALU(s) 2310 in response to performing instructions or other code, wherein weight values stored in code and/or data storage 2305 and/or data storage 2301 are used as operands along with other values, such as bias values, gradient information, momentum values, or other parameters or hyperparameters, any or all of which may be stored in code and/or data storage 2305 or code and/or data storage 2301 or another storage on or off-chip.

In at least one embodiment, ALU(s) 2310 are included within one or more processors or other hardware logic devices or circuits, whereas in another embodiment, ALU(s) 2310 may be external to a processor or other hardware logic device or circuit that uses them (e.g., a co-processor). In at least one embodiment, ALUs 2310 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 2301, code and/or data storage 2305, and activation storage 2320 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 2320 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 2320 may be cache memory, DRAM, SRAM, non-volatile memory (e.g., flash memory), or other storage. In at least one embodiment, activation storage 2320 may be completely or partially within or external to one or more processors or other logical circuits. In at least one embodiment, a choice of whether activation storage 2320 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 2315 illustrated in FIG. 23A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 2315 illustrated in FIG. 23A may be used in conjunction with central processing unit (“CPU”) hardware, graphics processing unit (“GPU”) hardware or other hardware, such as field programmable gate arrays (“FPGAs”).

FIG. 23B illustrates inference and/or training logic 2315, according to at least one embodiment. In at least one embodiment, inference and/or training logic 2315 may include, without limitation, hardware logic in which computational resources are dedicated or otherwise exclusively used in conjunction with weight values or other information corresponding to one or more layers of neurons within a neural network. In at least one embodiment, inference and/or training logic 2315 illustrated in FIG. 23B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 2315 illustrated in FIG. 23B may be used in conjunction with central processing unit (CPU) hardware, graphics processing unit (GPU) hardware or other hardware, such as field programmable gate arrays (FPGAs). In at least one embodiment, inference and/or training logic 2315 includes, without limitation, code and/or data storage 2301 and code and/or data storage 2305, which may be used to store code (e.g., graph code), weight values and/or other information, including bias values, gradient information, momentum values, and/or other parameter or hyperparameter information. In at least one embodiment illustrated in FIG. 23B, each of code and/or data storage 2301 and code and/or data storage 2305 is associated with a dedicated computational resource, such as computational hardware 2302 and computational hardware 2306, respectively. In at least one embodiment, each of computational hardware 2302 and computational hardware 2306 comprises one or more ALUs that perform mathematical functions, such as linear algebraic functions, only on information stored in code and/or data storage 2301 and code and/or data storage 2305, respectively, result of which is stored in activation storage 2320.

In at least one embodiment, each of code and/or data storage 2301 and 2305 and corresponding computational hardware 2302 and 2306, respectively, correspond to different layers of a neural network, such that resulting activation from one storage/computational pair 2301/2302 of code and/or data storage 2301 and computational hardware 2302 is provided as an input to a next storage/computational pair 2305/2306 of code and/or data storage 2305 and computational hardware 2306, in order to mirror a conceptual organization of a neural network. In at least one embodiment, each of storage/computational pairs 2301/2302 and 2305/2306 may correspond to more than one neural network layer. In at least one embodiment, additional storage/computation pairs (not shown) subsequent to or in parallel with storage/computation pairs 2301/2302 and 2305/2306 may be included in inference and/or training logic 2315.

In at least one embodiment, one or more circuits, processors, computing systems, or other devices or techniques are adapted, with reference to said FIGS., to identify a cause of a performance regression by comparing performance metrics associated with a first group of user interactions with a web-based service to performance metrics associated with a second group of user interactions with the web-based service. In at least one embodiment, this is performed by embodiments of said FIGS., according to embodiments described herein in relation to FIGS. 1-10.

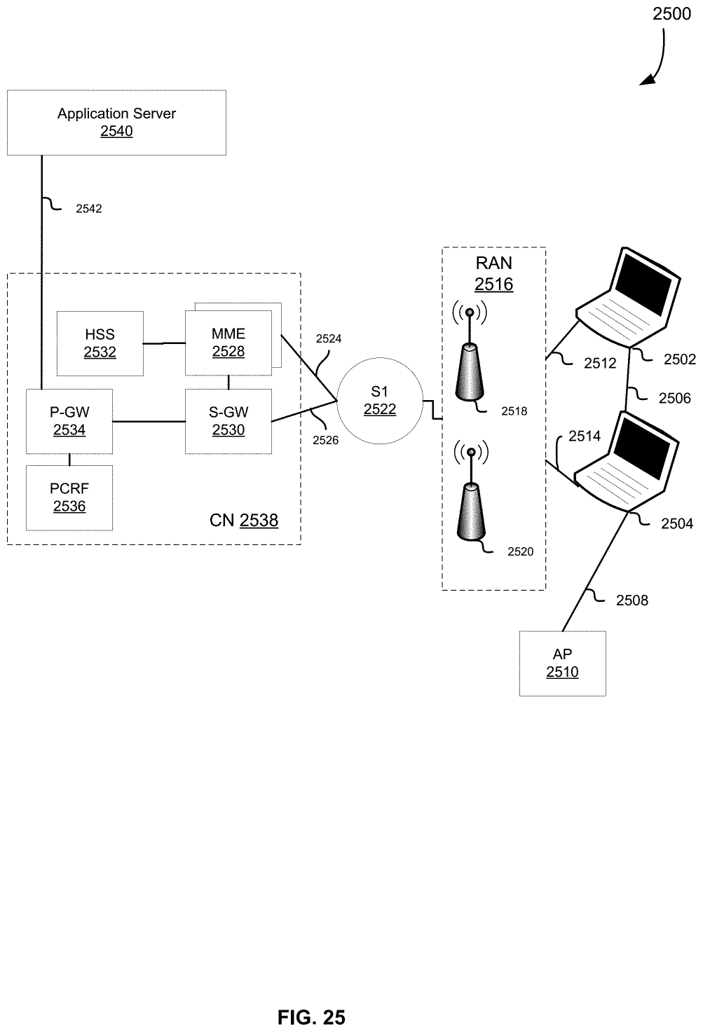

FIG. 24 illustrates training and deployment of a deep neural network, according to at least one embodiment. In at least one embodiment, untrained neural network 2406 is trained using a training dataset 2402. In at least one embodiment, training framework 2404 is a PyTorch framework, whereas in other embodiments, training framework 2404 is a TensorFlow, Boost, Caffe, Microsoft Cognitive Toolkit/CNTK, MXNet, Chainer, Keras, Deeplearning4j, or other training framework. In at least one embodiment, training framework 2404 trains an untrained neural network 2406 and enables it to be trained using processing resources described herein to generate a trained neural network 2408. In at least one embodiment, weights may be chosen randomly or by pre-training using a deep belief network. In at least one embodiment, training may be performed in either a supervised, partially supervised, or unsupervised manner.

In at least one embodiment, untrained neural network 2406 is trained using supervised learning, wherein training dataset 2402 includes an input paired with a desired output for an input, or where training dataset 2402 includes input having a known output and an output of neural network 2406 is manually graded. In at least one embodiment, untrained neural network 2406 is trained in a supervised manner and processes inputs from training dataset 2402 and compares resulting outputs against a set of expected or desired outputs. In at least one embodiment, errors are then propagated back through untrained neural network 2406. In at least one embodiment, training framework 2404 adjusts weights that control untrained neural network 2406. In at least one embodiment, training framework 2404 includes tools to monitor how well untrained neural network 2406 is converging towards a model, such as trained neural network 2408, suitable to generating correct answers, such as in result 2414, based on input data such as a new dataset 2412. In at least one embodiment, training framework 2404 trains untrained neural network 2406 repeatedly while adjust weights to refine an output of untrained neural network 2406 using a loss function and adjustment algorithm, such as stochastic gradient descent. In at least one embodiment, training framework 2404 trains untrained neural network 2406 until untrained neural network 2406 achieves a desired accuracy. In at least one embodiment, trained neural network 2408 can then be deployed to implement any number of machine learning operations.

In at least one embodiment, untrained neural network 2406 is trained using unsupervised learning, wherein untrained neural network 2406 attempts to train itself using unlabeled data. In at least one embodiment, unsupervised learning training dataset 2402 will include input data without any associated output data or “ground truth” data. In at least one embodiment, untrained neural network 2406 can learn groupings within training dataset 2402 and can determine how individual inputs are related to untrained dataset 2402. In at least one embodiment, unsupervised training can be used to generate a self-organizing map in trained neural network 2408 capable of performing operations useful in reducing dimensionality of new dataset 2412. In at least one embodiment, unsupervised training can also be used to perform anomaly detection, which allows identification of data points in new dataset 2412 that deviate from normal patterns of new dataset 2412.

In at least one embodiment, semi-supervised learning may be used, which is a technique in which in training dataset 2402 includes a mix of labeled and unlabeled data. In at least one embodiment, training framework 2404 may be used to perform incremental learning, such as through transferred learning techniques. In at least one embodiment, incremental learning enables trained neural network 2408 to adapt to new dataset 2412 without forgetting knowledge instilled within trained neural network 2408 during initial training.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### 5G Networks

The following FIGS. set forth, without limitation, exemplary 5G network-based systems that can be used to implement at least one embodiment.

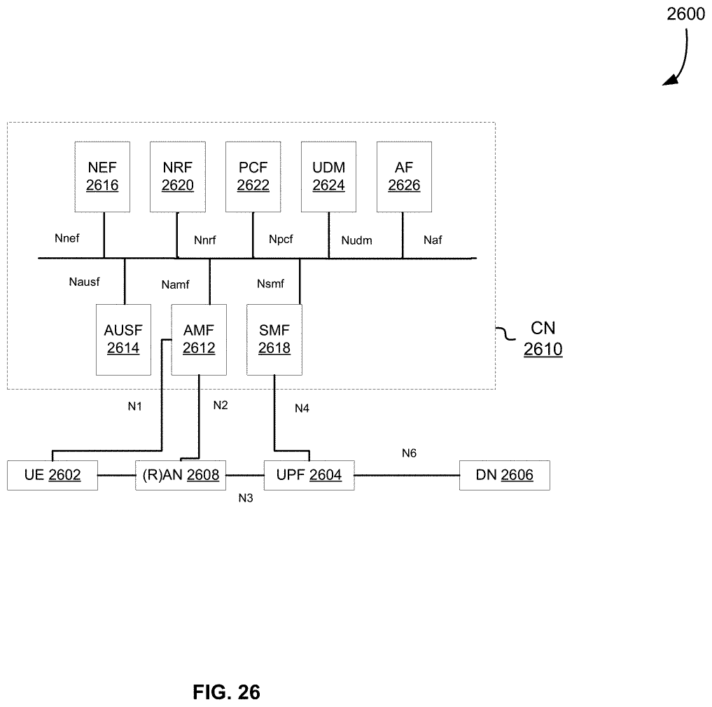

FIG. 25 illustrates an architecture of a system 2500 of a network, in accordance with at least one embodiment. In at least one embodiment, system 2500 is shown to include a user equipment (UE) 2502 and a UE 2504. In at least one embodiment, UEs 2502 and 2504 are illustrated as smartphones (e.g., handheld touchscreen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In at least one embodiment, any of UEs 2502 and 2504 can comprise an Internet of Things (IoT) UE, which can comprise a network access layer designed for low-power IoT applications utilizing short-lived UE connections. In at least one embodiment, an IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. In at least one embodiment, a M2M or MTC exchange of data may be a machine-initiated exchange of data. In at least one embodiment, an IoT network describes interconnecting IoT UEs, which may include uniquely identifiable embedded computing devices (within Internet infrastructure), with short-lived connections. In at least one embodiment, an IoT UEs may execute background applications (e.g., keep alive messages, status updates, etc.) to facilitate connections of an IoT network.

In at least one embodiment, UEs 2502 and 2504 may be configured to connect, e.g., communicatively couple, with a radio access network (RAN) 2516. In at least one embodiment, RAN 2516 may be, for example, an Evolved Universal Mobile Telecommunications System (UMTS) Terrestrial Radio Access Network (E-UTRAN), a NextGen RAN (NG RAN), or some other type of RAN. In at least one embodiment, UEs 2502 and 2504 utilize connections 2512 and 2514, respectively, each of which comprises a physical communications interface or layer. In at least one embodiment, connections 2512 and 2514 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and variations thereof.

In at least one embodiment, UEs 2502 and 2504 may further directly exchange communication data via a ProSe interface 2506. In at least one embodiment, ProSe interface 2506 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In at least one embodiment, UE 2504 is shown to be configured to access an access point (AP) 2510 via connection 2508. In at least one embodiment, connection 2508 can comprise a local wireless connection, such as a connection consistent with any IEEE 802.11 protocol, wherein AP 2510 would comprise a wireless fidelity (WiFi®) router. In at least one embodiment, AP 2510 is shown to be connected to an Internet without connecting to a core network of a wireless system.

In at least one embodiment, RAN 2516 can include one or more access nodes that enable connections 2512 and 2514. In at least one embodiment, these access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). In at least one embodiment, RAN 2516 may include one or more RAN nodes for providing macrocells, e.g., macro RAN node 2518, and one or more RAN nodes for providing femtocells or picocells (e.g., cells having smaller coverage areas, smaller user capacity, or higher bandwidth compared to macrocells), e.g., low power (LP) RAN node 2520.

In at least one embodiment, any of RAN nodes 2518 and 2520 can terminate an air interface protocol and can be a first point of contact for UEs 2502 and 2504. In at least one embodiment, any of RAN nodes 2518 and 2520 can fulfill various logical functions for RAN 2516 including, but not limited to, radio network controller (RNC) functions such as radio bearer management, uplink and downlink dynamic radio resource management and data packet scheduling, and mobility management.

In at least one embodiment, UEs 2502 and 2504 can be configured to communicate using Orthogonal Frequency-Division Multiplexing (OFDM) communication signals with each other or with any of RAN nodes 2518 and 2520 over a multi-carrier communication channel in accordance various communication techniques, such as, but not limited to, an Orthogonal Frequency Division Multiple Access (OFDMA) communication technique (e.g., for downlink communications) or a Single Carrier Frequency Division Multiple Access (SC-FDMA) communication technique (e.g., for uplink and ProSe or sidelink communications), and/or variations thereof. In at least one embodiment, OFDM signals can comprise a plurality of orthogonal sub-carriers.

In at least one embodiment, a downlink resource grid can be used for downlink transmissions from any of RAN nodes 2518 and 2520 to UEs 2502 and 2504, while uplink transmissions can utilize similar techniques. In at least one embodiment, a grid can be a time frequency grid, called a resource grid or time-frequency resource grid, which is a physical resource in a downlink in each slot. In at least one embodiment, such a time frequency plane representation is a common practice for OFDM systems, which makes it intuitive for radio resource allocation. In at least one embodiment, each column and each row of a resource grid corresponds to one OFDM symbol and one OFDM subcarrier, respectively. In at least one embodiment, a duration of a resource grid in a time domain corresponds to one slot in a radio frame. In at least one embodiment, a smallest time-frequency unit in a resource grid is denoted as a resource element. In at least one embodiment, each resource grid comprises a number of resource blocks, which describe a mapping of certain physical channels to resource elements. In at least one embodiment, each resource block comprises a collection of resource elements. In at least one embodiment, in a frequency domain, this may represent a smallest quantity of resources that currently can be allocated. In at least one embodiment, there are several different physical downlink channels that are conveyed using such resource blocks.

In at least one embodiment, a physical downlink shared channel (PDSCH) may carry user data and higher-layer signaling to UEs 2502 and 2504. In at least one embodiment, a physical downlink control channel (PDCCH) may carry information about a transport format and resource allocations related to PDSCH channel, among other things. In at least one embodiment, it may also inform UEs 2502 and 2504 about a transport format, resource allocation, and HARQ (Hybrid Automatic Repeat Request) information related to an uplink shared channel. In at least one embodiment, typically, downlink scheduling (assigning control and shared channel resource blocks to UE 2502 within a cell) may be performed at any of RAN nodes 2518 and 2520 based on channel quality information fed back from any of UEs 2502 and 2504. In at least one embodiment, downlink resource assignment information may be sent on a PDCCH used for (e.g., assigned to) each of UEs 2502 and 2504.

In at least one embodiment, a PDCCH may use control channel elements (CCEs) to convey control information. In at least one embodiment, before being mapped to resource elements, PDCCH complex valued symbols may first be organized into quadruplets, which may then be permuted using a sub-block interleaver for rate matching. In at least one embodiment, each PDCCH may be transmitted using one or more of these CCEs, where each CCE may correspond to nine sets of four physical resource elements known as resource element groups (REGs). In at least one embodiment, four Quadrature Phase Shift Keying (QPSK) symbols may be mapped to each REG. In at least one embodiment, PDCCH can be transmitted using one or more CCEs, depending on a size of a downlink control information (DCI) and a channel condition. In at least one embodiment, there can be four or more different PDCCH formats defined in LTE with different numbers of CCEs (e.g., aggregation level, L=1, 2, 4, or 8).

In at least one embodiment, an enhanced physical downlink control channel (EPDCCH) that uses PDSCH resources may be utilized for control information transmission. In at least one embodiment, EPDCCH may be transmitted using one or more enhanced control channel elements (ECCEs). In at least one embodiment, each ECCE may correspond to nine sets of four physical resource elements known as an enhanced resource element groups (EREGs). In at least one embodiment, an ECCE may have other numbers of EREGs in some situations.

In at least one embodiment, RAN 2516 is shown to be communicatively coupled to a core network (CN) 2538 via an S1 interface 2522. In at least one embodiment, CN 2538 may be an evolved packet core (EPC) network, a NextGen Packet Core (NPC) network, or some other type of CN. In at least one embodiment, S1 interface 2522 is split into two parts: S1-U interface 2526, which carries traffic data between RAN nodes 2518 and 2520 and serving gateway (S-GW) 2530, and a S1-mobility management entity (MME) interface 2524, which is a signaling interface between RAN nodes 2518 and 2520 and MMEs 2528.

In at least one embodiment, CN 2538 comprises MMEs 2528, S-GW 2530, Packet Data Network (PDN) Gateway (P-GW) 2534, and a home subscriber server (HSS) 2532. In at least one embodiment, MMEs 2528 may be similar in function to a control plane of legacy Serving General Packet Radio Service (GPRS) Support Nodes (SGSN). In at least one embodiment, MMEs 2528 may manage mobility aspects in access such as gateway selection and tracking area list management. In at least one embodiment, HSS 2532 may comprise a database for network users, including subscription related information to support a network entities' handling of communication sessions. In at least one embodiment, CN 2538 may comprise one or several HSSs 2532, depending on a number of mobile subscribers, on a capacity of an equipment, on an organization of a network, etc. In at least one embodiment, HSS 2532 can provide support for routing/roaming, authentication, authorization, naming/addressing resolution, location dependencies, etc.

In at least one embodiment, S-GW 2530 may terminate a S1 interface 2522 towards RAN 2516, and routes data packets between RAN 2516 and CN 2538. In at least one embodiment, S-GW 2530 may be a local mobility anchor point for inter-RAN node handovers and also may provide an anchor for inter-3GPP mobility. In at least one embodiment, other responsibilities may include lawful intercept, charging, and some policy enforcement.

In at least one embodiment, P-GW 2534 may terminate an SGi interface toward a PDN. In at least one embodiment, P-GW 2534 may route data packets between an EPC network 2538 and external networks such as a network including application server 2540 (alternatively referred to as application function (AF)) via an Internet Protocol (IP) interface 2542. In at least one embodiment, application server 2540 may be an element offering applications that use IP bearer resources with a core network (e.g., UMTS Packet Services (PS) domain, LTE PS data services, etc.). In at least one embodiment, P-GW 2534 is shown to be communicatively coupled to an application server 2540 via an IP communications interface 2542. In at least one embodiment, application server 2540 can also be configured to support one or more communication services (e.g., Voice-over-Internet Protocol (VoIP) sessions, PTT sessions, group communication sessions, social networking services, etc.) for UEs 2502 and 2504 via CN 2538.

In at least one embodiment, P-GW 2534 may further be a node for policy enforcement and charging data collection. In at least one embodiment, policy and Charging Enforcement Function (PCRF) 2536 is a policy and charging control element of CN 2538. In at least one embodiment, in a non-roaming scenario, there may be a single PCRF in a Home Public Land Mobile Network (HPLMN) associated with a UE's Internet Protocol Connectivity Access Network (IP-CAN) session. In at least one embodiment, in a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). In at least one embodiment, PCRF 2536 may be communicatively coupled to application server 2540 via P-GW 2534. In at least one embodiment, application server 2540 may signal PCRF 2536 to indicate a new service flow and select an appropriate Quality of Service (QoS) and charging parameters. In at least one embodiment, PCRF 2536 may provision this rule into a Policy and Charging Enforcement Function (PCEF) (not shown) with an appropriate traffic flow template (TFT) and QoS class of identifier (QCI), which commences a QoS and charging as specified by application server 2540.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

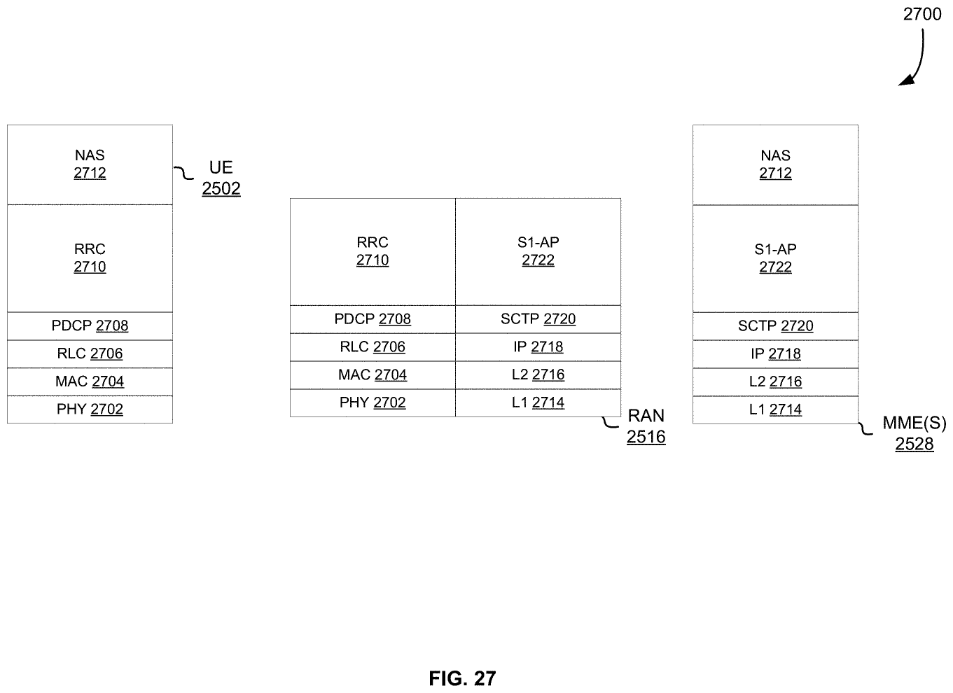

FIG. 26 illustrates an architecture of a system 2600 of a network in accordance with some embodiments. In at least one embodiment, system 2600 is shown to include a UE 2602, a 5G access node or RAN node (shown as (R)AN node 2608), a User Plane Function (shown as UPF 2604), a Data Network (DN 2606), which may be, for example, operator services, Internet access or 3rd party services, and a 5G Core Network (5GC) (shown as CN 2610).

In at least one embodiment, CN 2610 includes an Authentication Server Function (AUSF 2614); a Core Access and Mobility Management Function (AMF 2612); a Session Management Function (SMF 2618); a Network Exposure Function (NEF 2616); a Policy Control Function (PCF 2622); a Network Function (NF) Repository Function (NRF 2620); a Unified Data Management (UDM 2624); and an Application Function (AF 2626). In at least one embodiment, CN 2610 may also include other elements that are not shown, such as a Structured Data Storage network function (SDSF), an Unstructured Data Storage network function (UDSF), and variations thereof.

In at least one embodiment, UPF 2604 may act as an anchor point for intra-RAT and inter-RAT mobility, an external PDU session point of interconnect to DN 2606, and a branching point to support multi-homed PDU session. In at least one embodiment, UPF 2604 may also perform packet routing and forwarding, packet inspection, enforce user plane part of policy rules, lawfully intercept packets (UP collection); traffic usage reporting, perform QoS handling for user plane (e.g. packet filtering, gating, UL/DL rate enforcement), perform Uplink Traffic verification (e.g., SDF to QoS flow mapping), transport level packet marking in uplink and downlink, and downlink packet buffering and downlink data notification triggering. In at least one embodiment, UPF 2604 may include an uplink classifier to support routing traffic flows to a data network. In at least one embodiment, DN 2606 may represent various network operator services, Internet access, or third party services.

In at least one embodiment, AUSF 2614 may store data for authentication of UE 2602 and handle authentication related functionality. In at least one embodiment, AUSF 2614 may facilitate a common authentication framework for various access types.

In at least one embodiment, AMF 2612 may be responsible for registration management (e.g., for registering UE 2602, etc.), connection management, reachability management, mobility management, and lawful interception of AMF-related events, and access authentication and authorization. In at least one embodiment, AMF 2612 may provide transport for SM messages for SMF 2618, and act as a transparent proxy for routing SM messages. In at least one embodiment, AMF 2612 may also provide transport for short message service (SMS) messages between UE 2602 and an SMS function (SMSF) (not shown by FIG. 26). In at least one embodiment, AMF 2612 may act as Security Anchor Function (SEA), which may include interaction with AUSF 2614 and UE 2602 and receipt of an intermediate key that was established as a result of UE 2602 authentication process. In at least one embodiment, where USIM based authentication is used, AMF 2612 may retrieve security material from AUSF 2614. In at least one embodiment, AMF 2612 may also include a Security Context Management (SCM) function, which receives a key from SEA that it uses to derive access-network specific keys. In at least one embodiment, furthermore, AMF 2612 may be a termination point of RAN CP interface (N2 reference point), a termination point of NAS (NI) signaling, and perform NAS ciphering and integrity protection.

In at least one embodiment, AMF 2612 may also support NAS signaling with a UE 2602 over an N3 interworking-function (IWF) interface. In at least one embodiment, N3IWF may be used to provide access to untrusted entities. In at least one embodiment, N3IWF may be a termination point for N2 and N3 interfaces for control plane and user plane, respectively, and as such, may handle N2 signaling from SMF and AMF for PDU sessions and QoS, encapsulate/de-encapsulate packets for IPSec and N3 tunneling, mark N3 user-plane packets in uplink, and enforce QoS corresponding to N3 packet marking taking into account QoS requirements associated to such marking received over N2. In at least one embodiment, N3IWF may also relay uplink and downlink control-plane NAS (NI) signaling between UE 2602 and AMF 2612, and relay uplink and downlink user-plane packets between UE 2602 and UPF 2604. In at least one embodiment, N3IWF also provides mechanisms for IPsec tunnel establishment with UE 2602.

In at least one embodiment, SMF 2618 may be responsible for session management (e.g., session establishment, modify and release, including tunnel maintain between UPF and AN node); UE IP address allocation & management (including optional Authorization);

Selection and control of UP function; Configures traffic steering at UPF to route traffic to proper destination; termination of interfaces towards Policy control functions; control part of policy enforcement and QoS; lawful intercept (for SM events and interface to LI System); termination of SM parts of NAS messages; downlink Data Notification; initiator of AN specific SM information, sent via AMF over N2 to AN; determine SSC mode of a session. In at least one embodiment, SMF 2618 may include following roaming functionality: handle local enforcement to apply QoS SLAB (VPLMN); charging data collection and charging interface (VPLMN); lawful intercept (in VPLMN for SM events and interface to LI System); support for interaction with external DN for transport of signaling for PDU session authorization/authentication by external DN.

In at least one embodiment, NEF 2616 may provide means for securely exposing services and capabilities provided by 3GPP network functions for third party, internal exposure/re-exposure, Application Functions (e.g., AF 2626), edge computing or fog computing systems, etc. In at least one embodiment, NEF 2616 may authenticate, authorize, and/or throttle AFs. In at least one embodiment, NEF 2616 may also translate information exchanged with AF 2626 and information exchanged with internal network functions. In at least one embodiment, NEF 2616 may translate between an AF-Service-Identifier and an internal 5GC information. In at least one embodiment, NEF 2616 may also receive information from other network functions (NFs) based on exposed capabilities of other network functions. In at least one embodiment, this information may be stored at NEF 2616 as structured data, or at a data storage NF using a standardized interfaces. In at least one embodiment, stored information can then be re-exposed by NEF 2616 to other NFs and AFs, and/or used for other purposes such as analytics.

In at least one embodiment, NRF 2620 may support service discovery functions, receive NF Discovery Requests from NF instances, and provide information of discovered NF instances to NF instances. In at least one embodiment, NRF 2620 also maintains information of available NF instances and their supported services.

In at least one embodiment, PCF 2622 may provide policy rules to control plane function(s) to enforce them, and may also support unified policy framework to govern network behavior. In at least one embodiment, PCF 2622 may also implement a front end (FE) to access subscription information relevant for policy decisions in a UDR of UDM 2624.

In at least one embodiment, UDM 2624 may handle subscription-related information to support a network entities' handling of communication sessions, and may store subscription data of UE 2602. In at least one embodiment, UDM 2624 may include two parts, an application FE and a User Data Repository (UDR). In at least one embodiment, UDM may include a UDM FE, which is in charge of processing of credentials, location management, subscription management and so on. In at least one embodiment, several different front ends may serve a same user in different transactions. In at least one embodiment, UDM-FE accesses subscription information stored in an UDR and performs authentication credential processing; user identification handling; access authorization; registration/mobility management; and subscription management. In at least one embodiment, UDR may interact with PCF 2622. In at least one embodiment, UDM 2624 may also support SMS management, wherein an SMS-FE implements a similar application logic as discussed previously.

In at least one embodiment, AF 2626 may provide application influence on traffic routing, access to a Network Capability Exposure (NCE), and interact with a policy framework for policy control. In at least one embodiment, NCE may be a mechanism that allows a 5GC and AF 2626 to provide information to each other via NEF 2616, which may be used for edge computing implementations. In at least one embodiment, network operator and third party services may be hosted close to UE 2602 access point of attachment to achieve an efficient service delivery through a reduced end-to-end latency and load on a transport network. In at least one embodiment, for edge computing implementations, 5GC may select a UPF 2604 close to UE 2602 and execute traffic steering from UPF 2604 to DN 2606 via N6 interface. In at least one embodiment, this may be based on UE subscription data, UE location, and information provided by AF 2626. In at least one embodiment, AF 2626 may influence UPF (re)selection and traffic routing. In at least one embodiment, based on operator deployment, when AF 2626 is considered to be a trusted entity, a network operator may permit AF 2626 to interact directly with relevant NFs.

In at least one embodiment, CN 2610 may include an SMSF, which may be responsible for SMS subscription checking and verification, and relaying SM messages to/from UE 2602 to/from other entities, such as an SMS-GMSC/IWMSC/SMS-router. In at least one embodiment, SMS may also interact with AMF 2612 and UDM 2624 for notification procedure that UE 2602 is available for SMS transfer (e.g., set a UE not reachable flag, and notifying UDM 2624 when UE 2602 is available for SMS).

In at least one embodiment, system 2600 may include following service-based interfaces: Namf: Service-based interface exhibited by AMF; Nsmf: Service-based interface exhibited by SMF; Nnef: Service-based interface exhibited by NEF; Npcf: Service-based interface exhibited by PCF; Nudm: Service-based interface exhibited by UDM; Naf: Service-based interface exhibited by AF; Nnrf: Service-based interface exhibited by NRF; and Nausf: Service-based interface exhibited by AUSF.

In at least one embodiment, system 2600 may include following reference points: N1: Reference point between UE and AMF; N2: Reference point between (R)AN and AMF; N3: Reference point between (R)AN and UPF; N4: Reference point between SMF and UPF; and N6: Reference point between UPF and a Data Network. In at least one embodiment, there may be many more reference points and/or service-based interfaces between a NF services in NFs, however, these interfaces and reference points have been omitted for clarity. In at least one embodiment, an NS reference point may be between a PCF and AF; an N7 reference point may be between PCF and SMF; an N11 reference point between AMF and SMF; etc. In at least one embodiment, CN 2610 may include an Nx interface, which is an inter-CN interface between MME and AMF 2612 in order to enable interworking between CN 2610 and CN 7226.

In at least one embodiment, system 2600 may include multiple RAN nodes (such as (R)AN node 2608) wherein an Xn interface is defined between two or more (R)AN node 2608 (e.g., gNBs) that connecting to 5GC 410, between a (R)AN node 2608 (e.g., gNB) connecting to CN 2610 and an eNB (e.g., a macro RAN node), and/or between two eNBs connecting to CN 2610.

In at least one embodiment, Xn interface may include an Xn user plane (Xn-U) interface and an Xn control plane (Xn-C) interface. In at least one embodiment, Xn-U may provide non-guaranteed delivery of user plane PDUs and support/provide data forwarding and flow control functionality. In at least one embodiment, Xn-C may provide management and error handling functionality, functionality to manage a Xn-C interface; mobility support for UE 2602 in a connected mode (e.g., CM-CONNECTED) including functionality to manage UE mobility for connected mode between one or more (R)AN node 2608. In at least one embodiment, mobility support may include context transfer from an old (source) serving (R)AN node 2608 to new (target) serving (R)AN node 2608; and control of user plane tunnels between old (source) serving (R)AN node 2608 to new (target) serving (R)AN node 2608.

In at least one embodiment, a protocol stack of a Xn-U may include a transport network layer built on Internet Protocol (IP) transport layer, and a GTP—U layer on top of a UDP and/or IP layer(s) to carry user plane PDUs. In at least one embodiment, Xn-C protocol stack may include an application layer signaling protocol (referred to as Xn Application Protocol (Xn-AP)) and a transport network layer that is built on an SCTP layer. In at least one embodiment, SCTP layer may be on top of an IP layer. In at least one embodiment, SCTP layer provides a guaranteed delivery of application layer messages. In at least one embodiment, in a transport IP layer point-to-point transmission is used to deliver signaling PDUs. In at least one embodiment, Xn-U protocol stack and/or a Xn-C protocol stack may be same or similar to an user plane and/or control plane protocol stack(s) shown and described herein.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

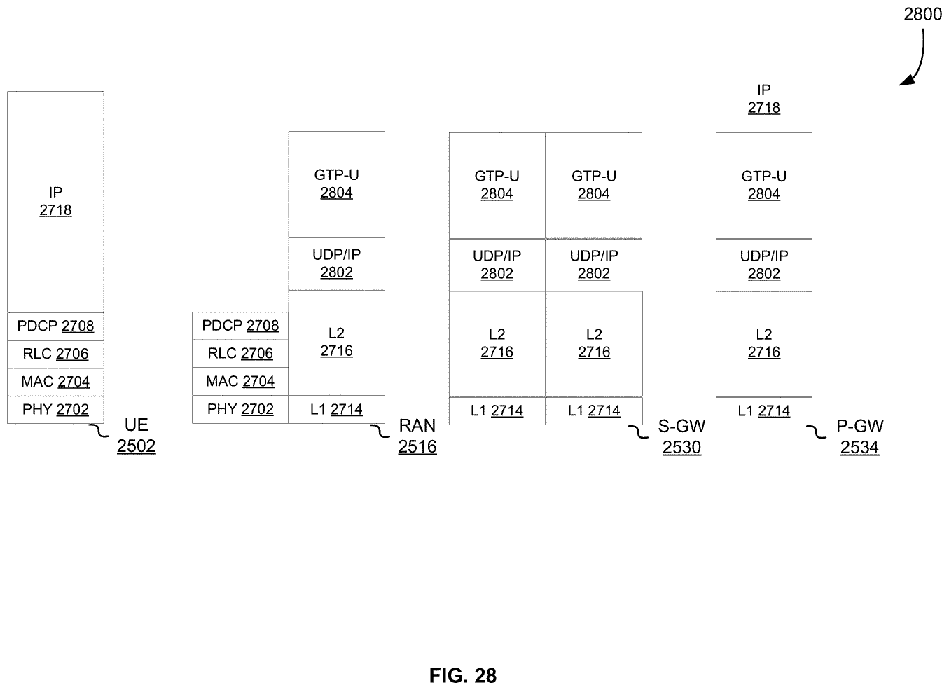

FIG. 27 is an illustration of a control plane protocol stack in accordance with some embodiments. In at least one embodiment, a control plane 2700 is shown as a communications protocol stack between UE 2502 (or alternatively, UE 2504), RAN 2516, and MME(s) 2528.

In at least one embodiment, PHY layer 2702 may transmit or receive information used by MAC layer 2704 over one or more air interfaces. In at least one embodiment, PHY layer 2702 may further perform link adaptation or adaptive modulation and coding (AMC), power control, cell search (e.g., for initial synchronization and handover purposes), and other measurements used by higher layers, such as an RRC layer 2710. In at least one embodiment, PHY layer 2702 may still further perform error detection on transport channels, forward error correction (FEC) coding/de-coding of transport channels, modulation/demodulation of physical channels, interleaving, rate matching, mapping onto physical channels, and Multiple Input Multiple Output (MIMO) antenna processing.

In at least one embodiment, MAC layer 2704 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from PHY via transport channels, multiplexing MAC SDUs onto TBs, scheduling information reporting, error correction through hybrid automatic repeat request (HARD), and logical channel prioritization.

In at least one embodiment, RLC layer 2706 may operate in a plurality of modes of operation, including: Transparent Mode™, Unacknowledged Mode (UM), and Acknowledged Mode (AM). In at least one embodiment, RLC layer 2706 may execute transfer of upper layer protocol data units (PDUs), error correction through automatic repeat request (ARQ) for AM data transfers, and concatenation, segmentation and reassembly of RLC SDUs for UM and AM data transfers. In at least one embodiment, RLC layer 2706 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

In at least one embodiment, PDCP layer 2708 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

In at least one embodiment, main services and functions of a RRC layer 2710 may include broadcast of system information (e.g., included in Master Information Blocks (MIBs) or System Information Blocks (SIBs) related to a non-access stratum (NAS)), broadcast of system information related to an access stratum (AS), paging, establishment, maintenance and release of an RRC connection between an UE and E-UTRAN (e.g., RRC connection paging, RRC connection establishment, RRC connection modification, and RRC connection release), establishment, configuration, maintenance and release of point-to-point radio bearers, security functions including key management, inter radio access technology (RAT) mobility, and measurement configuration for UE measurement reporting. In at least one embodiment, said MIBs and SIBs may comprise one or more information elements (IEs), which may each comprise individual data fields or data structures.

In at least one embodiment, UE 2502 and RAN 2516 may utilize a Uu interface (e.g., an LTE-Uu interface) to exchange control plane data via a protocol stack comprising PHY layer 2702, MAC layer 2704, RLC layer 2706, PDCP layer 2708, and RRC layer 2710.

In at least one embodiment, non-access stratum (NAS) protocols (NAS protocols 2712) form a highest stratum of a control plane between UE 2502 and MME(s) 2528. In at least one embodiment, NAS protocols 2712 support mobility of UE 2502 and session management procedures to establish and maintain IP connectivity between UE 2502 and P-GW 2534.

In at least one embodiment, Si Application Protocol (S1-AP) layer (Si-AP layer 2722) may support functions of a Si interface and comprise Elementary Procedures (EPs). In at least one embodiment, an EP is a unit of interaction between RAN 2516 and CN 2528. In at least one embodiment, S1-AP layer services may comprise two groups: UE-associated services and non UE-associated services. In at least one embodiment, these services perform functions including, but not limited to: E-UTRAN Radio Access Bearer (E-RAB) management, UE capability indication, mobility, NAS signaling transport, RAN Information Management (RIM), and configuration transfer.

In at least one embodiment, Stream Control Transmission Protocol (SCTP) layer (alternatively referred to as a stream control transmission protocol/internet protocol (SCTP/IP) layer) (SCTP layer 2720) may ensure reliable delivery of signaling messages between RAN 2516 and MME(s) 2528 based, in part, on an IP protocol, supported by an IP layer 2718. In at least one embodiment, L2 layer 2716 and an L1 layer 2714 may refer to communication links (e.g., wired or wireless) used by a RAN node and MME to exchange information.

In at least one embodiment, RAN 2516 and MME(s) 2528 may utilize an S1-MME interface to exchange control plane data via a protocol stack comprising a L1 layer 2714, L2 layer 2716, IP layer 2718, SCTP layer 2720, and Si-AP layer 2722.

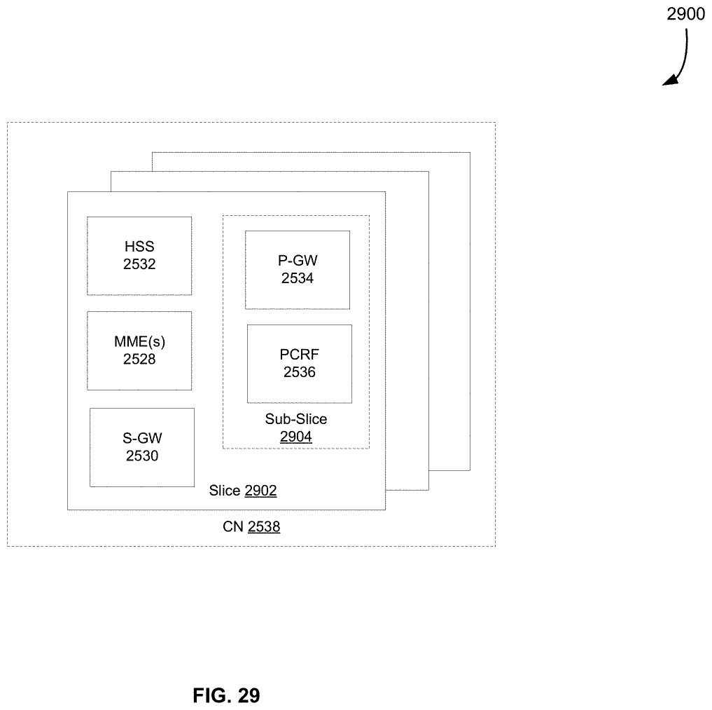

FIG. 28 is an illustration of a user plane protocol stack in accordance with at least one embodiment. In at least one embodiment, a user plane 2800 is shown as a communications protocol stack between a UE 2502, RAN 2516, S-GW 2530, and P-GW 2534. In at least one embodiment, user plane 2800 may utilize a same protocol layers as control plane 2700. In at least one embodiment, for example, UE 2502 and RAN 2516 may utilize a Uu interface (e.g., an LTE-Uu interface) to exchange user plane data via a protocol stack comprising PHY layer 2702, MAC layer 2704, RLC layer 2706, PDCP layer 2708.

In at least one embodiment, General Packet Radio Service (GPRS) Tunneling Protocol for a user plane (GTP-U) layer (GTP—U layer 2804) may be used for carrying user data within a GPRS core network and between a radio access network and a core network. In at least one embodiment, user data transported can be packets in any of IPv4, IPv6, or PPP formats, for example. In at least one embodiment, UDP and IP security (UDP/IP) layer (UDP/IP layer 2802) may provide checksums for data integrity, port numbers for addressing different functions at a source and destination, and encryption and authentication on selected data flows. In at least one embodiment, RAN 2516 and S-GW 2530 may utilize an S1-U interface to exchange user plane data via a protocol stack comprising L1 layer 2714, L2 layer 2716, UDP/IP layer 2802, and GTP—U layer 2804. In at least one embodiment, S-GW 2530 and P-GW 2534 may utilize an S5/S8a interface to exchange user plane data via a protocol stack comprising L1 layer 2714, L2 layer 2716, UDP/IP layer 2802, and GTP—U layer 2804. In at least one embodiment, as discussed above with respect to FIG. 27, NAS protocols support a mobility of UE 2502 and session management procedures to establish and maintain IP connectivity between UE 2502 and P-GW 2534.

In at least one embodiment, one or more circuits, processors, computing systems, or other devices or techniques are adapted, with reference to above FIGS., to identify a cause of a performance regression by comparing performance metrics associated with a first group of user interactions with a web-based service to performance metrics associated with a second group of user interactions with the web-based service. In at least one embodiment, this is performed by embodiments of said FIGS., according to embodiments described herein in relation to FIGS. 1-10.

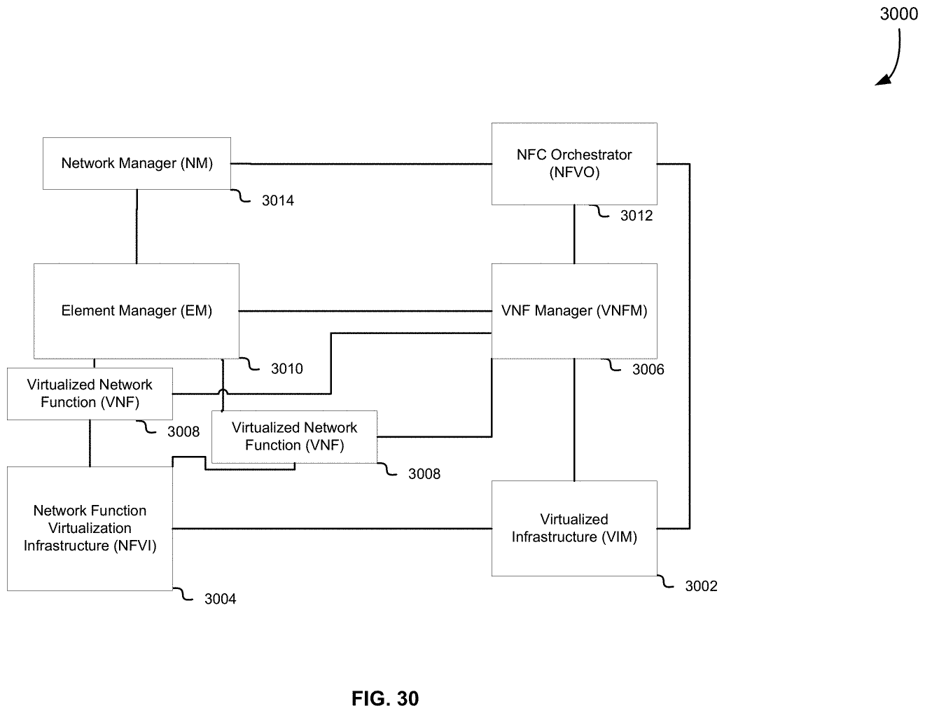

FIG. 29 illustrates components 2900 of a core network in accordance with at least one embodiment. In at least one embodiment, components of CN 2538 may be implemented in one physical node or separate physical nodes including components to read and execute instructions from a machine-readable or computer-readable medium (e.g., a non-transitory machine-readable storage medium). In at least one embodiment, Network Functions Virtualization (NFV) is utilized to virtualize any or all of above described network node functions via executable instructions stored in one or more computer readable storage mediums (described in further detail below). In at least one embodiment, a logical instantiation of CN 2538 may be referred to as a network slice 2902 (e.g., network slice 2902 is shown to include HSS 2532, MME(s) 2528, and S-GW 2530). In at least one embodiment, a logical instantiation of a portion of CN 2538 may be referred to as a network sub-slice 2904 (e.g., network sub-slice 2904 is shown to include P-GW 2534 and PCRF 2536).

In at least one embodiment, NFV architectures and infrastructures may be used to virtualize one or more network functions, alternatively performed by proprietary hardware, onto physical resources comprising a combination of industry-standard server hardware, storage hardware, or switches. In at least one embodiment, NFV systems can be used to execute virtual or reconfigurable implementations of one or more EPC components/functions.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

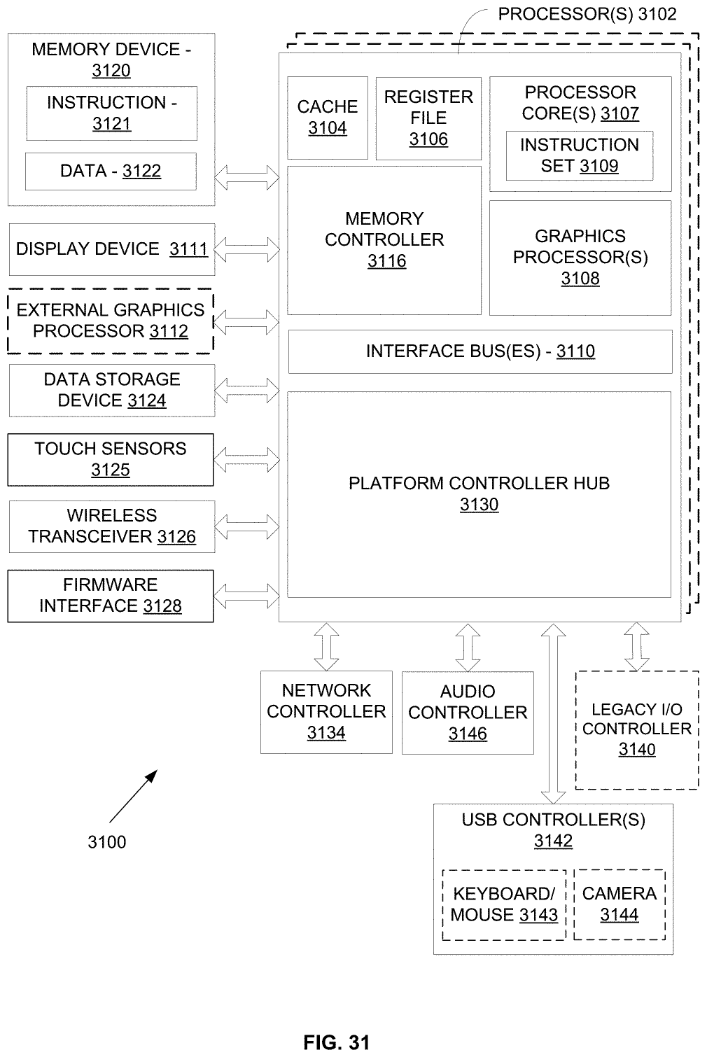

FIG. 30 is a block diagram illustrating components, according to at least one embodiment, of a system 3000 to support network function virtualization (NFV). In at least one embodiment, system 3000 is illustrated as including a virtualized infrastructure manager (shown as VIM 3002), a network function virtualization infrastructure (shown as NFVI 3004), a VNF manager (shown as VNFM 3006), virtualized network functions (shown as VNF 3008), an element manager (shown as EM 3010), an NFV Orchestrator (shown as NFVO 3012), and a network manager (shown as NM 3014).

In at least one embodiment, VIM 3002 manages resources of NFVI 3004. In at least one embodiment, NFVI 3004 can include physical or virtual resources and applications (including hypervisors) used to execute system 3000. In at least one embodiment, VIM 3002 may manage a life cycle of virtual resources with NFVI 3004 (e.g., creation, maintenance, and tear down of virtual machines (VMs) associated with one or more physical resources), track VM instances, track performance, fault and security of VM instances and associated physical resources, and expose VM instances and associated physical resources to other management systems.

In at least one embodiment, VNFM 3006 may manage VNF 3008. In at least one embodiment, VNF 3008 may be used to execute EPC components/functions. In at least one embodiment, VNFM 3006 may manage a life cycle of VNF 3008 and track performance, fault and security of virtual aspects of VNF 3008. In at least one embodiment, EM 3010 may track performance, fault and security of functional aspects of VNF 3008. In at least one embodiment, tracking data from VNFM 3006 and EM 3010 may comprise, for example, performance measurement (PM) data used by VIM 3002 or NFVI 3004. In at least one embodiment, both VNFM 3006 and EM 3010 can scale up/down a quantity of VNFs of system 3000.

In at least one embodiment, NFVO 3012 may coordinate, authorize, release and engage resources of NFVI 3004 in order to provide a requested service (e.g., to execute an EPC function, component, or slice). In at least one embodiment, NM 3014 may provide a package of end-user functions with responsibility for a management of a network, which may include network elements with VNFs, non-virtualized network functions, or both (management of VNFs may occur via an EM 3010).

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### Computer-Based Systems

The following FIGS. set forth, without limitation, exemplary computer-based systems that can be used to implement at least one embodiment.

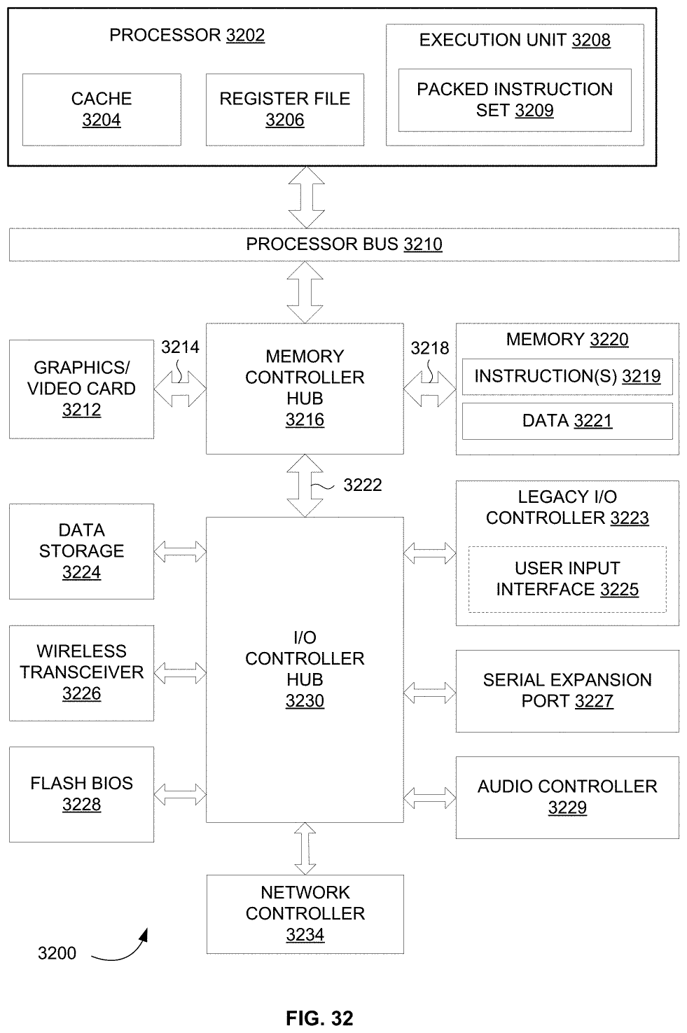

FIG. 31 illustrates a processing system 3100, in accordance with at least one embodiment. In at least one embodiment, processing system 3100 includes one or more processors 3102 and one or more graphics processors 3108, and may be a single processor desktop system, a multiprocessor workstation system, or a server system having a large number of processors 3102 or processor cores 3107. In at least one embodiment, processing system 3100 is a processing platform incorporated within a system-on-a-chip (“Sort”) integrated circuit for use in mobile, handheld, or embedded devices.

In at least one embodiment, processing system 3100 can include, or be incorporated within a server-based gaming platform, a game console, a media console, a mobile gaming console, a handheld game console, or an online game console. In at least one embodiment, processing system 3100 is a mobile phone, smart phone, tablet computing device or mobile Internet device. In at least one embodiment, processing system 3100 can also include, couple with, or be integrated within a wearable device, such as a smart watch wearable device, smart eyewear device, augmented reality device, or virtual reality device. In at least one embodiment, processing system 3100 is a television or set top box device having one or more processors 3102 and a graphical interface generated by one or more graphics processors 3108.

In at least one embodiment, one or more processors 3102 each include one or more processor cores 3107 to process instructions which, when executed, perform operations for system and user software. In at least one embodiment, each of one or more processor cores 3107 is configured to process a specific instruction set 3109. In at least one embodiment, instruction set 3109 may facilitate Complex Instruction Set Computing (“CISC”), Reduced Instruction Set Computing (“RISC”), or computing via a Very Long Instruction Word (“VLIW”). In at least one embodiment, processor cores 3107 may each process a different instruction set 3109, which may include instructions to facilitate emulation of other instruction sets. In at least one embodiment, processor core 3107 may also include other processing devices, such as a digital signal processor (“DSP”).

In at least one embodiment, processor 3102 includes cache memory (‘cache”) 3104. In at least one embodiment, processor 3102 can have a single internal cache or multiple levels of internal cache. In at least one embodiment, cache memory is shared among various components of processor 3102. In at least one embodiment, processor 3102 also uses an external cache (e.g., a Level 3 (“L3”) cache or Last Level Cache (“LLC”)) (not shown), which may be shared among processor cores 3107 using known cache coherency techniques. In at least one embodiment, register file 3106 is additionally included in processor 3102 which may include different types of registers for storing different types of data (e.g., integer registers, floating point registers, status registers, and an instruction pointer register). In at least one embodiment, register file 3106 may include general-purpose registers or other registers.

In at least one embodiment, one or more processor(s) 3102 are coupled with one or more interface bus(es) 3110 to transmit communication signals such as address, data, or control signals between processor 3102 and other components in processing system 3100. In at least one embodiment interface bus 3110, in one embodiment, can be a processor bus, such as a version of a Direct Media Interface (“DMI”) bus. In at least one embodiment, interface bus 3110 is not limited to a DMI bus, and may include one or more Peripheral Component Interconnect buses (e.g., “PCI,” PCI Express (“PCIe”)), memory buses, or other types of interface buses. In at least one embodiment processor(s) 3102 include an integrated memory controller 3116 and a platform controller hub 3130. In at least one embodiment, memory controller 3116 facilitates communication between a memory device and other components of processing system 3100, while platform controller hub (“PCH”) 3130 provides connections to Input/Output (“I/O”) devices via a local I/O bus.

In at least one embodiment, memory device 3120 can be a dynamic random access memory (“DRAM”) device, a static random access memory (“SRAM”) device, flash memory device, phase-change memory device, or some other memory device having suitable performance to serve as processor memory. In at least one embodiment memory device 3120 can operate as system memory for processing system 3100, to store data 3122 and instructions 3121 for use when one or more processors 3102 executes an application or process. In at least one embodiment, memory controller 3116 also couples with an optional external graphics processor 3112, which may communicate with one or more graphics processors 3108 in processors 3102 to perform graphics and media operations. In at least one embodiment, a display device 3111 can connect to processor(s) 3102. In at least one embodiment display device 3111 can include one or more of an internal display device, as in a mobile electronic device or a laptop device or an external display device attached via a display interface (e.g., DisplayPort, etc.). In at least one embodiment, display device 3111 can include a head mounted display (“HMD”) such as a stereoscopic display device for use in virtual reality (“VR”) applications or augmented reality (“AR”) applications.

In at least one embodiment, platform controller hub 3130 enables peripherals to connect to memory device 3120 and processor 3102 via a high-speed I/O bus. In at least one embodiment, I/O peripherals include, but are not limited to, an audio controller 3146, a network controller 3134, a firmware interface 3128, a wireless transceiver 3126, touch sensors 3125, a data storage device 3124 (e.g., hard disk drive, flash memory, etc.). In at least one embodiment, data storage device 3124 can connect via a storage interface (e.g., SATA) or via a peripheral bus, such as PCI, or PCIe. In at least one embodiment, touch sensors 3125 can include touch screen sensors, pressure sensors, or fingerprint sensors. In at least one embodiment, wireless transceiver 3126 can be a Wi-Fi transceiver, a Bluetooth transceiver, or a mobile network transceiver such as a 3G, 4G, or Long Term Evolution (“LTE”) transceiver. In at least one embodiment, firmware interface 3128 enables communication with system firmware, and can be, for example, a unified extensible firmware interface (“UEFI”). In at least one embodiment, network controller 3134 can enable a network connection to a wired network. In at least one embodiment, a high-performance network controller (not shown) couples with interface bus 3110. In at least one embodiment, audio controller 3146 is a multi-channel high definition audio controller. In at least one embodiment, processing system 3100 includes an optional legacy I/O controller 3140 for coupling legacy (e.g., Personal System 2 (“PS/2”)) devices to processing system 3100. In at least one embodiment, platform controller hub 3130 can also connect to one or more Universal Serial Bus (“USB”) controllers 3142 connect input devices, such as keyboard and mouse 3143 combinations, a camera 3144, or other USB input devices.

In at least one embodiment, an instance of memory controller 3116 and platform controller hub 3130 may be integrated into a discreet external graphics processor, such as external graphics processor 3112. In at least one embodiment, platform controller hub 3130 and/or memory controller 3116 may be external to one or more processor(s) 3102. For example, in at least one embodiment, processing system 3100 can include an external memory controller 3116 and platform controller hub 3130, which may be configured as a memory controller hub and peripheral controller hub within a system chipset that is in communication with processor(s) 3102.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

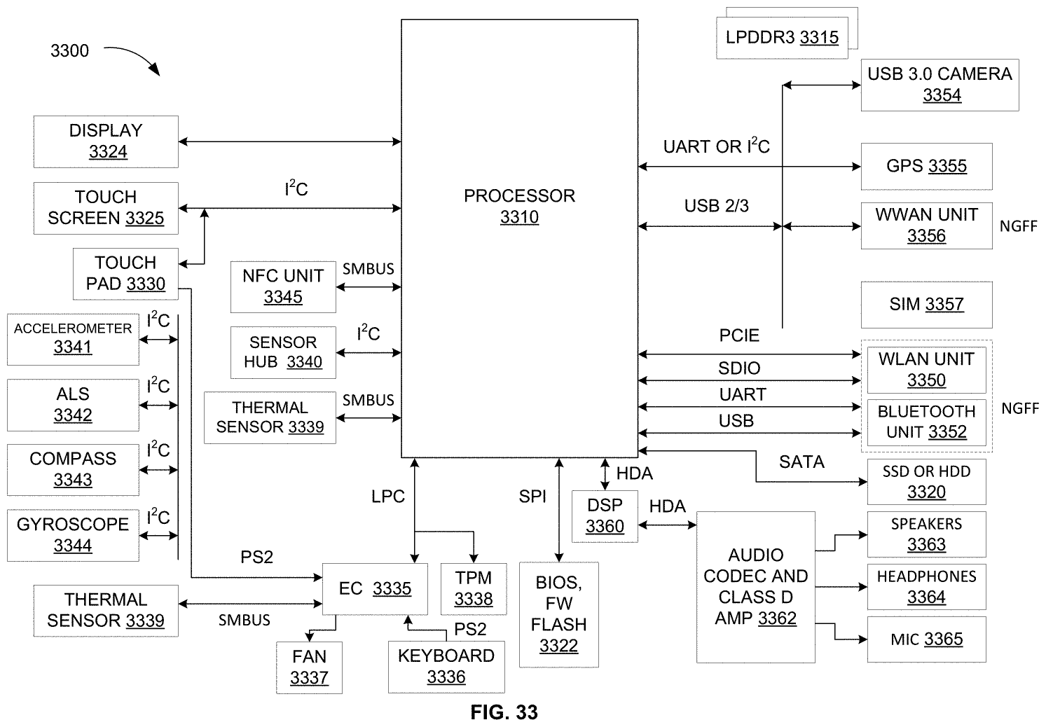

FIG. 32 illustrates a computer system 3200, in accordance with at least one embodiment. In at least one embodiment, computer system 3200 may be a system with interconnected devices and components, an SOC, or some combination. In at least on embodiment, computer system 3200 is formed with a processor 3202 that may include execution units to execute an instruction. In at least one embodiment, computer system 3200 may include, without limitation, a component, such as processor 3202 to employ execution units including logic to perform algorithms for processing data. In at least one embodiment, computer system 3200 may include processors, such as PENTIUM® Processor family, Xeon™, Itanium®, XScale™ and/or StrongARM™, Intel® Core™, or Intel® Nervana™ microprocessors available from Intel Corporation of Santa Clara, Calif., although other systems (including PCs having other microprocessors, engineering workstations, set-top boxes and like) may also be used. In at least one embodiment, computer system 3200 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 3200 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions.

In at least one embodiment, computer system 3200 may include, without limitation, processor 3202 that may include, without limitation, one or more execution units 3208 that may be configured to execute a Compute Unified Device Architecture (“CUDA”) (CUDA® is developed by NVIDIA Corporation of Santa Clara, Calif.) program. In at least one embodiment, a CUDA program is at least a portion of a software application written in a CUDA programming language. In at least one embodiment, computer system 3200 is a single processor desktop or server system. In at least one embodiment, computer system 3200 may be a multiprocessor system. In at least one embodiment, processor 3202 may include, without limitation, a CISC microprocessor, a RISC microprocessor, a VLIW microprocessor, a processor implementing a combination of instruction sets, or any other processor device, such as a digital signal processor, for example. In at least one embodiment, processor 3202 may be coupled to a processor bus 3210 that may transmit data signals between processor 3202 and other components in computer system 3200.

In at least one embodiment, processor 3202 may include, without limitation, a Level 1 (“L1”) internal cache memory (“cache”) 3204. In at least one embodiment, processor 3202 may have a single internal cache or multiple levels of internal cache. In at least one embodiment, cache memory may reside external to processor 3202. In at least one embodiment, processor 3202 may also include a combination of both internal and external caches. In at least one embodiment, a register file 3206 may store different types of data in various registers including, without limitation, integer registers, floating point registers, status registers, and instruction pointer register.

In at least one embodiment, execution unit 3208, including, without limitation, logic to perform integer and floating point operations, also resides in processor 3202. Processor 3202 may also include a microcode (“ucode”) read only memory (“ROM”) that stores microcode for certain macro instructions. In at least one embodiment, execution unit 3208 may include logic to handle a packed instruction set 3209. In at least one embodiment, by including packed instruction set 3209 in an instruction set of a general-purpose processor 3202, along with associated circuitry to execute instructions, operations used by many multimedia applications may be performed using packed data in a general-purpose processor 3202. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 3208 may also be used in microcontrollers, embedded processors, graphics devices, DSPs, and other types of logic circuits. In at least one embodiment, computer system 3200 may include, without limitation, a memory 3220. In at least one embodiment, memory 3220 may be implemented as a DRAM device, an SRAM device, flash memory device, or other memory device. Memory 3220 may store instruction(s) 3219 and/or data 3221 represented by data signals that may be executed by processor 3202.

In at least one embodiment, a system logic chip may be coupled to processor bus 3210 and memory 3220. In at least one embodiment, a system logic chip may include, without limitation, a memory controller hub (“MCH”) 3216, and processor 3202 may communicate with MCH 3216 via processor bus 3210. In at least one embodiment, MCH 3216 may provide a high bandwidth memory path 3218 to memory 3220 for instruction and data storage and for storage of graphics commands, data and textures. In at least one embodiment, MCH 3216 may direct data signals between processor 3202, memory 3220, and other components in computer system 3200 and to bridge data signals between processor bus 3210, memory 3220, and a system I/O 3222. In at least one embodiment, system logic chip may provide a graphics port for coupling to a graphics controller. In at least one embodiment, MCH 3216 may be coupled to memory 3220 through high bandwidth memory path 3218 and graphics/video card 3212 may be coupled to MCH 3216 through an Accelerated Graphics Port (“AGP”) interconnect 3214.

In at least one embodiment, computer system 3200 may use system I/O 3222 that is a proprietary hub interface bus to couple MCH 3216 to I/O controller hub (“ICH”) 3230. In at least one embodiment, ICH 3230 may provide direct connections to some I/O devices via a local I/O bus. In at least one embodiment, local I/O bus may include, without limitation, a high-speed I/O bus for connecting peripherals to memory 3220, a chipset, and processor 3202. Examples may include, without limitation, an audio controller 3229, a firmware hub (“flash BIOS”) 3228, a wireless transceiver 3226, a data storage 3224, a legacy I/O controller 3223 containing a user input interface 3225 and a keyboard interface, a serial expansion port 3227, such as a USB, and a network controller 3234. Data storage 3224 may comprise a hard disk drive, a floppy disk drive, a CD-ROM device, a flash memory device, or other mass storage device.

In at least one embodiment, FIG. 32 illustrates a system, which includes interconnected hardware devices or “chips.” In at least one embodiment, FIG. 32 may illustrate an exemplary SoC. In at least one embodiment, devices illustrated in FIG. 32 may be interconnected with proprietary interconnects, standardized interconnects (e.g., PCIe), or some combination thereof. In at least one embodiment, one or more components of system 3200 are interconnected using compute express link (“CXL”) interconnects.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

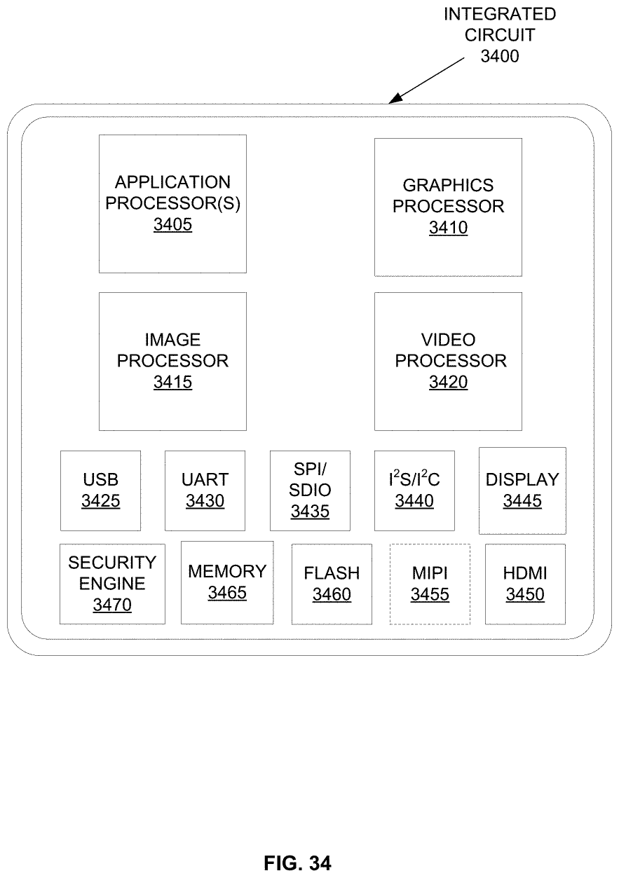

FIG. 33 illustrates a system 3300, in accordance with at least one embodiment. In at least one embodiment, system 3300 is an electronic device that utilizes a processor 3310. In at least one embodiment, system 3300 may be, for example and without limitation, a notebook, a tower server, a rack server, a blade server, a laptop, a desktop, a tablet, a mobile device, a phone, an embedded computer, or any other suitable electronic device.

In at least one embodiment, system 3300 may include, without limitation, processor 3310 communicatively coupled to any suitable number or kind of components, peripherals, modules, or devices. In at least one embodiment, processor 3310 is coupled using a bus or interface, such as an VC bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, FIG. 33 illustrates a system which includes interconnected hardware devices or “chips.” In at least one embodiment, FIG. 33 may illustrate an exemplary SoC. In at least one embodiment, devices illustrated in FIG. 33 may be interconnected with proprietary interconnects, standardized interconnects (e.g., PCIe) or some combination thereof. In at least one embodiment, one or more components of FIG. 33 are interconnected using CXL interconnects.

In at least one embodiment, FIG. 33 may include a display 3324, a touch screen 3325, a touch pad 3330, a Near Field Communications unit (“NFC”) 3345, a sensor hub 3340, a thermal sensor 3346, an Express Chipset (“EC”) 3335, a Trusted Platform Module (“TPM”) 3338, BIOS/firmware/flash memory (“BIOS, FW Flash”) 3322, a DSP 3360, a Solid State Disk (“SSD”) or Hard Disk Drive (“HDD”) 3320, a wireless local area network unit (“WLAN”) 3350, a Bluetooth unit 3352, a Wireless Wide Area Network unit (“WWAN”) 3356, a Global Positioning System (“GPS”) 3355, a camera (“USB 3.0 camera”) 3354 such as a USB 3.0 camera, or a Low Power Double Data Rate (“LPDDR”) memory unit (“LPDDR3”) 3315 implemented in, for example, LPDDR3 standard. These components may each be implemented in any suitable manner.

In at least one embodiment, other components may be communicatively coupled to processor 3310 through components discussed above. In at least one embodiment, an accelerometer 3341, an Ambient Light Sensor (“ALS”) 3342, a compass 3343, and a gyroscope 3344 may be communicatively coupled to sensor hub 3340. In at least one embodiment, a thermal sensor 3339, a fan 3337, a keyboard 3346, and a touch pad 3330 may be communicatively coupled to EC 3335. In at least one embodiment, a speaker 3363, a headphones 3364, and a microphone (“mic”) 3365 may be communicatively coupled to an audio unit (“audio codec and class d amp”) 3364, which may in turn be communicatively coupled to DSP 3360. In at least one embodiment, audio unit 3364 may include, for example and without limitation, an audio coder/decoder (“codec”) and a class D amplifier. In at least one embodiment, a SIM card (“SIM”) 3357 may be communicatively coupled to WWAN unit 3356. In at least one embodiment, components such as WLAN unit 3350 and Bluetooth unit 3352, as well as WWAN unit 3356 may be implemented in a Next Generation Form Factor (“NGFF”).

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

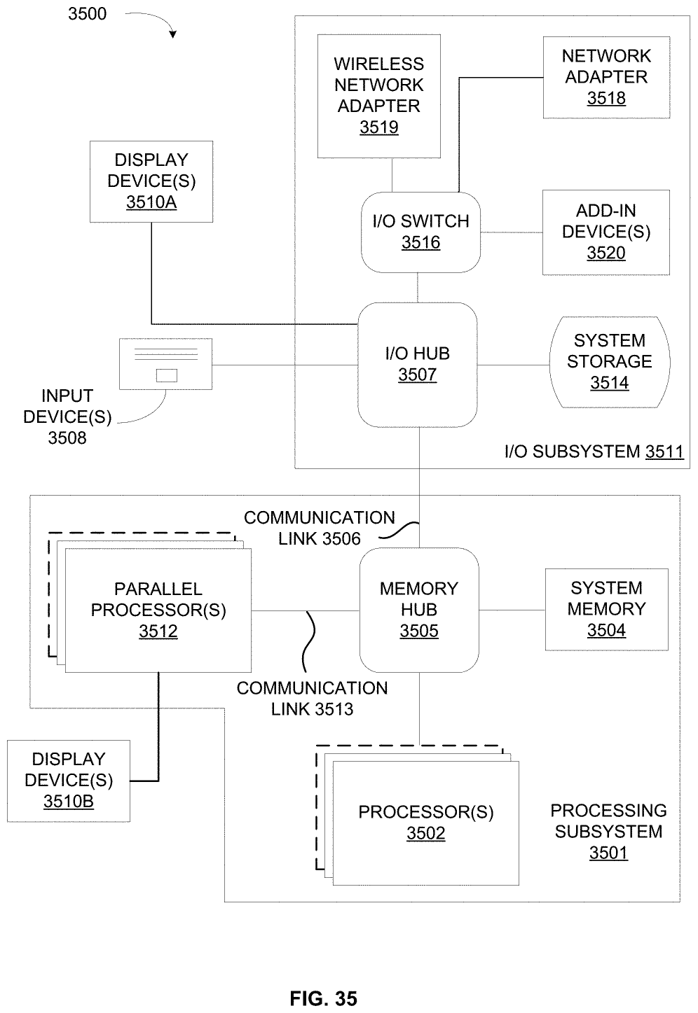

FIG. 34 illustrates an exemplary integrated circuit 3400, in accordance with at least one embodiment. In at least one embodiment, exemplary integrated circuit 3400 is an SoC that may be fabricated using one or more IP cores. In at least one embodiment, integrated circuit 3400 includes one or more application processor(s) 3405 CPUs), at least one graphics processor 3410, and may additionally include an image processor 3415 and/or a video processor 3420, any of which may be a modular IP core. In at least one embodiment, integrated circuit 3400 includes peripheral or bus logic including a USB controller 3425, a UART controller 3430, an SPI/SDIO controller 3435, and an I²S/I²C controller 3440. In at least one embodiment, integrated circuit 3400 can include a display device 3445 coupled to one or more of a high-definition multimedia interface (“HDMI”) controller 3450 and a mobile industry processor interface (“MIPI”) display interface 3455. In at least one embodiment, storage may be provided by a flash memory subsystem 3460 including flash memory and a flash memory controller. In at least one embodiment, a memory interface may be provided via a memory controller 3465 for access to SDRAM or SRAM memory devices. In at least one embodiment, some integrated circuits additionally include an embedded security engine 3470.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

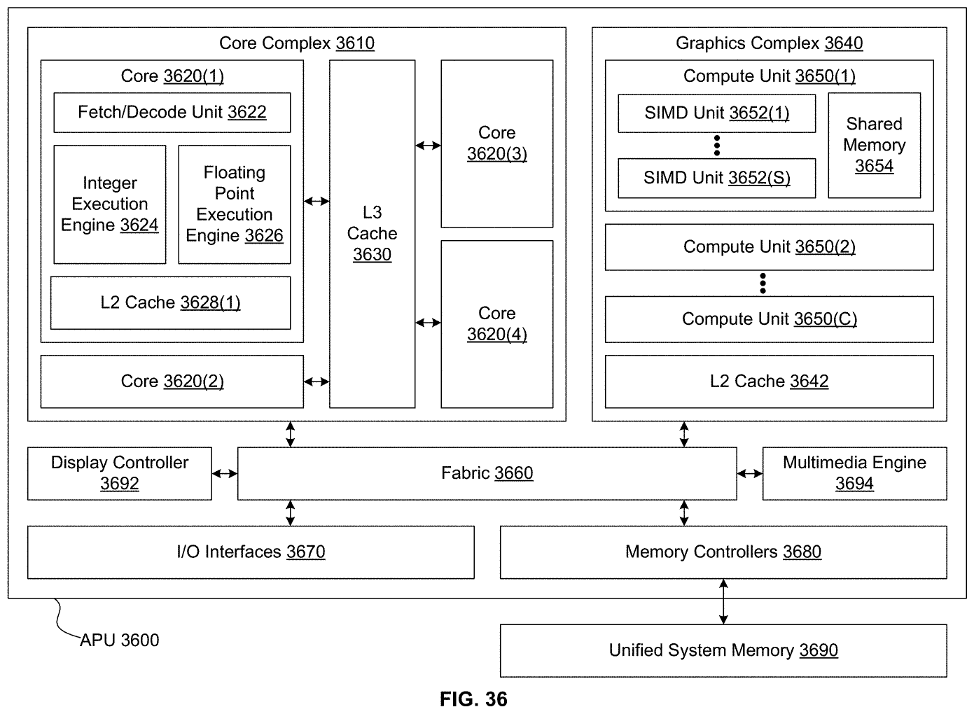

FIG. 35 illustrates a computing system 3500, according to at least one embodiment; In at least one embodiment, computing system 3500 includes a processing subsystem 3501 having one or more processor(s) 3502 and a system memory 3504 communicating via an interconnection path that may include a memory hub 3505. In at least one embodiment, memory hub 3505 may be a separate component within a chipset component or may be integrated within one or more processor(s) 3502. In at least one embodiment, memory hub 3505 couples with an I/O subsystem 3511 via a communication link 3506. In at least one embodiment, I/O subsystem 3511 includes an I/O hub 3507 that can enable computing system 3500 to receive input from one or more input device(s) 3508. In at least one embodiment, I/O hub 3507 can enable a display controller, which may be included in one or more processor(s) 3502, to provide outputs to one or more display device(s) 3510A. In at least one embodiment, one or more display device(s) 3510A coupled with I/O hub 3507 can include a local, internal, or embedded display device.

In at least one embodiment, processing subsystem 3501 includes one or more parallel processor(s) 3512 coupled to memory hub 3505 via a bus or other communication link 3513. In at least one embodiment, communication link 3513 may be one of any number of standards based communication link technologies or protocols, such as, but not limited to PCIe, or may be a vendor specific communications interface or communications fabric. In at least one embodiment, one or more parallel processor(s) 3512 form a computationally focused parallel or vector processing system that can include a large number of processing cores and/or processing clusters, such as a many integrated core processor. In at least one embodiment, one or more parallel processor(s) 3512 form a graphics processing subsystem that can output pixels to one of one or more display device(s) 3510A coupled via I/O Hub 3507. In at least one embodiment, one or more parallel processor(s) 3512 can also include a display controller and display interface (not shown) to enable a direct connection to one or more display device(s) 3510B.

In at least one embodiment, a system storage unit 3514 can connect to I/O hub 3507 to provide a storage mechanism for computing system 3500. In at least one embodiment, an I/O switch 3516 can be used to provide an interface mechanism to enable connections between I/O hub 3507 and other components, such as a network adapter 3518 and/or wireless network adapter 3519 that may be integrated into a platform, and various other devices that can be added via one or more add-in device(s) 3520. In at least one embodiment, network adapter 3518 can be an Ethernet adapter or another wired network adapter. In at least one embodiment, wireless network adapter 3519 can include one or more of a Wi-Fi, Bluetooth, NFC, or other network device that includes one or more wireless radios.

In at least one embodiment, computing system 3500 can include other components not explicitly shown, including USB or other port connections, optical storage drives, video capture devices, and/or variations thereof, that may also be connected to I/O hub 3507. In at least one embodiment, communication paths interconnecting various components in FIG. 35 may be implemented using any suitable protocols, such as PCI based protocols (e.g., PCIe), or other bus or point-to-point communication interfaces and/or protocol(s), such as NVLink high-speed interconnect, or interconnect protocols.

In at least one embodiment, one or more parallel processor(s) 3512 incorporate circuitry optimized for graphics and video processing, including, for example, video output circuitry, and constitutes a graphics processing unit (“GPU”). In at least one embodiment, one or more parallel processor(s) 3512 incorporate circuitry optimized for general purpose processing. In at least embodiment, components of computing system 3500 may be integrated with one or more other system elements on a single integrated circuit. For example, in at least one embodiment, one or more parallel processor(s) 3512, memory hub 3505, processor(s) 3502, and I/O hub 3507 can be integrated into a SoC integrated circuit. In at least one embodiment, components of computing system 3500 can be integrated into a single package to form a system in package (“SIP”) configuration. In at least one embodiment, at least a portion of components of computing system 3500 can be integrated into a multi-chip module (“MCM”), which can be interconnected with other multi-chip modules into a modular computing system. In at least one embodiment, I/O subsystem 3511 and display devices 3510B are omitted from computing system 3500.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### Processing Systems

The following FIGS. set forth, without limitation, exemplary processing systems that can be used to implement at least one embodiment.

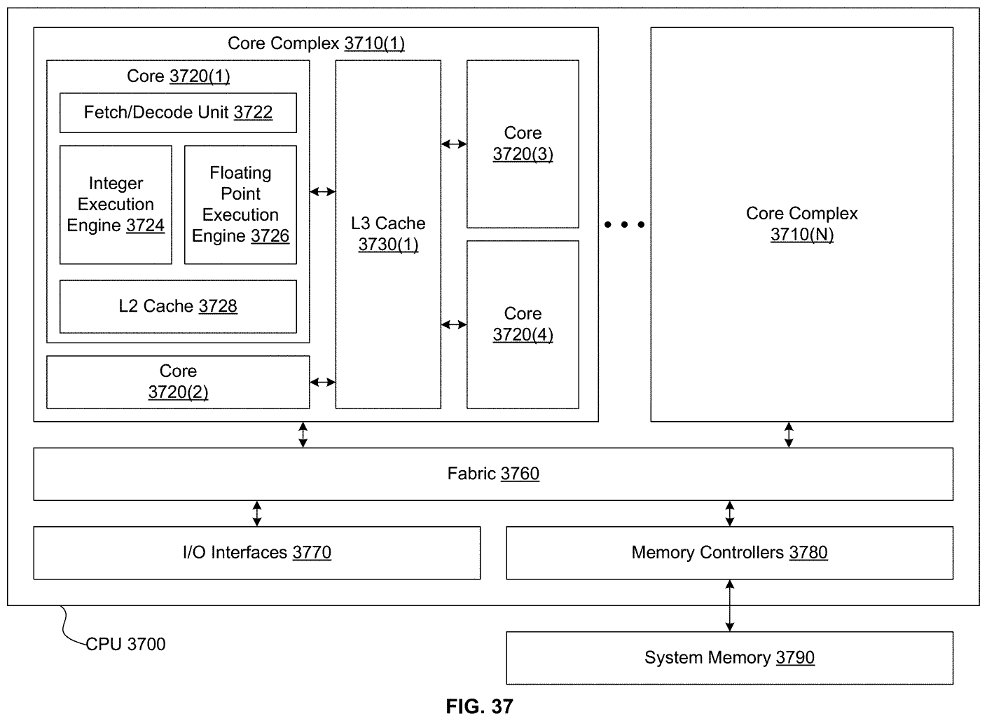

FIG. 36 illustrates an accelerated processing unit (“APU”) 3600, in accordance with at least one embodiment. In at least one embodiment, APU 3600 is developed by AMD Corporation of Santa Clara, Calif. In at least one embodiment, APU 3600 can be configured to execute an application program, such as a CUDA program. In at least one embodiment, APU 3600 includes, without limitation, a core complex 3610, a graphics complex 3640, fabric 3660, I/O interfaces 3670, memory controllers 3680, a display controller 3692, and a multimedia engine 3694. In at least one embodiment, APU 3600 may include, without limitation, any number of core complexes 3610, any number of graphics complexes 3650, any number of display controllers 3692, and any number of multimedia engines 3694 in any combination. For explanatory purposes, multiple instances of like objects are denoted herein with reference numbers identifying an object and parenthetical numbers identifying an instance where needed.

In at least one embodiment, core complex 3610 is a CPU, graphics complex 3640 is a GPU, and APU 3600 is a processing unit that integrates, without limitation, 3610 and 3640 onto a single chip. In at least one embodiment, some tasks may be assigned to core complex 3610 and other tasks may be assigned to graphics complex 3640. In at least one embodiment, core complex 3610 is configured to execute main control software associated with APU 3600, such as an operating system. In at least one embodiment, core complex 3610 is a master processor of APU 3600, controlling and coordinating operations of other processors. In at least one embodiment, core complex 3610 issues commands that control an operation of graphics complex 3640. In at least one embodiment, core complex 3610 can be configured to execute host executable code derived from CUDA source code, and graphics complex 3640 can be configured to execute device executable code derived from CUDA source code.

In at least one embodiment, core complex 3610 includes, without limitation, cores 3620(1)-3620(4) and an L3 cache 3630. In at least one embodiment, core complex 3610 may include, without limitation, any number of cores 3620 and any number and type of caches in any combination. In at least one embodiment, cores 3620 are configured to execute instructions of a particular instruction set architecture (“ISA”). In at least one embodiment, each core 3620 is a CPU core.

In at least one embodiment, each core 3620 includes, without limitation, a fetch/decode unit 3622, an integer execution engine 3624, a floating point execution engine 3626, and an L2 cache 3628. In at least one embodiment, fetch/decode unit 3622 fetches instructions, decodes such instructions, generates micro-operations, and dispatches separate micro-instructions to integer execution engine 3624 and floating point execution engine 3626. In at least one embodiment, fetch/decode unit 3622 can concurrently dispatch one micro-instruction to integer execution engine 3624 and another micro-instruction to floating point execution engine 3626. In at least one embodiment, integer execution engine 3624 executes, without limitation, integer and memory operations. In at least one embodiment, floating point engine 3626 executes, without limitation, floating point and vector operations. In at least one embodiment, fetch-decode unit 3622 dispatches micro-instructions to a single execution engine that replaces both integer execution engine 3624 and floating point execution engine 3626.

In at least one embodiment, each core 3620(i), where i is an integer representing a particular instance of core 3620, may access L2 cache 3628(i) included in core 3620(i). In at least one embodiment, each core 3620 included in core complex 3610(j), where j is an integer representing a particular instance of core complex 3610, is connected to other cores 3620 included in core complex 3610(j) via L3 cache 3630(j) included in core complex 3610(j). In at least one embodiment, cores 3620 included in core complex 3610(j), where j is an integer representing a particular instance of core complex 3610, can access all of L3 cache 3630(j) included in core complex 3610(j). In at least one embodiment, L3 cache 3630 may include, without limitation, any number of slices.

In at least one embodiment, graphics complex 3640 can be configured to perform compute operations in a highly-parallel fashion. In at least one embodiment, graphics complex 3640 is configured to execute graphics pipeline operations such as draw commands, pixel operations, geometric computations, and other operations associated with rendering an image to a display. In at least one embodiment, graphics complex 3640 is configured to execute operations unrelated to graphics. In at least one embodiment, graphics complex 3640 is configured to execute both operations related to graphics and operations unrelated to graphics.

In at least one embodiment, graphics complex 3640 includes, without limitation, any number of compute units 3650 and an L2 cache 3642. In at least one embodiment, compute units 3650 share L2 cache 3642. In at least one embodiment, L2 cache 3642 is partitioned. In at least one embodiment, graphics complex 3640 includes, without limitation, any number of compute units 3650 and any number (including zero) and type of caches. In at least one embodiment, graphics complex 3640 includes, without limitation, any amount of dedicated graphics hardware.

In at least one embodiment, each compute unit 3650 includes, without limitation, any number of SIMD units 3652 and a shared memory 3654. In at least one embodiment, each SIMD unit 3652 implements a SIMD architecture and is configured to perform operations in parallel. In at least one embodiment, each compute unit 3650 may execute any number of thread blocks, but each thread block executes on a single compute unit 3650. In at least one embodiment, a thread block includes, without limitation, any number of threads of execution. In at least one embodiment, a workgroup is a thread block. In at least one embodiment, each SIMD unit 3652 executes a different warp. In at least one embodiment, a warp is a group of threads (e.g., 16 threads), where each thread in a warp belongs to a single thread block and is configured to process a different set of data based on a single set of instructions. In at least one embodiment, predication can be used to disable one or more threads in a warp. In at least one embodiment, a lane is a thread. In at least one embodiment, a work item is a thread. In at least one embodiment, a wavefront is a warp. In at least one embodiment, different wavefronts in a thread block may synchronize together and communicate via shared memory 3654.

In at least one embodiment, fabric 3660 is a system interconnect that facilitates data and control transmissions across core complex 3610, graphics complex 3640, I/O interfaces 3670, memory controllers 3680, display controller 3692, and multimedia engine 3694. In at least one embodiment, APU 3600 may include, without limitation, any amount and type of system interconnect in addition to or instead of fabric 3660 that facilitates data and control transmissions across any number and type of directly or indirectly linked components that may be internal or external to APU 3600. In at least one embodiment, I/O interfaces 3670 are representative of any number and type of I/O interfaces (e.g., PCI, PCI-Extended (“PCI-X”), PCIe, gigabit Ethernet (“GBE”), USB, etc.). In at least one embodiment, various types of peripheral devices are coupled to I/O interfaces 3670 In at least one embodiment, peripheral devices that are coupled to I/O interfaces 3670 may include, without limitation, keyboards, mice, printers, scanners, joysticks or other types of game controllers, media recording devices, external storage devices, network interface cards, and so forth.

In at least one embodiment, display controller AMD92 displays images on one or more display device(s), such as a liquid crystal display (“LCD”) device. In at least one embodiment, multimedia engine 240 includes, without limitation, any amount and type of circuitry that is related to multimedia, such as a video decoder, a video encoder, an image signal processor, etc. In at least one embodiment, memory controllers 3680 facilitate data transfers between APU 3600 and a unified system memory 3690. In at least one embodiment, core complex 3610 and graphics complex 3640 share unified system memory 3690.

In at least one embodiment, APU 3600 implements a memory subsystem that includes, without limitation, any amount and type of memory controllers 3680 and memory devices (e.g., shared memory 3654) that may be dedicated to one component or shared among multiple components. In at least one embodiment, APU 3600 implements a cache subsystem that includes, without limitation, one or more cache memories (e.g., L2 caches 3728, L3 cache 3630, and L2 cache 3642) that may each be private to or shared between any number of components (e.g., cores 3620, core complex 3610, SIMD units 3652, compute units 3650, and graphics complex 3640).

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

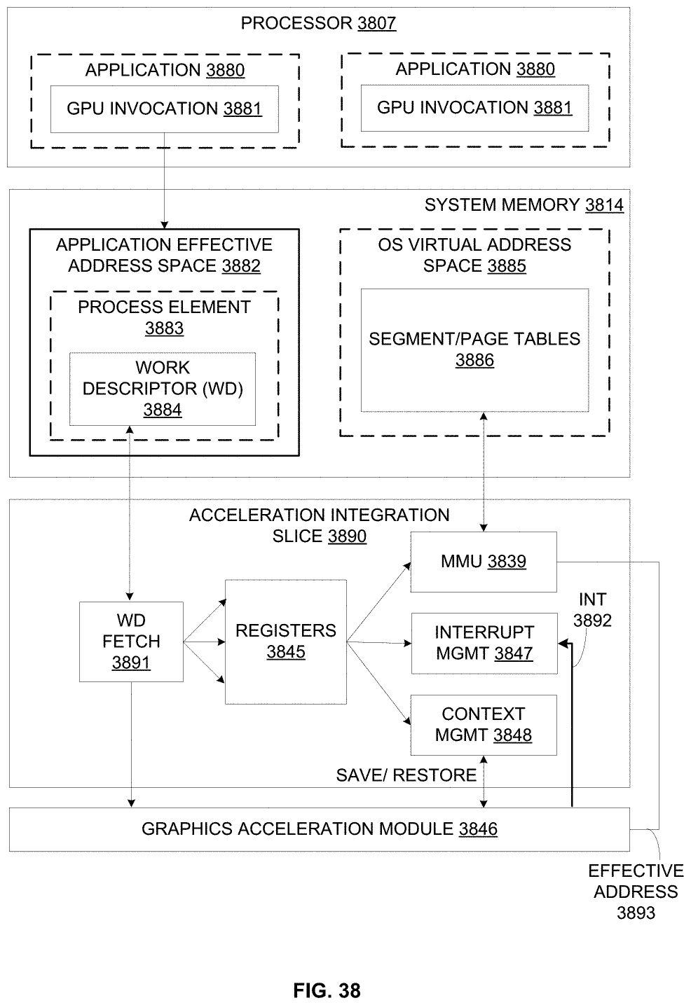

FIG. 37 illustrates a CPU 3700, in accordance with at least one embodiment. In at least one embodiment, CPU 3700 is developed by AMD Corporation of Santa Clara, Calif. In at least one embodiment, CPU 3700 can be configured to execute an application program. In at least one embodiment, CPU 3700 is configured to execute main control software, such as an operating system. In at least one embodiment, CPU 3700 issues commands that control an operation of an external GPU (not shown). In at least one embodiment, CPU 3700 can be configured to execute host executable code derived from CUDA source code, and an external GPU can be configured to execute device executable code derived from such CUDA source code. In at least one embodiment, CPU 3700 includes, without limitation, any number of core complexes 3710, fabric 3760, I/O interfaces 3770, and memory controllers AMAD80.

In at least one embodiment, core complex 3710 includes, without limitation, cores 3720(1)-3720(4) and an L3 cache 3730. In at least one embodiment, core complex 3710 may include, without limitation, any number of cores 3720 and any number and type of caches in any combination. In at least one embodiment, cores 3720 are configured to execute instructions of a particular ISA. In at least one embodiment, each core 3720 is a CPU core.

In at least one embodiment, each core 3720 includes, without limitation, a fetch/decode unit 3722, an integer execution engine 3724, a floating point execution engine 3726, and an L2 cache 3728. In at least one embodiment, fetch/decode unit 3722 fetches instructions, decodes such instructions, generates micro-operations, and dispatches separate micro-instructions to integer execution engine 3724 and floating point execution engine 3726. In at least one embodiment, fetch/decode unit 3722 can concurrently dispatch one micro-instruction to integer execution engine 3724 and another micro-instruction to floating point execution engine 3726. In at least one embodiment, integer execution engine 3724 executes, without limitation, integer and memory operations. In at least one embodiment, floating point engine 3726 executes, without limitation, floating point and vector operations. In at least one embodiment, fetch-decode unit 3722 dispatches micro-instructions to a single execution engine that replaces both integer execution engine 3724 and floating point execution engine 3726.

In at least one embodiment, each core 3720(i), where i is an integer representing a particular instance of core 3720, may access L2 cache 3728(i) included in core 3720(i). In at least one embodiment, each core 3720 included in core complex 3710(j), where j is an integer representing a particular instance of core complex 3710, is connected to other cores 3720 in core complex 3710(j) via L3 cache 3730(j) included in core complex 3710(j). In at least one embodiment, cores 3720 included in core complex 3710(j), where j is an integer representing a particular instance of core complex 3710, can access all of L3 cache 3730(j) included in core complex 3710(j). In at least one embodiment, L3 cache 3730 may include, without limitation, any number of slices.

In at least one embodiment, fabric 3760 is a system interconnect that facilitates data and control transmissions across core complexes 3710(1)-3710(N) (where N is an integer greater than zero), I/O interfaces 3770, and memory controllers 3780. In at least one embodiment, CPU 3700 may include, without limitation, any amount and type of system interconnect in addition to or instead of fabric 3760 that facilitates data and control transmissions across any number and type of directly or indirectly linked components that may be internal or external to CPU 3700. In at least one embodiment, I/O interfaces 3770 are representative of any number and type of I/O interfaces (e.g., PCI, PCI-X, PCIe, GBE, USB, etc.). In at least one embodiment, various types of peripheral devices are coupled to I/O interfaces 3770 In at least one embodiment, peripheral devices that are coupled to I/O interfaces 3770 may include, without limitation, displays, keyboards, mice, printers, scanners, joysticks or other types of game controllers, media recording devices, external storage devices, network interface cards, and so forth.

In at least one embodiment, memory controllers 3780 facilitate data transfers between CPU 3700 and a system memory 3790. In at least one embodiment, core complex 3710 and graphics complex 3740 share system memory 3790. In at least one embodiment, CPU 3700 implements a memory subsystem that includes, without limitation, any amount and type of memory controllers 3780 and memory devices that may be dedicated to one component or shared among multiple components. In at least one embodiment, CPU 3700 implements a cache subsystem that includes, without limitation, one or more cache memories (e.g., L2 caches 3728 and L3 caches 3730) that may each be private to or shared between any number of components (e.g., cores 3720 and core complexes 3710).

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

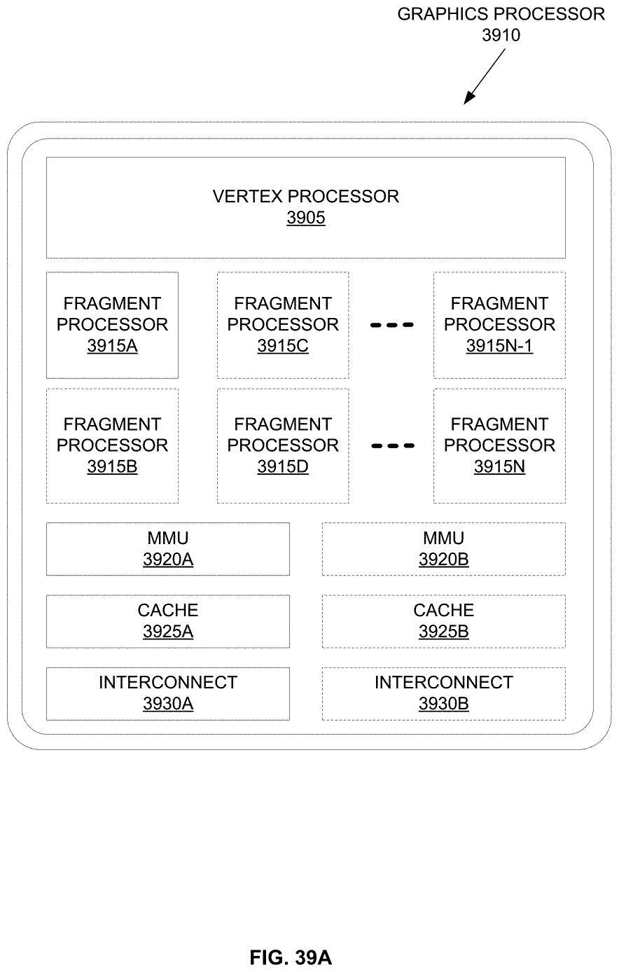

FIG. 38 illustrates an exemplary accelerator integration slice 3890, in accordance with at least one embodiment. As used herein, a “slice” comprises a specified portion of processing resources of an accelerator integration circuit. In at least one embodiment, an accelerator integration circuit provides cache management, memory access, context management, and interrupt management services on behalf of multiple graphics processing engines included in a graphics acceleration module. Graphics processing engines may each comprise a separate GPU. Alternatively, graphics processing engines may comprise different types of graphics processing engines within a GPU such as graphics execution units, media processing engines (e.g., video encoders/decoders), samplers, and blit engines. In at least one embodiment, a graphics acceleration module may be a GPU with multiple graphics processing engines. In at least one embodiment, graphics processing engines may be individual GPUs integrated on a common package, line card, or chip.

An application effective address space 3882 within system memory 3814 stores process elements 3883. In one embodiment, process elements 3883 are stored in response to GPU invocations 3881 from applications 3880 executed on processor 3807. A process element 3883 contains process state for corresponding application 3880. A work descriptor (“WD”) 3884 contained in process element 3883 can be a single job requested by an application or may contain a pointer to a queue of jobs. In at least one embodiment, WD 3884 is a pointer to a job request queue in application effective address space 3882.

Graphics acceleration module 3846 and/or individual graphics processing engines can be shared by all or a subset of processes in a system. In at least one embodiment, an infrastructure for setting up process state and sending WD 3884 to graphics acceleration module 3846 to start a job in a virtualized environment may be included.

In at least one embodiment, a dedicated-process programming model is implementation-specific. In this model, a single process owns graphics acceleration module 3846 or an individual graphics processing engine. Because graphics acceleration module 3846 is owned by a single process, a hypervisor initializes an accelerator integration circuit for an owning partition and an operating system initializes accelerator integration circuit for an owning process when graphics acceleration module 3846 is assigned.

In operation, a WD fetch unit 3891 in accelerator integration slice 3890 fetches next WD 3884 which includes an indication of work to be done by one or more graphics processing engines of graphics acceleration module 3846. Data from WD 3884 may be stored in registers 3845 and used by a memory management unit (“MMU”) 3839, interrupt management circuit 3847 and/or context management circuit 3848 as illustrated. For example, one embodiment of MMU 3839 includes segment/page walk circuitry for accessing segment/page tables 3886 within OS virtual address space 3885. Interrupt management circuit 3847 may process interrupt events (“INT”) 3892 received from graphics acceleration module 3846. When performing graphics operations, an effective address 3893 generated by a graphics processing engine is translated to a real address by MMU 3839.

In one embodiment, a same set of registers 3845 are duplicated for each graphics processing engine and/or graphics acceleration module 3846 and may be initialized by a hypervisor or operating system. Each of these duplicated registers may be included in accelerator integration slice 3890. Exemplary registers that may be initialized by a hypervisor are shown in Table 1.

TABLE 1
Hypervisor Initialized Registers

| | |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record Pointer |
| 9 | Storage Description Register |

Exemplary registers that may be initialized by an operating system are shown in Table 2.

TABLE 2
Operating System Initialized Registers

| | |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In one embodiment, each WD 3884 is specific to a particular graphics acceleration module 3846 and/or a particular graphics processing engine. It contains all information required by a graphics processing engine to do work or it can be a pointer to a memory location where an application has set up a command queue of work to be completed.

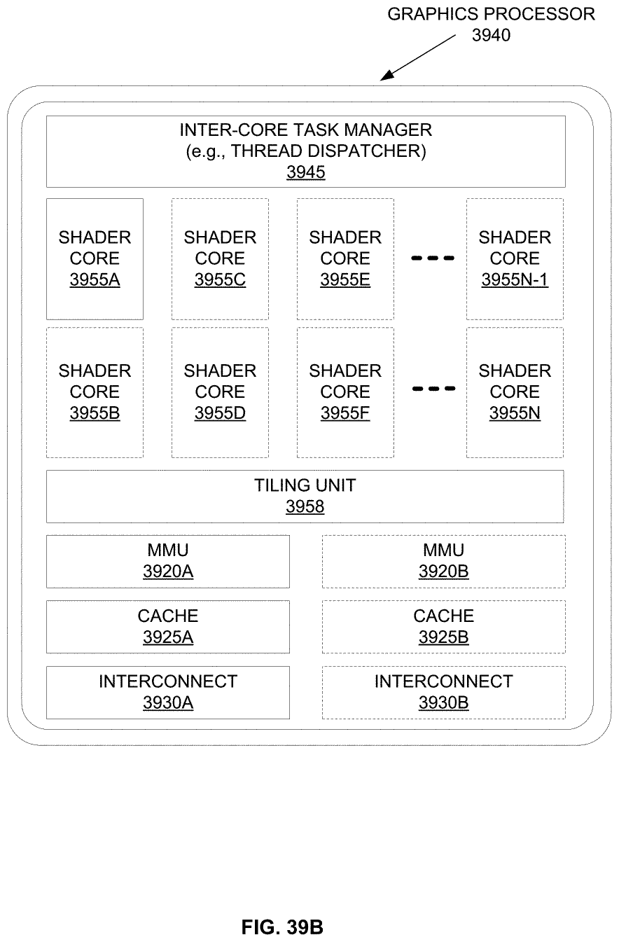

FIGS. 39A and 39B illustrate exemplary graphics processors, in accordance with at least one embodiment. In at least one embodiment, any of the exemplary graphics processors may be fabricated using one or more IP cores. In addition to what is illustrated, other logic and circuits may be included in at least one embodiment, including additional graphics processors/cores, peripheral interface controllers, or general-purpose processor cores. In at least one embodiment, the exemplary graphics processors are for use within an SoC.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

FIG. 39A illustrates an exemplary graphics processor 3910 of an SoC integrated circuit that may be fabricated using one or more IP cores, in accordance with at least one embodiment. FIG. 39B illustrates an additional exemplary graphics processor 3940 of an SoC integrated circuit that may be fabricated using one or more IP cores, in accordance with at least one embodiment. In at least one embodiment, graphics processor 3910 of FIG. 39A is a low power graphics processor core. In at least one embodiment, graphics processor 3940 of FIG. 39B is a higher performance graphics processor core. In at least one embodiment, each of graphics processors 3910, 3940 can be variants of graphics processor 1510 of FIG. 15.

In at least one embodiment, graphics processor 3910 includes a vertex processor 3905 and one or more fragment processor(s) 3915A-3915N (e.g., 3915A, 3915B, 3915C, 3915D, through 3915N-1, and 3915N). In at least one embodiment, graphics processor 3910 can execute different shader programs via separate logic, such that vertex processor 3905 is optimized to execute operations for vertex shader programs, while one or more fragment processor(s) 3915A-3915N execute fragment (e.g., pixel) shading operations for fragment or pixel shader programs. In at least one embodiment, vertex processor 3905 performs a vertex processing stage of a 3D graphics pipeline and generates primitives and vertex data. In at least one embodiment, fragment processor(s) 3915A-3915N use primitive and vertex data generated by vertex processor 3905 to produce a framebuffer that is displayed on a display device. In at least one embodiment, fragment processor(s) 3915A-3915N are optimized to execute fragment shader programs as provided for in an OpenGL API, which may be used to perform similar operations as a pixel shader program as provided for in a Direct 3D API.

In at least one embodiment, graphics processor 3910 additionally includes one or more MMU(s) 3920A-3920B, cache(s) 3925A-3925B, and circuit interconnect(s) 3930A-3930B. In at least one embodiment, one or more MMU(s) 3920A-3920B provide for virtual to physical address mapping for graphics processor 3910, including for vertex processor 3905 and/or fragment processor(s) 3915A-3915N, which may reference vertex or image/texture data stored in memory, in addition to vertex or image/texture data stored in one or more cache(s) 3925A-3925B. In at least one embodiment, one or more MMU(s) 3920A-3920B may be synchronized with other MMUs within a system, including one or more MMUs associated with one or more application processor(s) 1505, image processors 1515, and/or video processors 1520 of FIG. 15, such that each processor 1505-1520 can participate in a shared or unified virtual memory system. In at least one embodiment, one or more circuit interconnect(s) 3930A-3930B enable graphics processor 3910 to interface with other IP cores within an SoC, either via an internal bus of an SoC or via a direct connection.

In at least one embodiment, graphics processor 3940 includes one or more MMU(s) 3920A-3920B, caches 3925A-3925B, and circuit interconnects 3930A-3930B of graphics processor 3910 of FIG. 39A. In at least one embodiment, graphics processor 3940 includes one or more shader core(s) 3955A-3955N (e.g., 3955A, 3955B, 3955C, 3955D, 3955E, 3955F, through 3955N-1, and 3955N), which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 3940 includes an inter-core task manager 3945, which acts as a thread dispatcher to dispatch execution threads to one or more shader cores 3955A-3955N and a tiling unit 3958 to accelerate tiling operations for tile-based rendering, in which rendering operations for a scene are subdivided in image space, for example to exploit local spatial coherence within a scene or to optimize use of internal caches.

In at least one embodiment, one or more circuits, processors, computing systems, or other devices or techniques are adapted, with reference to said FIGS., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

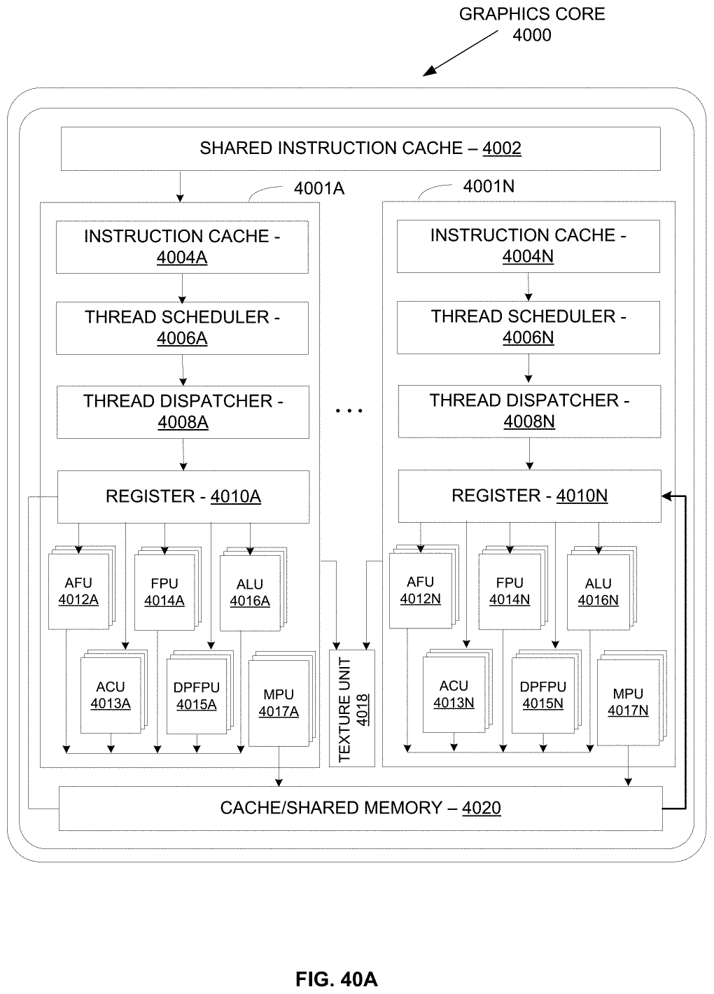

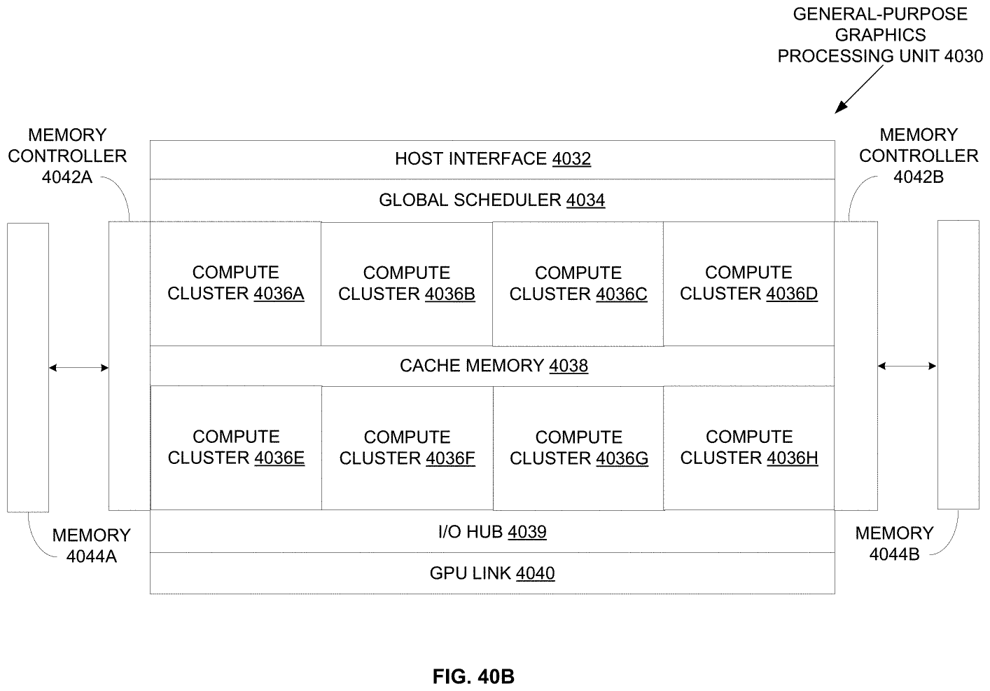

FIG. 40A illustrates a graphics core 4000, in accordance with at least one embodiment. In at least one embodiment, graphics core 4000 may be included within graphics processor 3410 of FIG. 34. In at least one embodiment, graphics core 4000 may be a unified shader core 3955A-3955N as in FIG. 39B. In at least one embodiment, graphics core 4000 includes a shared instruction cache 4002, a texture unit 4018, and a cache/shared memory 4020 that are common to execution resources within graphics core 4000. In at least one embodiment, graphics core 4000 can include multiple slices 4001A-4001N or partition for each core, and a graphics processor can include multiple instances of graphics core 4000. Slices 4001A-4001N can include support logic including a local instruction cache 4004A-4004N, a thread scheduler 4006A-4006N, a thread dispatcher 4008A-4008N, and a set of registers 4010A-4010N. In at least one embodiment, slices 4001A-4001N can include a set of additional function units (“AFUs”) 4012A-4012N, floating-point units (“FPUs”) 4014A-4014N, integer arithmetic logic units (“ALUs”) 4016-4016N, address computational units (“ACUs”) 4013A-4013N, double-precision floating-point units (“DPFPUs”) 4015A-4015N, and matrix processing units (“MPUs”) 4017A-4017N.

In at least one embodiment, FPUs 4014A-4014N can perform single-precision (32-bit) and half-precision (16-bit) floating point operations, while DPFPUs 4015A-4015N perform double precision (64-bit) floating point operations. In at least one embodiment, ALUs 4016A-4016N can perform variable precision integer operations at 8-bit, 16-bit, and 32-bit precision, and can be configured for mixed precision operations. In at least one embodiment, MPUs 4017A-4017N can also be configured for mixed precision matrix operations, including half-precision floating point and 8-bit integer operations. In at least one embodiment, MPUs 4017-4017N can perform a variety of matrix operations to accelerate CUDA programs, including enabling support for accelerated general matrix to matrix multiplication (“GEMM”). In at least one embodiment, AFUs 4012A-4012N can perform additional logic operations not supported by floating-point or integer units, including trigonometric operations (e.g., Sine, Cosine, etc.).

FIG. 40B illustrates a general-purpose graphics processing unit (“GPGPU”) 4030, in accordance with at least one embodiment. In at least one embodiment, GPGPU 4030 is highly-parallel and suitable for deployment on a multi-chip module. In at least one embodiment, GPGPU 4030 can be configured to enable highly-parallel compute operations to be performed by an array of GPUs. In at least one embodiment, GPGPU 4030 can be linked directly to other instances of GPGPU 4030 to create a multi-GPU cluster to improve execution time for CUDA programs. In at least one embodiment, GPGPU 4030 includes a host interface 4032 to enable a connection with a host processor. In at least one embodiment, host interface 4032 is a PCIe interface. In at least one embodiment, host interface 4032 can be a vendor specific communications interface or communications fabric. In at least one embodiment, GPGPU 4030 receives commands from a host processor and uses a global scheduler 4034 to distribute execution threads associated with those commands to a set of compute clusters 4036A-4036H. In at least one embodiment, compute clusters 4036A-4036H share a cache memory 4038. In at least one embodiment, cache memory 4038 can serve as a higher-level cache for cache memories within compute clusters 4036A-4036H.

In at least one embodiment, GPGPU 4030 includes memory 4044A-4044B coupled with compute clusters 4036A-4036H via a set of memory controllers 4042A-4042B. In at least one embodiment, memory 4044A-4044B can include various types of memory devices including DRAM or graphics random access memory, such as synchronous graphics random access memory (“SGRAM”), including graphics double data rate (“GDDR”) memory.

In at least one embodiment, compute clusters 4036A-4036H each include a set of graphics cores, such as graphics core 4000 of FIG. 40A, which can include multiple types of integer and floating point logic units that can perform computational operations at a range of precisions including suited for computations associated with CUDA programs. For example, in at least one embodiment, at least a subset of floating point units in each of compute clusters 4036A-4036H can be configured to perform 16-bit or 32-bit floating point operations, while a different subset of floating point units can be configured to perform 64-bit floating point operations.

In at least one embodiment, multiple instances of GPGPU 4030 can be configured to operate as a compute cluster. In at least one embodiment, compute clusters 4036A-4036H may implement any technically feasible communication techniques for synchronization and data exchange. In at least one embodiment, multiple instances of GPGPU 4030 communicate over host interface 4032. In at least one embodiment, GPGPU 4030 includes an I/O hub 4039 that couples GPGPU 4030 with a GPU link 4040 that enables a direct connection to other instances of GPGPU 4030. In at least one embodiment, GPU link 4040 is coupled to a dedicated GPU-to-GPU bridge that enables communication and synchronization between multiple instances of GPGPU 4030. In at least one embodiment GPU link 4040 couples with a high speed interconnect to transmit and receive data to other GPGPUs 4030 or parallel processors. In at least one embodiment, multiple instances of GPGPU 4030 are located in separate data processing systems and communicate via a network device that is accessible via host interface 4032. In at least one embodiment GPU link 4040 can be configured to enable a connection to a host processor in addition to or as an alternative to host interface 4032. In at least one embodiment, GPGPU 4030 can be configured to execute a CUDA program.

In at least one embodiment, one or more circuits, processors, computing systems, or other devices or techniques are adapted, with reference to above FIGS., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

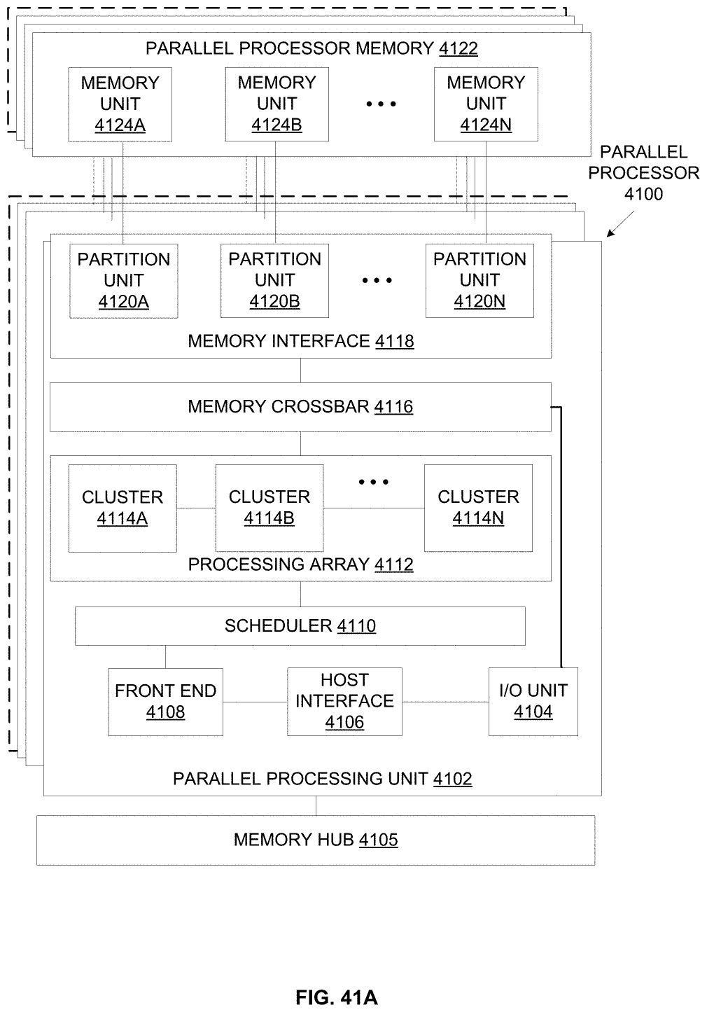

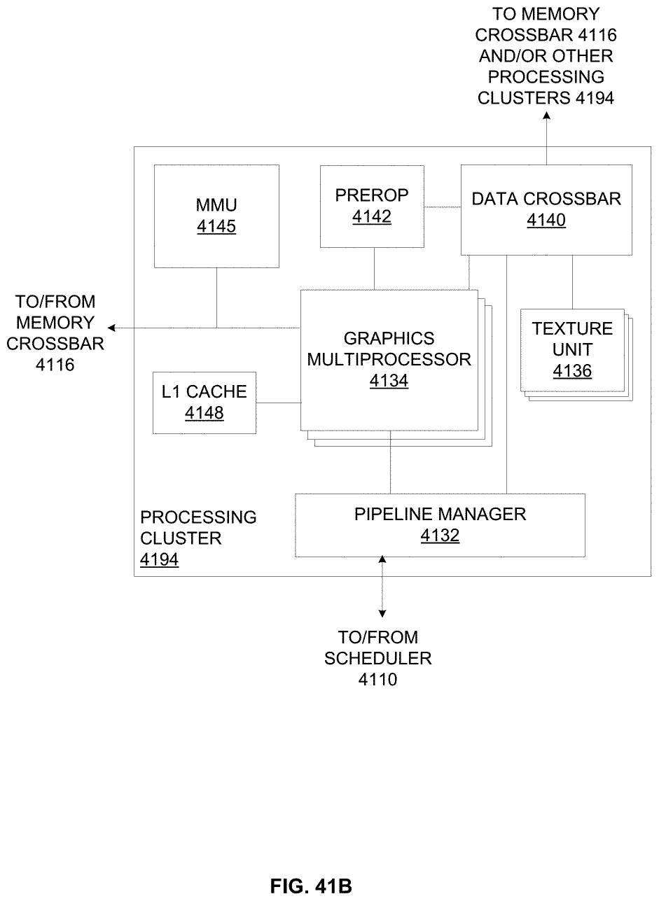

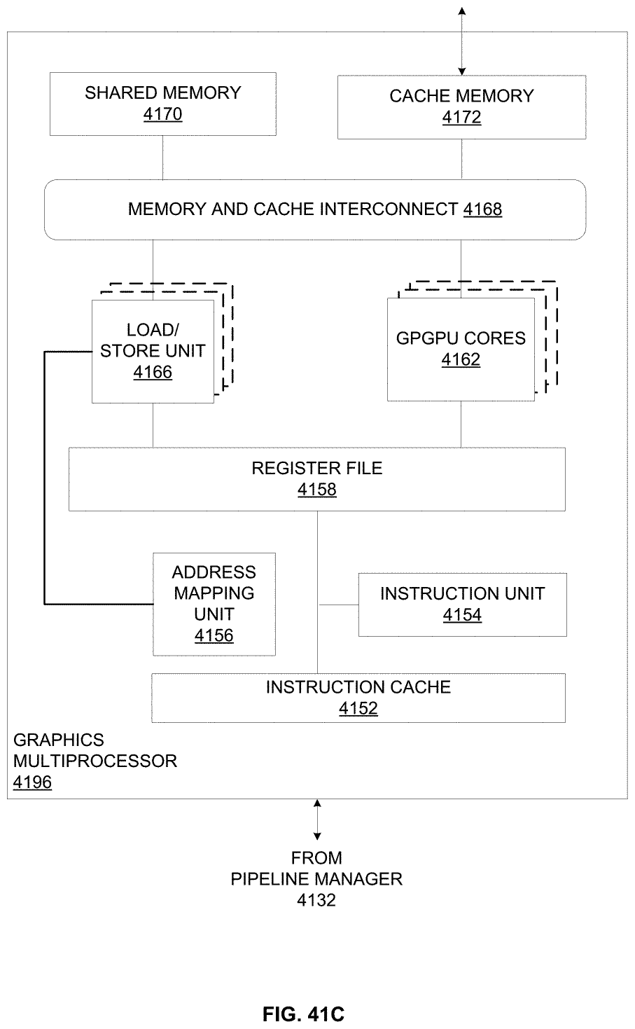

FIG. 41A illustrates a parallel processor 4100, in accordance with at least one embodiment. In at least one embodiment, various components of parallel processor 4100 may be implemented using one or more integrated circuit devices, such as programmable processors, application specific integrated circuits (“ASICs”), or FPGAs.

In at least one embodiment, parallel processor 4100 includes a parallel processing unit 4102. In at least one embodiment, parallel processing unit 4102 includes an I/O unit 4104 that enables communication with other devices, including other instances of parallel processing unit 4102. In at least one embodiment, I/O unit 4104 may be directly connected to other devices. In at least one embodiment, I/O unit 4104 connects with other devices via use of a hub or switch interface, such as memory hub 1605. In at least one embodiment, connections between memory hub 1605 and I/O unit 4104 form a communication link. In at least one embodiment, I/O unit 4104 connects with a host interface 4106 and a memory crossbar 4116, where host interface 4106 receives commands directed to performing processing operations and memory crossbar 4116 receives commands directed to performing memory operations.

In at least one embodiment, when host interface 4106 receives a command buffer via I/O unit 4104, host interface 4106 can direct work operations to perform those commands to a front end 4108. In at least one embodiment, front end 4108 couples with a scheduler 4110, which is configured to distribute commands or other work items to a processing array 4112. In at least one embodiment, scheduler 4110 ensures that processing array 4112 is properly configured and in a valid state before tasks are distributed to processing array 4112. In at least one embodiment, scheduler 4110 is implemented via firmware logic executing on a microcontroller. In at least one embodiment, microcontroller implemented scheduler 4110 is configurable to perform complex scheduling and work distribution operations at coarse and fine granularity, enabling rapid preemption and context switching of threads executing on processing array 4112. In at least one embodiment, host software can prove workloads for scheduling on processing array 4112 via one of multiple graphics processing doorbells. In at least one embodiment, workloads can then be automatically distributed across processing array 4112 by scheduler 4110 logic within a microcontroller including scheduler 4110.

In at least one embodiment, processing array 4112 can include up to “N” clusters (e.g., cluster 4114A, cluster 4114B, through cluster 4114N). In at least one embodiment, each cluster 4114A-4114N of processing array 4112 can execute a large number of concurrent threads. In at least one embodiment, scheduler 4110 can allocate work to clusters 4114A-4114N of processing array 4112 using various scheduling and/or work distribution algorithms, which may vary depending on a workload arising for each type of program or computation. In at least one embodiment, scheduling can be handled dynamically by scheduler 4110, or can be assisted in part by compiler logic during compilation of program logic configured for execution by processing array 4112. In at least one embodiment, different clusters 4114A-4114N of processing array 4112 can be allocated for processing different types of programs or for performing different types of computations.

In at least one embodiment, processing array 4112 can be configured to perform various types of parallel processing operations. In at least one embodiment, processing array 4112 is configured to perform general-purpose parallel compute operations. For example, in at least one embodiment, processing array 4112 can include logic to execute processing tasks including filtering of video and/or audio data, performing modeling operations, including physics operations, and performing data transformations.

In at least one embodiment, processing array 4112 is configured to perform parallel graphics processing operations. In at least one embodiment, processing array 4112 can include additional logic to support execution of such graphics processing operations, including, but not limited to texture sampling logic to perform texture operations, as well as tessellation logic and other vertex processing logic. In at least one embodiment, processing array 4112 can be configured to execute graphics processing related shader programs such as, but not limited to vertex shaders, tessellation shaders, geometry shaders, and pixel shaders. In at least one embodiment, parallel processing unit 4102 can transfer data from system memory via I/O unit 4104 for processing. In at least one embodiment, during processing, transferred data can be stored to on-chip memory (e.g., a parallel processor memory 4122) during processing, then written back to system memory.

In at least one embodiment, when parallel processing unit 4102 is used to perform graphics processing, scheduler 4110 can be configured to divide a processing workload into approximately equal sized tasks, to better enable distribution of graphics processing operations to multiple clusters 4114A-4114N of processing array 4112. In at least one embodiment, portions of processing array 4112 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 4114A-4114N may be stored in buffers to allow intermediate data to be transmitted between clusters 4114A-4114N for further processing.

In at least one embodiment, processing array 4112 can receive processing tasks to be executed via scheduler 4110, which receives commands defining processing tasks from front end 4108. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 4110 may be configured to fetch indices corresponding to tasks or may receive indices from front end 4108. In at least one embodiment, front end 4108 can be configured to ensure processing array 4112 is configured to a valid state before a workload specified by incoming command buffers batch-buffers, push buffers, etc.) is initiated.

In at least one embodiment, each of one or more instances of parallel processing unit 4102 can couple with parallel processor memory 4122. In at least one embodiment, parallel processor memory 4122 can be accessed via memory crossbar 4116, which can receive memory requests from processing array 4112 as well as I/O unit 4104. In at least one embodiment, memory crossbar 4116 can access parallel processor memory 4122 via a memory interface 4118. In at least one embodiment, memory interface 4118 can include multiple partition units (e.g., a partition unit 4120A, partition unit 4120B, through partition unit 4120N) that can each couple to a portion (e.g., memory unit) of parallel processor memory 4122. In at least one embodiment, a number of partition units 4120A-4120N is configured to be equal to a number of memory units, such that a first partition unit 4120A has a corresponding first memory unit 4124A, a second partition unit 4120B has a corresponding memory unit 4124B, and an Nth partition unit 4120N has a corresponding Nth memory unit 4124N. In at least one embodiment, a number of partition units 4120A-4120N may not be equal to a number of memory devices.

In at least one embodiment, memory units 4124A-4124N can include various types of memory devices, including DRAM or graphics random access memory, such as SGRAM, including GDDR memory. In at least one embodiment, memory units 4124A-4124N may also include 3D stacked memory, including but not limited to high bandwidth memory (“HBM”). In at least one embodiment, render targets, such as frame buffers or texture maps may be stored across memory units 4124A-4124N, allowing partition units 4120A-4120N to write portions of each render target in parallel to efficiently use available bandwidth of parallel processor memory 4122. In at least one embodiment, a local instance of parallel processor memory 4122 may be excluded in favor of a unified memory design that utilizes system memory in conjunction with local cache memory.

In at least one embodiment, any one of clusters 4114A-4114N of processing array 4112 can process data that will be written to any of memory units 4124A-4124N within parallel processor memory 4122. In at least one embodiment, memory crossbar 4116 can be configured to transfer an output of each cluster 4114A-4114N to any partition unit 4120A-4120N or to another cluster 4114A-4114N, which can perform additional processing operations on an output. In at least one embodiment, each cluster 4114A-4114N can communicate with memory interface 4118 through memory crossbar 4116 to read from or write to various external memory devices. In at least one embodiment, memory crossbar 4116 has a connection to memory interface 4118 to communicate with I/O unit 4104, as well as a connection to a local instance of parallel processor memory 4122, enabling processing units within different clusters 4114A-4114N to communicate with system memory or other memory that is not local to parallel processing unit 4102. In at least one embodiment, memory crossbar 4116 can use virtual channels to separate traffic streams between clusters 4114A-4114N and partition units 4120A-4120N.

In at least one embodiment, multiple instances of parallel processing unit 4102 can be provided on a single add-in card, or multiple add-in cards can be interconnected. In at least one embodiment, different instances of parallel processing unit 4102 can be configured to interoperate even if different instances have different numbers of processing cores, different amounts of local parallel processor memory, and/or other configuration differences. For example, in at least one embodiment, some instances of parallel processing unit 4102 can include higher precision floating point units relative to other instances. In at least one embodiment, systems incorporating one or more instances of parallel processing unit 4102 or parallel processor 4100 can be implemented in a variety of configurations and form factors, including but not limited to desktop, laptop, or handheld personal computers, servers, workstations, game consoles, and/or embedded systems.

FIG. 41B illustrates a processing cluster 4194, in accordance with at least one embodiment. In at least one embodiment, processing cluster 4194 is included within a parallel processing unit. In at least one embodiment, processing cluster 4194 is one of processing clusters 4114A-4114N of FIG. 41. In at least one embodiment, processing cluster 4194 can be configured to execute many threads in parallel, where the term “thread” refers to an instance of a particular program executing on a particular set of input data. In at least one embodiment, single instruction, multiple data (“SIMD”) instruction issue techniques are used to support parallel execution of a large number of threads without providing multiple independent instruction units. In at least one embodiment, single instruction, multiple thread (“SIMT”) techniques are used to support parallel execution of a large number of generally synchronized threads, using a common instruction unit configured to issue instructions to a set of processing engines within each processing cluster 4194.

In at least one embodiment, operation of processing cluster 4194 can be controlled via a pipeline manager 4132 that distributes processing tasks to SIMT parallel processors. In at least one embodiment, pipeline manager 4132 receives instructions from scheduler 4110 of FIG. 41 and manages execution of those instructions via a graphics multiprocessor 4134 and/or a texture unit 4136. In at least one embodiment, graphics multiprocessor 4134 is an exemplary instance of a SIMT parallel processor. However, in at least one embodiment, various types of SIMT parallel processors of differing architectures may be included within processing cluster 4194. In at least one embodiment, one or more instances of graphics multiprocessor 4134 can be included within processing cluster 4194. In at least one embodiment, graphics multiprocessor 4134 can process data and a data crossbar 4140 can be used to distribute processed data to one of multiple possible destinations, including other shader units. In at least one embodiment, pipeline manager 4132 can facilitate distribution of processed data by specifying destinations for processed data to be distributed via data crossbar 4140.

In at least one embodiment, each graphics multiprocessor 4134 within processing cluster 4194 can include an identical set of functional execution logic (e.g., arithmetic logic units, load/store units (“LSUs”), etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 4194 constitute a thread. In at least one embodiment, a set of threads executing across a set of parallel processing engines is a thread group. In at least one embodiment, a thread group executes a program on different input data. In at least one embodiment, each thread within a thread group can be assigned to a different processing engine within graphics multiprocessor 4134. In at least one embodiment, a thread group may include fewer threads than a number of processing engines within graphics multiprocessor 4134. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 4134. In at least one embodiment, when a thread group includes more threads than a number of processing engines within graphics multiprocessor 4134, processing can be performed over consecutive clock cycles. In at least one embodiment, multiple thread groups can be executed concurrently on graphics multiprocessor 4134.

In at least one embodiment, graphics multiprocessor 4134 includes an internal cache memory to perform load and store operations. In at least one embodiment, graphics multiprocessor 4134 can forego an internal cache and use a cache memory (e.g., L1 cache 4148) within processing cluster 4194. In at least one embodiment, each graphics multiprocessor 4134 also has access to Level 2 (“L2”) caches within partition units (e.g., partition units 4120A-4120N of FIG. 41A) that are shared among all processing clusters 4194 and may be used to transfer data between threads. In at least one embodiment, graphics multiprocessor 4134 may also access off-chip global memory, which can include one or more of local parallel processor memory and/or system memory. In at least one embodiment, any memory external to parallel processing unit 4102 may be used as global memory. In at least one embodiment, processing cluster 4194 includes multiple instances of graphics multiprocessor 4134 that can share common instructions and data, which may be stored in L1 cache 4148.

In at least one embodiment, each processing cluster 4194 may include an MMU 4145 that is configured to map virtual addresses into physical addresses. In at least one embodiment, one or more instances of MMU 4145 may reside within memory interface 4118 of FIG. 41. In at least one embodiment, MMU 4145 includes a set of page table entries (“PTEs”) used to map a virtual address to a physical address of a tile and optionally a cache line index. In at least one embodiment, MMU 4145 may include address translation lookaside buffers (“TLBs”) or caches that may reside within graphics multiprocessor 4134 or L1 cache 4148 or processing cluster 4194. In at least one embodiment, a physical address is processed to distribute surface data access locality to allow efficient request interleaving among partition units. In at least one embodiment, a cache line index may be used to determine whether a request for a cache line is a hit or miss.

In at least one embodiment, processing cluster 4194 may be configured such that each graphics multiprocessor 4134 is coupled to a texture unit 4136 for performing texture mapping operations, e.g., determining texture sample positions, reading texture data, and filtering texture data. In at least one embodiment, texture data is read from an internal texture L1 cache (not shown) or from an L1 cache within graphics multiprocessor 4134 and is fetched from an L2 cache, local parallel processor memory, or system memory, as needed. In at least one embodiment, each graphics multiprocessor 4134 outputs a processed task to data crossbar 4140 to provide a processed task to another processing cluster 4194 for further processing or to store a processed task in an L2 cache, a local parallel processor memory, or a system memory via memory crossbar 4116. In at least one embodiment, a pre-raster operations unit (“preROP”) 4142 is configured to receive data from graphics multiprocessor 4134, direct data to ROP units, which may be located with partition units as described herein (e.g., partition units 4120A-4120N of FIG. 41). In at least one embodiment, PreROP 4142 can perform optimizations for color blending, organize pixel color data, and perform address translations.

FIG. 41C illustrates a graphics multiprocessor 4196, in accordance with at least one embodiment. In at least one embodiment, graphics multiprocessor 4196 is graphics multiprocessor 4134 of FIG. 41B. In at least one embodiment, graphics multiprocessor 4196 couples with pipeline manager 4132 of processing cluster 4194. In at least one embodiment, graphics multiprocessor 4196 has an execution pipeline including but not limited to an instruction cache 4152, an instruction unit 4154, an address mapping unit 4156, a register file 4158, one or more GPGPU cores 4162, and one or more LSUs 4166. GPGPU cores 4162 and LSUs 4166 are coupled with cache memory 4172 and shared memory 4170 via a memory and cache interconnect 4168.

In at least one embodiment, instruction cache 4152 receives a stream of instructions to execute from pipeline manager 4132. In at least one embodiment, instructions are cached in instruction cache 4152 and dispatched for execution by instruction unit 4154. In at least one embodiment, instruction unit 4154 can dispatch instructions as thread groups (e.g., warps), with each thread of a thread group assigned to a different execution unit within GPGPU core 4162. In at least one embodiment, an instruction can access any of a local, shared, or global address space by specifying an address within a unified address space. In at least one embodiment, address mapping unit 4156 can be used to translate addresses in a unified address space into a distinct memory address that can be accessed by LSUs 4166.

In at least one embodiment, register file 4158 provides a set of registers for functional units of graphics multiprocessor 4196. In at least one embodiment, register file 4158 provides temporary storage for operands connected to data paths of functional units (e.g., GPGPU cores 4162, LSUs 4166) of graphics multiprocessor 4196. In at least one embodiment, register file 4158 is divided between each of functional units such that each functional unit is allocated a dedicated portion of register file 4158. In at least one embodiment, register file 4158 is divided between different thread groups being executed by graphics multiprocessor 4196.

In at least one embodiment, GPGPU cores 4162 can each include FPUs and/or integer ALUs that are used to execute instructions of graphics multiprocessor 4196. GPGPU cores 4162 can be similar in architecture or can differ in architecture. In at least one embodiment, a first portion of GPGPU cores 4162 include a single precision FPU and an integer ALU while a second portion of GPGPU cores 4162 include a double precision FPU. In at least one embodiment, FPUs can implement IEEE 754-2008 standard for floating point arithmetic or enable variable precision floating point arithmetic. In at least one embodiment, graphics multiprocessor 4196 can additionally include one or more fixed function or special function units to perform specific functions such as copy rectangle or pixel blending operations. In at least one embodiment one or more of GPGPU cores 4162 can also include fixed or special function logic.

In at least one embodiment, GPGPU cores 4162 include SIMD logic capable of performing a single instruction on multiple sets of data. In at least one embodiment GPGPU cores 4162 can physically execute SIMD4, SIMD8, and SIMD16 instructions and logically execute SIMD1, SIMD2, and SIMD32 instructions. In at least one embodiment, SIMD instructions for GPGPU cores 4162 can be generated at compile time by a shader compiler or automatically generated when executing programs written and compiled for single program multiple data (“SPMD”) or SIMT architectures. In at least one embodiment, multiple threads of a program configured for an SIMT execution model can executed via a single SIMD instruction. For example, in at least one embodiment, eight SIMT threads that perform the same or similar operations can be executed in parallel via a single SIMD8 logic unit.

In at least one embodiment, memory and cache interconnect 4168 is an interconnect network that connects each functional unit of graphics multiprocessor 4196 to register file 4158 and to shared memory 4170. In at least one embodiment, memory and cache interconnect 4168 is a crossbar interconnect that allows LSU 4166 to implement load and store operations between shared memory 4170 and register file 4158. In at least one embodiment, register file 4158 can operate at a same frequency as GPGPU cores 4162, thus data transfer between GPGPU cores 4162 and register file 4158 is very low latency. In at least one embodiment, shared memory 4170 can be used to enable communication between threads that execute on functional units within graphics multiprocessor 4196. In at least one embodiment, cache memory 4172 can be used as a data cache for example, to cache texture data communicated between functional units and texture unit 4136. In at least one embodiment, shared memory 4170 can also be used as a program managed cached. In at least one embodiment, threads executing on GPGPU cores 4162 can programmatically store data within shared memory in addition to automatically cached data that is stored within cache memory 4172.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high speed interconnect such as PCIe or NVLink). In at least one embodiment, a GPU may be integrated on a same package or chip as cores and communicatively coupled to cores over a processor bus/interconnect that is internal to a package or a chip. In at least one embodiment, regardless of a manner in which a GPU is connected, processor cores may allocate work to a GPU in a form of sequences of commands/instructions contained in a WD. In at least one embodiment, a GPU then uses dedicated circuitry/logic for efficiently processing these commands/instructions.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

### General Computing

The following FIGS. set forth, without limitation, exemplary software constructs within general computing that can be used to implement at least one embodiment.

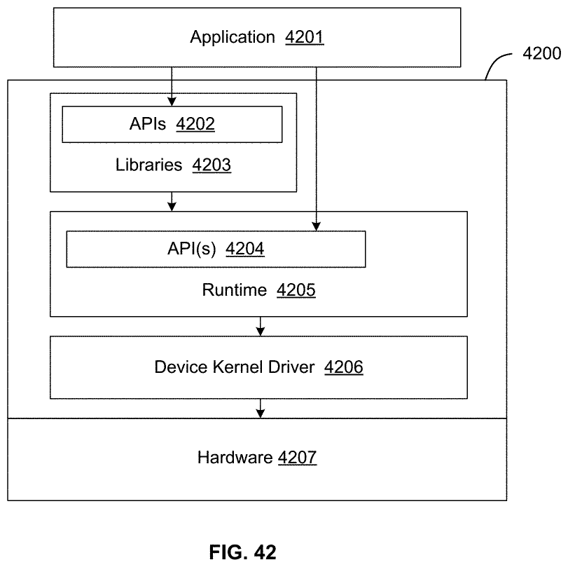

FIG. 42 illustrates a software stack of a programming platform, in accordance with at least one embodiment. In at least one embodiment, a programming platform is a platform for leveraging hardware on a computing system to accelerate computational tasks. A programming platform may be accessible to software developers through libraries, compiler directives, and/or extensions to programming languages, in at least one embodiment. In at least one embodiment, a programming platform may be, but is not limited to, CUDA, Radeon Open Compute Platform (“ROCm”), OpenCL (OpenCL™ is developed by Khronos group), SYCL, or Intel One API.

In at least one embodiment, a software stack 4200 of a programming platform provides an execution environment for an application 4201. In at least one embodiment, application 4201 may include any computer software capable of being launched on software stack 4200. In at least one embodiment, application 4201 may include, but is not limited to, an artificial intelligence (“AI”)/machine learning (“ML”) application, a high performance computing (“HPC”) application, a virtual desktop infrastructure (“VDI”), or a data center workload.

In at least one embodiment, application 4201 and software stack 4200 run on hardware 4207. Hardware 4207 may include one or more GPUs, CPUs, FPGAs, AI engines, and/or other types of compute devices that support a programming platform, in at least one embodiment. In at least one embodiment, such as with CUDA, software stack 4200 may be vendor specific and compatible with only devices from particular vendor(s). In at least one embodiment, such as in with OpenCL, software stack 4200 may be used with devices from different vendors. In at least one embodiment, hardware 4207 includes a host connected to one more devices that can be accessed to perform computational tasks via application programming interface (“API”) calls. A device within hardware 4207 may include, but is not limited to, a GPU, FPGA, AI engine, or other compute device (but may also include a CPU) and its memory, as opposed to a host within hardware 4207 that may include, but is not limited to, a CPU (but may also include a compute device) and its memory, in at least one embodiment.

In at least one embodiment, software stack 4200 of a programming platform includes, without limitation, a number of libraries 4203, a runtime 4205, and a device kernel driver 4206. Each of libraries 4203 may include data and programming code that can be used by computer programs and leveraged during software development, in at least one embodiment. In at least one embodiment, libraries 4203 may include, but are not limited to, pre-written code and subroutines, classes, values, type specifications, configuration data, documentation, help data, and/or message templates. In at least one embodiment, libraries 4203 include functions that are optimized for execution on one or more types of devices. In at least one embodiment, libraries 4203 may include, but are not limited to, functions for performing mathematical, deep learning, and/or other types of operations on devices. In at least one embodiment, libraries 4303 are associated with corresponding APIs 4302, which may include one or more APIs, that expose functions implemented in libraries 4303.

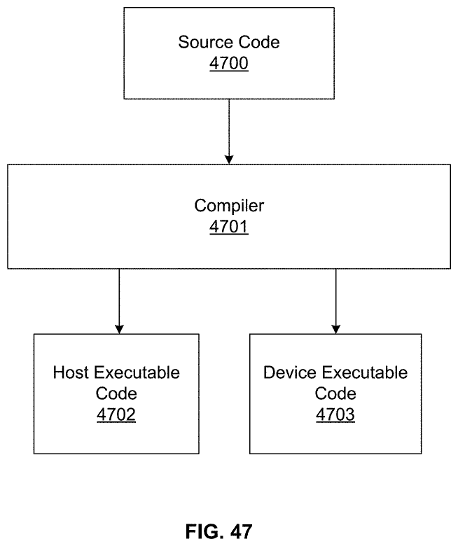

In at least one embodiment, application 4201 is written as source code that is compiled into executable code, as discussed in greater detail below in conjunction with FIG. 47. Executable code of application 4201 may run, at least in part, on an execution environment provided by software stack 4200, in at least one embodiment. In at least one embodiment, during execution of application 4201, code may be reached that needs to run on a device, as opposed to a host. In such a case, runtime 4205 may be called to load and launch requisite code on a device, in at least one embodiment. In at least one embodiment, runtime 4205 may include any technically feasible runtime system that is able to support execution of application S01.

In at least one embodiment, runtime 4205 is implemented as one or more runtime libraries associated with corresponding APIs, which are shown as API(s) 4204. One or more of such runtime libraries may include, without limitation, functions for memory management, execution control, device management, error handling, and/or synchronization, among other things, in at least one embodiment. In at least one embodiment, memory management functions may include, but are not limited to, functions to allocate, deallocate, and copy device memory, as well as transfer data between host memory and device memory. In at least one embodiment, execution control functions may include, but are not limited to, functions to launch a function (sometimes referred to as a “kernel” when a function is a global function callable from a host) on a device and set attribute values in a buffer maintained by a runtime library for a given function to be executed on a device.

Runtime libraries and corresponding API(s) 4204 may be implemented in any technically feasible manner, in at least one embodiment. In at least one embodiment, one (or any number of) API may expose a low-level set of functions for fine-grained control of a device, while another (or any number of) API may expose a higher-level set of such functions. In at least one embodiment, a high-level runtime API may be built on top of a low-level API. In at least one embodiment, one or more of runtime APIs may be language-specific APIs that are layered on top of a language-independent runtime API.

In at least one embodiment, device kernel driver 4206 is configured to facilitate communication with an underlying device. In at least one embodiment, device kernel driver 4206 may provide low-level functionalities upon which APIs, such as API(s) 4204, and/or other software relies. In at least one embodiment, device kernel driver 4206 may be configured to compile intermediate representation (“IR”) code into binary code at runtime. For CUDA, device kernel driver 4206 may compile Parallel Thread Execution (“PTX”) IR code that is not hardware specific into binary code for a specific target device at runtime (with caching of compiled binary code), which is also sometimes referred to as “finalizing” code, in at least one embodiment. Doing so may permit finalized code to run on a target device, which may not have existed when source code was originally compiled into PTX code, in at least one embodiment. Alternatively, in at least one embodiment, device source code may be compiled into binary code offline, without requiring device kernel driver 4206 to compile IR code at runtime.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

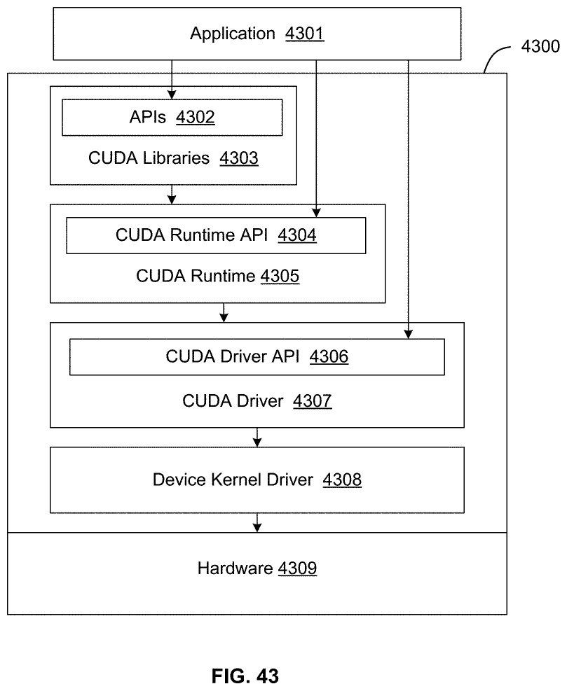

FIG. 43 illustrates a CUDA implementation of software stack 4200 of FIG. 42, in accordance with at least one embodiment. In at least one embodiment, a CUDA software stack 4300, on which an application 4301 may be launched, includes CUDA libraries 4303, a CUDA runtime 4305, a CUDA driver 4307, and a device kernel driver 4308. In at least one embodiment, CUDA software stack 4300 executes on hardware 4309, which may include a GPU that supports CUDA and is developed by NVIDIA Corporation of Santa Clara, Calif.

In at least one embodiment, application 4301, CUDA runtime 4305, and device kernel driver 4308 may perform similar functionalities as application 4201, runtime 4205, and device kernel driver 4206, respectively, which are described above in conjunction with FIG. 42. In at least one embodiment, CUDA driver 4307 includes a library (libcuda.so) that implements a CUDA driver API 4306. Similar to a CUDA runtime API 4304 implemented by a CUDA runtime library (cudart), CUDA driver API 4306 may, without limitation, expose functions for memory management, execution control, device management, error handling, synchronization, and/or graphics interoperability, among other things, in at least one embodiment. In at least one embodiment, CUDA driver API 4306 differs from CUDA runtime API 4304 in that CUDA runtime API 4304 simplifies device code management by providing implicit initialization, context (analogous to a process) management, and module (analogous to dynamically loaded libraries) management. In contrast to high-level CUDA runtime API 4304, CUDA driver API 4306 is a low-level API providing more fine-grained control of a device, particularly with respect to contexts and module loading, in at least one embodiment. In at least one embodiment, CUDA driver API 4306 may expose functions for context management that are not exposed by CUDA runtime API 4304. In at least one embodiment, CUDA driver API 4306 is also language-independent and supports, e.g., OpenCL in addition to CUDA runtime API 4304. Further, in at least one embodiment, development libraries, including CUDA runtime 4305, may be considered as separate from driver components, including user-mode CUDA driver 4307 and kernel-mode device driver 4308 (also sometimes referred to as a “display” driver).

In at least one embodiment, CUDA libraries 4303 may include, but are not limited to, mathematical libraries, deep learning libraries, parallel algorithm libraries, and/or signal/image/video processing libraries, which parallel computing applications such as application 4301 may utilize. In at least one embodiment, CUDA libraries 4303 may include mathematical libraries such as a cuBLAS library that is an implementation of Basic Linear Algebra Subprograms (“BLAS”) for performing linear algebra operations, a cuFFT library for computing fast Fourier transforms (“FFTs”), and a cuRAND library for generating random numbers, among others. In at least one embodiment, CUDA libraries 4303 may include deep learning libraries such as a cuDNN library of primitives for deep neural networks and a TensorRT platform for high-performance deep learning inference, among others.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

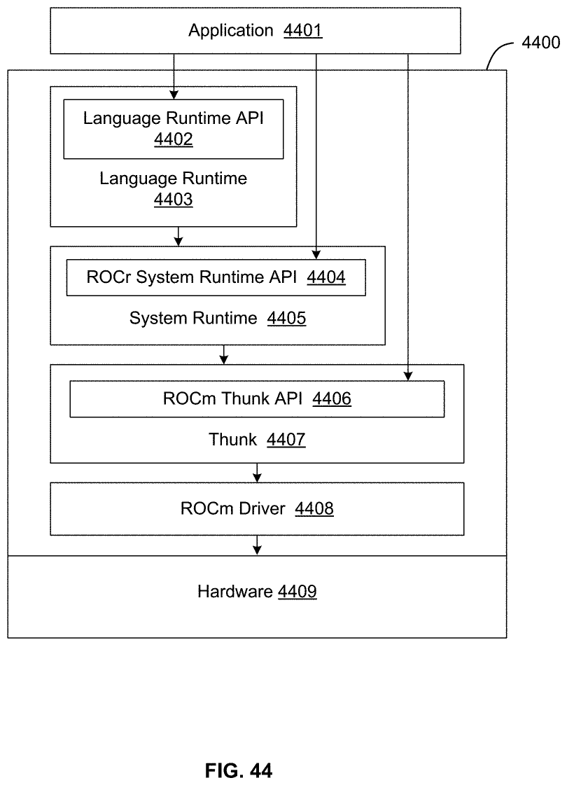

FIG. 44 illustrates a ROCm implementation of software stack 4200 of FIG. 42, in accordance with at least one embodiment. In at least one embodiment, a ROCm software stack 4400, on which an application 4401 may be launched, includes a language runtime 4403, a system runtime 4405, a thunk 4407, a ROCm kernel driver 4408, and a device kernel driver 4409. In at least one embodiment, ROCm software stack 4400 executes on hardware 4410, which may include a GPU that supports ROCm and is developed by AMD Corporation of Santa Clara, Calif.

In at least one embodiment, application 4401 may perform similar functionalities as application 4201 discussed above in conjunction with FIG. 42. In addition, language runtime 4403 and system runtime 4405 may perform similar functionalities as runtime 4205 discussed above in conjunction with FIG. 42, in at least one embodiment. In at least one embodiment, language runtime 4403 and system runtime 4405 differ in that system runtime 4405 is a language-independent runtime that implements a ROCr system runtime API 4404 and makes use of a Heterogeneous System Architecture (“HAS”) Runtime API. HAS runtime API is a thin, user-mode API that exposes interfaces to access and interact with an AMD GPU, including functions for memory management, execution control via architected dispatch of kernels, error handling, system and agent information, and runtime initialization and shutdown, among other things, in at least one embodiment. In contrast to system runtime 4405, language runtime 4403 is an implementation of a language-specific runtime API 4402 layered on top of ROCr system runtime API 4404, in at least one embodiment. In at least one embodiment, language runtime API may include, but is not limited to, a Heterogeneous compute Interface for Portability (“HIP”) language runtime API, a Heterogeneous Compute Compiler (“HCC”) language runtime API, or an OpenCL API, among others. HIP language in particular is an extension of C++ programming language with functionally similar versions of CUDA mechanisms, and, in at least one embodiment, a HIP language runtime API includes functions that are similar to those of CUDA runtime API 4304 discussed above in conjunction with FIG. 43, such as functions for memory management, execution control, device management, error handling, and synchronization, among other things.

In at least one embodiment, thunk (ROCt) 4407 is an interface that can be used to interact with underlying ROCm driver 4408. In at least one embodiment, ROCm driver 4408 is a ROCk driver, which is a combination of an AMDGPU driver and a HAS kernel driver (amdkfd). In at least one embodiment, AMDGPU driver is a device kernel driver for GPUs developed by AMD that performs similar functionalities as device kernel driver 4206 discussed above in conjunction with FIG. 42. In at least one embodiment, HAS kernel driver is a driver permitting different types of processors to share system resources more effectively via hardware features.

In at least one embodiment, various libraries (not shown) may be included in ROCm software stack 4400 above language runtime 4403 and provide functionality similarity to CUDA libraries 4303, discussed above in conjunction with FIG. 43. In at least one embodiment, various libraries may include, but are not limited to, mathematical, deep learning, and/or other libraries such as a hipBLAS library that implements functions similar to those of CUDA cuBLAS, a rocFFT library for computing FFTs that is similar to CUDA cuFFT, among others.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

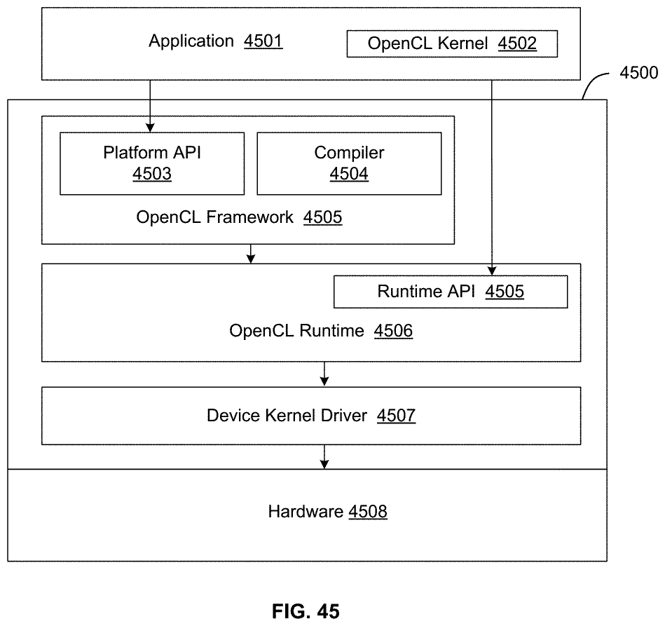

FIG. 45 illustrates an OpenCL implementation of software stack 4200 of FIG. 42, in accordance with at least one embodiment. In at least one embodiment, an OpenCL software stack 4500, on which an application 4501 may be launched, includes an OpenCL framework 4505, an OpenCL runtime 4506, and a driver 4507. In at least one embodiment, OpenCL software stack 4500 executes on hardware 4309 that is not vendor-specific. As OpenCL is supported by devices developed by different vendors, specific OpenCL drivers may be required to interoperate with hardware from such vendors, in at least one embodiment.

In at least one embodiment, application 4501, OpenCL runtime 4506, device kernel driver 4507, and hardware 4508 may perform similar functionalities as application 4201, runtime 4205, device kernel driver 4206, and hardware 4207, respectively, that are discussed above in conjunction with FIG. 42. In at least one embodiment, application 4501 further includes an OpenCL kernel 4502 with code that is to be executed on a device.

In at least one embodiment, OpenCL defines a “platform” that allows a host to control devices connected to a host. In at least one embodiment, an OpenCL framework provides a platform layer API and a runtime API, shown as platform API 4503 and runtime API 4505. In at least one embodiment, runtime API 4505 uses contexts to manage execution of kernels on devices. In at least one embodiment, each identified device may be associated with a respective context, which runtime API 4505 may use to manage command queues, program objects, and kernel objects, share memory objects, among other things, for that device. In at least one embodiment, platform API 4503 exposes functions that permit device contexts to be used to select and initialize devices, submit work to devices via command queues, and enable data transfer to and from devices, among other things. In addition, OpenCL framework provides various built-in functions (not shown), including math functions, relational functions, and image processing functions, among others, in at least one embodiment.

In at least one embodiment, a compiler 4504 is also included in OpenCL frame-work 4505. Source code may be compiled offline prior to executing an application or online during execution of an application, in at least one embodiment. In contrast to CUDA and ROCm, OpenCL applications in at least one embodiment may be compiled online by compiler 4504, which is included to be representative of any number of compilers that may be used to compile source code and/or IR code, such as Standard Portable Intermediate Representation (“SPIR-V”) code, into binary code. Alternatively, in at least one embodiment, OpenCL applications may be compiled offline, prior to execution of such applications.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

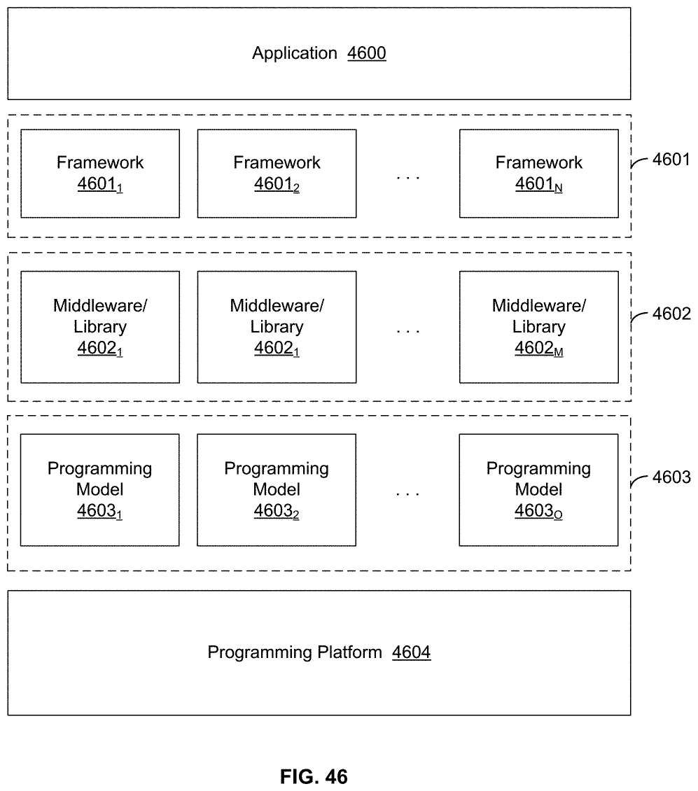

FIG. 46 illustrates software that is supported by a programming platform, in accordance with at least one embodiment. In at least one embodiment, a programming platform 4604 is configured to support various programming models 4603, middlewares and/or libraries 4602, and frameworks 4601 that an application 4600 may rely upon. In at least one embodiment, application 4600 may be an AI/ML application implemented using, for example, a deep learning framework such as MXNet, PyTorch, or TensorFlow, which may rely on libraries such as cuDNN, NVIDIA Collective Communications Library (“NCCL”), and/or NVIDA Developer Data Loading Library (“DALI”) CUDA libraries to provide accelerated computing on underlying hardware.

In at least one embodiment, programming platform 4604 may be one of a CUDA, ROCm, or OpenCL platform described above in conjunction with FIG. 43, FIG. 44, and FIG. 45, respectively. In at least one embodiment, programming platform 4604 supports multiple programming models 4603, which are abstractions of an underlying computing system permitting expressions of algorithms and data structures. Programming models 4603 may expose features of underlying hardware in order to improve performance, in at least one embodiment. In at least one embodiment, programming models 4603 may include, but are not limited to, CUDA, HIP, OpenCL, C++ Accelerated Massive Parallelism (“C++ AMP”), Open Multi-Processing (“OpenMP”), Open Accelerators (“OpenACC”), and/or Vulcan Compute.

In at least one embodiment, libraries and/or middlewares 4602 provide implementations of abstractions of programming models 4604. In at least one embodiment, such libraries include data and programming code that may be used by computer programs and leveraged during software development. In at least one embodiment, such middlewares include software that provides services to applications beyond those available from programming platform 4604. In at least one embodiment, libraries and/or middlewares 4602 may include, but are not limited to, cuBLAS, cuFFT, cuRAND, and other CUDA libraries, or rocBLAS, rocFFT, rocRAND, and other ROCm libraries. In addition, in at least one embodiment, libraries and/or middlewares 4602 may include NCCL and ROCm Communication Collectives Library (“RCCL”) libraries providing communication routines for GPUs, a MlOpen library for deep learning acceleration, and/or an Eigen library for linear algebra, matrix and vector operations, geometrical transformations, numerical solvers, and related algorithms.

In at least one embodiment, application frameworks 4601 depend on libraries and/or middlewares 4602. In at least one embodiment, each of application frameworks 4601 is a software framework used to implement a standard structure of application software. An AI/ML application may be implemented using a framework such as Caffe, Caffe2, TensorFlow, Keras, PyTorch, or MxNet deep learning frameworks, in at least one embodiment.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

FIG. 47 illustrates compiling code to execute on one of programming platforms of FIGS. 42-45, in accordance with at least one embodiment. In at least one embodiment, a compiler 4701 receives source code 4700 that includes both host code as well as device code. In at least one embodiment, complier 4701 is configured to convert source code 4700 into host executable code 4702 for execution on a host and device executable code 4703 for execution on a device. In at least one embodiment, source code 4700 may either be compiled offline prior to execution of an application, or online during execution of an application.

In at least one embodiment, source code 4700 may include code in any programming language supported by compiler 4701, such as C++, C, Fortran, etc. In at least one embodiment, source code 4700 may be included in a single-source file having a mixture of host code and device code, with locations of device code being indicated therein. In at least one embodiment, a single-source file may be a .cu file that includes CUDA code or a.hip.cpp file that includes HIP code. Alternatively, in at least one embodiment, source code 4700 may include multiple source code files, rather than a single-source file, into which host code and device code are separated.

In at least one embodiment, compiler 4701 is configured to compile source code 4700 into host executable code 4702 for execution on a host and device executable code 4703 for execution on a device. In at least one embodiment, compiler 4701 performs operations including parsing source code 4700 into an abstract system tree (AST), performing optimizations, and generating executable code. In at least one embodiment in which source code 4700 includes a single-source file, compiler 4701 may separate device code from host code in such a single-source file, compile device code and host code into device executable code 4703 and host executable code 4702, respectively, and link device executable code 4703 and host executable code 4702 together in a single file, as discussed in greater detail below with respect to FIG. 36.

In at least one embodiment, host executable code 4702 and device executable code 4703 may be in any suitable format, such as binary code and/or IR code. In a case of CUDA, host executable code 4702 may include native object code and device executable code 4703 may include code in PTX intermediate representation, in at least one embodiment. In a case of ROCm, both host executable code 4702 and device executable code 4703 may include target binary code, in at least one embodiment.

In at least one embodiment, one or more circuits, processors, computing systems, or other devices or techniques are adapted, with reference to said FIG., to identify a cause of a performance regression by comparing performance metrics associated with a first group of user interactions with a web-based service to performance metrics associated with a second group of user interactions with the web-based service. In at least one embodiment, this is performed by embodiments of said FIG., according to embodiments described herein in relation to FIGS. 1-10.

At least one embodiment of the disclosure can be described in view of the following clauses:

1. A processor comprising:

one or more circuits to be configured to compare one or more performance metrics of a web-based service in response to a first group of user interactions with the web-based service and one or more performance metrics of the web-based service in response to a second group of user interactions with the web-based service.

2. The processor of clause 1, the one or more circuits to be configured to determine that performance of the web-based service has regressed by at least:

generating a resampled time series, by at least randomly reassigning points of a time series of the one or more performance metrics of the web-based service to buckets of the resampled time series; and

identifying a transition point in the resampled time series based, at least in part, on statistical comparison of segments of the resampled time series.

3. The processor of clauses 1 or 2, the one or more circuits to be configured to compare a rate of change of the one or more performance metrics of the web-based service in response to the first group of user interactions, with a rate of change of the one or more performance metrics of the web-based service in response to the second group of user interactions.

4. The processor of any of clauses 1-3, the one or more circuits to be configured to compare a proportion of the first group of user interactions to a proportion of the second group of user interactions.

5. The processor of any of clauses 1-4, wherein the first group of user interactions is associated with a first property in a category of properties, and the second group of users interactions is associated with a second property in the category of properties.

6. The processor of any of clauses 1-5, the one or more circuits to be configured to determine that a property associated with the first group of user interactions is a likely cause of a regression in performance of the web-based service, based, at least in part, on a measure of information gained by comparing the one or more performance metrics of the first group of user interactions with the one or more performance metrics of the second group of user interactions.

7. The processor of any of clauses 1-6, the one or more circuits to be configured to recursively compare groups of user interactions based, at least in part, wherein each level of recursion is based, at least in part, on a category of property different than those in early levels of recursion.

8. The processor of any of clauses 1-7, wherein a user interaction comprises utilization of the web-based service by a client device associated with a user.

9. A system, comprising:

one or more computing devices comprising one or more processors to compare one or more performance metrics of a web-based service in response to a first group of user interactions with the web-based service and one or more performance metrics of the web-based service in response to a second group of user interactions with the web-based service.

10. The system of clause 9, the one or more processors to at least identify a regression in performance based, at least in part, by randomly reassigning points of a time series of the one or more performance metrics of the web-based service to buckets of a resampled version of the time series.

11. The system of clause 9 or 10, the one or more processors to compare a rate of change of the one or more performance metrics of the web-based service in response to the first group of user interactions, to a rate of change of the one or more performance metrics of the web-based service in response to the second group of user interactions.

12. The system of any of clauses 9-11, wherein comparison of the one or more performance metrics of the web-based service in response to the first group of user interactions and the one or more performance metrics of the web-based service in response to the second group of user interactions comprises comparison of a proportion of interactions with the first group of user interactions to a proportion of interactions with the second group of user interactions.

13. The system of any of clauses 9-12, wherein the first group of user interactions is generated by dividing user interactions based on properties associated with a category of properties.

14. The system of any of clauses 9-13, the one or more processors to determine that a property associated with the first group of user interactions is a likely cause of a regression in performance of the web-based service, based, at least in part, on a measure of information gained by comparing rates of change of proportion and performance metrics of the first and second groups of user interactions.

15. The system of any of clauses 9-14, the one or more processors to recursively compare groups of user interactions, wherein groups compared in a level of recursion are generated based, at least in part, on a category of property selected for that level of recursion.

16. A machine-readable medium having stored thereon a set of instructions, which if performed by one or more processors, cause the one or more processors to at least:

compare one or more performance metrics of a web-based service in response to a first group of user interactions with the web-based service and one or more performance metrics of the web-based service in response to a second group of user interactions with the web-based service.

17. The machine-readable medium of clause 16 having stored thereon a set of instructions, which if performed by one or more processors, cause the one or more processors to at least:

randomly reassign points of a time series of the one or more performance metrics of the web-based service to buckets of a resampled time series; and

identify a transition point in the resampled time series based, at least in part, on statistical comparison of segments of the resampled time series.

18. The machine-readable medium of clauses 16 or 17, having stored thereon a set of instructions, which if performed by one or more processors, cause the one or more processors to at least compare a rate of change of the one or more performance metrics of the web-based service in response to the first group of user interactions, with a rate of change of the one or more performance metrics of the web-based service in response to the second group of user interactions.

19. The machine-readable medium of any of clauses 16-18, having stored thereon a set of instructions, which if performed by one or more processors, cause the one or more processors to at least compare a proportion of the first group of user interactions to a proportion of the second group of user interactions.

20. The machine-readable medium of any of clauses 16-19, wherein the first group of user interactions is associated with a first property of a category of properties, and the second group of users interactions is associated with a second property of the category of properties.

21. The machine-readable medium of any of clauses 16-20, having stored thereon a set of instructions, which if performed by one or more processors, cause the one or more processors to at least determine that a property associated with the first group of user interactions is a potential cause of a regression in performance of the web-based service, based, at least in part, on a measure of information gained by comparing the one or more performance metrics of the first group of user interactions with one or more performance metrics of the second group of user interactions.

22. The machine-readable medium of any of clauses 16-21, having stored thereon a set of instructions, which if performed by one or more processors, cause the one or more processors to at least recursively compare groups of user interactions based, at least in part, wherein each level of recursion is based, at least in part, on a category of property different than those in early levels of recursion.

23. A system, comprising:

one or more computing devices to generate output for a computerized gameplay service, wherein the one or more computing devices compare one or more performance metrics of the service in response to a first group of interactions with the service and one or more performance metrics of the service in response to a second group of interactions with the service.

24. The system of clause 23, the one or more computing devices to at least:

identify a performance regression by at least randomly reassigning points of a time series of the one or more performance metrics to buckets of a resampled time series; and

identify a transition point in the resampled time series based, at least in part, on statistical comparison of segments of the resampled time series.

25. The system of clauses 23 or 24, wherein the comparison is based, at least in part, on a rate of change of the one or more performance metrics of the service in response to the first group of interactions.

26. The system of any of clauses 23-25, the one or more computing devices to at least compare a proportion of the first group of interactions to a proportion of the second group of interactions.

27. The system of any of clauses 23-26, wherein the first group of interactions is generated based, at least in part, on a property common to all interactions in the first group of interactions.

28. The system of any of clauses 23-27, the one or more computing devices to at least identify one or more properties likely to be a cause of a performance regression, based at least in part on analyzing statistics associated with groupings of user interactions and computing, based at least in part on the analysis, a value indicative of information gain.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium. In at least one embodiment, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—in at least one embodiment, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, in at least one embodiment, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor, comprising:
one or more circuits to be configured to compare one or more performance metrics of a web-based service in response to a first group of user interactions with the web-based service and one or more performance metrics of the web-based service in response to a second group of user interactions with the web-based service.

2. The processor of claim 1, the one or more circuits to be configured to determine that performance of the web-based service has regressed by at least:
generating a resampled time series, by at least randomly reassigning points of a time series of the one or more performance metrics of the web-based service to buckets of the resampled time series; and
identifying a transition point in the resampled time series based, at least in part, on statistical comparison of segments of the resampled time series.

3. The processor of claim 1, the one or more circuits to be configured to compare a rate of change of the one or more performance metrics of the web-based service in response to the first group of user interactions, with a rate of change of the one or more performance metrics of the web-based service in response to the second group of user interactions.

4. The processor of claim 1, the one or more circuits to be configured to compare a proportion of the first group of user interactions to a proportion of the second group of user interactions.

5. The processor of claim 1, wherein the first group of user interactions is associated with a first property in a category of properties, and the second group of user interactions is associated with a second property in the category of properties.

6. The processor of claim 1, the one or more circuits to be configured to determine that a property associated with the first group of user interactions is a likely cause of a regression in performance of the web-based service, based, at least in part, on a measure of information gained by comparing the one or more performance metrics of the first group of user interactions with the one or more performance metrics of the second group of user interactions.

7. The processor of claim 1, the one or more circuits to be configured to recursively compare groups of user interactions based, at least in part, wherein each level of recursion is based, at least in part, on a category of property different than those in early levels of recursion.

8. The processor of claim 1, wherein a user interaction comprises utilization of the web-based service by a client device associated with a user.

9. A system, comprising:
one or more computing devices comprising one or more processors to compare one or more performance metrics of a web-based service in response to a first group of user interactions with the web-based service and one or more performance metrics of the web-based service in response to a second group of user interactions with the web-based service.

10. The system of claim 9, the one or more processors to at least identify a regression in performance based, at least in part, by randomly reassigning points of a time series of the one or more performance metrics of the web-based service to buckets of a resampled version of the time series.

11. The system of claim 9, the one or more processors to compare a rate of change of the one or more performance metrics of the web-based service in response to the first group of user interactions, to a rate of change of the one or more performance metrics of the web-based service in response to the second group of user interactions.

12. The system of claim 9, wherein comparison of the one or more performance metrics of the web-based service in response to the first group of user interactions and the one or more performance metrics of the web-based service in response to the second group of user interactions comprises comparison of a proportion of interactions with the first group of user interactions to a proportion of interactions with the second group of user interactions.

13. The system of claim 9, wherein the first group of user interactions is generated by dividing user interactions based on properties associated with a category of properties.

14. The system of claim 9, the one or more processors to determine that a property associated with the first group of user interactions is a likely cause of a regression in performance of the web-based service, based, at least in part, on a measure of information gained by comparing rates of change of proportion and performance metrics of the first and second groups of user interactions.

15. The system of claim 9, the one or more processors to recursively compare groups of user interactions, wherein groups compared in a level of recursion are generated based, at least in part, on a category of property selected for that level of recursion.

16. A machine-readable medium having stored thereon a set of instructions, which if performed by one or more processors, cause the one or more processors to at least:
compare one or more performance metrics of a web-based service in response to a first group of user interactions with the web-based service and one or more performance metrics of the web-based service in response to a second group of user interactions with the web-based service.

17. The machine-readable medium of claim 16 having stored thereon a set of instructions, which if performed by one or more processors, cause the one or more processors to at least:
randomly reassign points of a time series of the one or more performance metrics of the web-based service to buckets of a resampled time series; and
identify a transition point in the resampled time series based, at least in part, on statistical comparison of segments of the resampled time series.

18. The machine-readable medium of claim 16, having stored thereon a set of instructions, which if performed by one or more processors, cause the one or more processors to at least compare a rate of change of the one or more performance metrics of the web-based service in response to the first group of user interactions, with a rate of change of the one or more performance metrics of the web-based service in response to the second group of user interactions.

19. The machine-readable medium of claim 16, having stored thereon a set of instructions, which if performed by one or more processors, cause the one or more processors to at least compare a proportion of the first group of user interactions to a proportion of the second group of user interactions.

20. The machine-readable medium of claim 16, wherein the first group of user interactions is associated with a first property of a category of properties, and the second group of users interactions is associated with a second property of the category of properties.

21. The machine-readable medium of claim 16, having stored thereon a set of instructions, which if performed by one or more processors, cause the one or more processors to at least determine that a property associated with the first group of user interactions is a potential cause of a regression in performance of the web-based service, based, at least in part, on a measure of information gained by comparing the one or more performance metrics of the first group of user interactions with one or more performance metrics of the second group of user interactions.

22. The machine-readable medium of claim 16, having stored thereon a set of instructions, which if performed by one or more processors, cause the one or more processors to at least recursively compare groups of user interactions based, at least in part, wherein each level of recursion is based, at least in part, on a category of property different than those in early levels of recursion.

23. A system, comprising:
one or more computing devices to generate output for a computerized gameplay service, wherein the one or more computing devices compare one or more performance metrics of the service in response to a first group of interactions with the service and one or more performance metrics of the service in response to a second group of interactions with the service.

24. The system of claim 23, the one or more computing devices to at least:
identify a performance regression by at least randomly reassigning points of a time series of the one or more performance metrics to buckets of a resampled time series; and
identify a transition point in the resampled time series based, at least in part, on statistical comparison of segments of the resampled time series.

25. The system of claim 23, wherein the comparison is based, at least in part, on a rate of change of the one or more performance metrics of the service in response to the first group of interactions.

26. The system of claim 23, the one or more computing devices to at least compare a proportion of the first group of interactions to a proportion of the second group of interactions.

27. The system of claim 23, wherein the first group of interactions is generated based, at least in part, on a property common to all interactions in the first group of interactions.

28. The system of claim 23, the one or more computing devices to at least identify one or more properties likely to be a cause of a performance regression, based at least in part on analyzing statistics associated with groupings of user interactions and computing, based at least in part on the analysis, a value indicative of information gain.
